(19) United States
(12) Patent Application Publication
(10) Pub. No.: US 2016/0087957 A1
(43) Pub. Date: Mar. 24, 2016

(54) MULTI-FACTOR AUTHENTICATION TO ACHIEVE REQUIRED AUTHENTICATION ASSURANCE LEVEL

(71) Applicant: INTERDIGITAL PATENT HOLDINGS, INC., Wilmington, DE (US)

(72) Inventors: Yogendra C. SHAH, Exton, PA (US); Andreas SCHMIDT, Frankfurt am Main (DE); Vinod K. CHOYI, Norristown, PA (US); Lakshmi SUBRAMANIAN, Karlsruhe (DE); Andreas LEICHER, Frankfurt (DE)

(21) Appl. No.: 14/786,688

(22) PCT Filed: Apr. 25, 2014
(86) PCT No.: PCT/US2014/035517

§ 371 Date: Oct. 23, 2015

Related U.S. Application Data
(60) Provisional application No. 61/816,446, filed on Apr. 26, 2013.
(60) Provisional application No. 61/832,509, filed on Jun. 7, 2013.

(51) Int. Cl. H04L 29/06; H04W 12/06

(52) U.S. Cl. CPC H04L 63/08; H04L 63/20; H04W 12/06; H04L 63/205

(57) ABSTRACT

As users gain access to different services, the grade of the services may vary, for example, from low value services to high value services. A low value may indicate that a low strength of authentication is required, while a high value may indicate that a high strength of authentication is required to access the service. There is disclosed a method for authenticating a device comprising the determination (204) of an authentication requirement to access a first service that is provided by a service provider, SP, the discovery (208) of one or more authentication factors, associated with the device or the user, that are available for the authentication, the determination (210) whether at least one of the discovered authentication factors are sufficient to achieve the authentication requirement and, if so, the performance (212-228) of corresponding authentication procedures.

### CROSS REFERENCE TO RELATED APPLICATIONS

This application claims the benefit of U.S. Provisional Patent Application Ser. No. 61/816,446, filed Apr. 26, 2013, and U.S. Provisional Patent Application Ser. No. 61/832,509, filed Jun. 7, 2013, the disclosures of both which are hereby incorporated by reference as if set forth in their entireties herein.

### BACKGROUND

Consumer use of mobile devices to access services and content in the cloud has increased in recent years. In addition, there is an increasing trend by corporations toward “bring your own device” (BYOD), where employees can use their personal mobile devices to access corporate services/data and to store corporate data locally on their devices. The use of mobile devices for mobile payment services is also increasing. The above examples of the increased use of mobile devices, along with other uses, has led to new requirements for security. For example, forms of authentication that are stronger than mere passwords are often required to access services and to process secure operations.

Two-factor authentication may be used to strengthen the authentication of a user. An example two-factor authentication is based on a user's identity (ID) and password as a first authentication factor and a hardware/software-based token as a second authentication factor. A user ID and password authenticate the user's presence and the token confirms the user's possession of the device on which the token functionality resides. Multi-factor authentication refers to any authentication that uses more than one factor. Example authentication factors include user identities with corresponding passwords, tokens, and biometrics/behavioral aspects of a user.

### SUMMARY

Existing approaches to multi-factor authentication are not flexible and are not user friendly. Various embodiments described herein include a generic architecture for incorporating various factors of authentication. The various factors may include factors that correspond to what a user knows (e.g., password), what a user is (e.g., biometrics), or what a user has (device authentication). For example, biometric authentication may be combined with password-based authentication. The authentications may be performed on a network or on a user equipment (UE). In some cases, multi-factor authentication described herein leverages various protocols, such as the OpenID protocol for example.

In an example embodiment, at least one, for instance both, of a wireless transmit/receive unit (WTRU) or a user that operates the WTRU is authenticated. A network entity, such as a service provider (SP) or an identity provider (IdP) for example, determines a first authentication requirement that is required by the SP to access a first service that is provided by the SP. The authentication requirement may indicate a first assurance level that is required. In accordance with the example embodiment, the network entity discovers one or more capabilities that are available for the authentication. The one or more capabilities may be associated with at least one of the WTRU or the user. The network entity may determine whether at least one of the discovered one or more capabilities are sufficient to achieve the first authentication requirement, for instance the authentication assurance level required by the SP. If at least one of the discovered capabilities is determined to be sufficient, one or more authentication factors are selected. The one or more authentication factors may achieve the first authentication assurance level required by the SP. Thereafter, a performance of at least one of the selected one or more authentication factors is triggered. Upon a successful performance of the one or more authentication factors, the WTRU and the user may access the first service.

### DESCRIPTION OF THE DRAWINGS

FIG. 1 is a block diagram of an example architecture for multi-factor authentication according to an embodiment;

FIGS. 2A and 2B depict a flow diagram for a multi-factor authentication that may be performed by the architecture shown in FIG. 1, in accordance with an example embodiment;

FIGS. 3A-C depict another flow diagram for multi-factor authentication in accordance with another example embodiment;

FIG. 4 is a call flow that shows example OpenID assertions in accordance with an example embodiment;

FIG. 5 is a block diagram that shows how assurance levels are communicated in accordance with an example embodiment;

FIG. 6 is a block diagram that shows example interfaces to an OpenID Identity Provider (OP) in accordance with an example embodiment;

FIGS. 7A-C depict a flow diagram that shows a network-based multi-factor authentication according to an example embodiment;

FIGS. 8A-C depict a flow diagram that shows an on-device authentication and an assertion generated locally in accordance with another example embodiment;

FIGS. 9A-C depict a flow diagram that depicts a local authentication that is combined with an assertion that is generated on the network in accordance with yet another embodiment;

FIG. 10 is a block diagram that shows an example system in which a service provider includes a relying party (RP) and an identity provider (IdP), according to an example embodiment;

FIGS. 11A-B depict a flow diagram that shows pseudo identity (PID) based seamless access to services;

FIGS. 12A-E depict a flow diagram that shows another example of PID-based seamless access to a service;

FIG. 13 is a block diagram that shows two circle of trusts that may communicate with a UE;

FIG. 14 is a block diagram that shows another circle of trust (CoT) in accordance with an example embodiment;

FIG. 15 is a block diagram that shows an example architecture for multi-factor authentication that can be implemented by various embodiments;

FIG. 16 is a block diagram that shows a variation of the example architecture depicted in FIG. 15 in accordance with an example embodiment;

FIG. 17 is a block diagram that shows the architecture of FIG. 15 with additional example functionality depicted;

FIG. 18 is an example device architecture in accordance with one example;

FIG. 19 is a block diagram that shows an example device architecture for multi-factor authentication in accordance with an example embodiment;

FIG. 20 is a block diagram that shows an example servlet architecture for multi-factor authentication in accordance with an example embodiment;

FIG. 21 is a system diagram that shows an example of various databases that can communicate with an example multi-factor authentication server (MFAS);

FIG. 22 is a call flow for a multi-factor authentication that can be performed using the architectures referenced above;

FIG. 23 shows the example architecture shown in FIG. 20, with additional policy entities depicted;

FIG. 24 shows an example of a multi-factor authentication architecture based on Smart OpenID;

FIG. 25 is an block diagram of an application that shows different example authentication activities that can be launched;

FIGS. 26A-C is a call flow that shows an integrated password and biometric authentication in accordance with an example embodiment;

FIG. 27 is a block diagram that shows a variation of the example architecture shown in FIG. 1;

FIG. 28A-B is a call flow for local biometric authentication that can be implemented by the architecture shown in FIG. 27;

FIGS. 29A-D depicts a call for an example multi-factor authentication using two relying parties;

FIGS. 30A-D depicts a variation of the call flow depicted in FIGS. 29A-D, wherein one RP is implemented;

FIG. 31 is a block diagram that shows an example FIDO-MFAS architecture;

FIG. 32A is a system diagram of an example communications system in which one or more disclosed embodiments may be implemented;

FIG. 32B is a system diagram of an example wireless transmit/receive unit (WTRU) that may be used within the communications system illustrated in FIG. 32A; and

FIG. 32C is a system diagram of an example radio access network and an example core network that may be used within the communications system illustrated in FIG. 32A.

### DETAILED DESCRIPTION OF ILLUSTRATIVE EMBODIMENTS

The ensuing detailed description is provided to illustrate example embodiments and is not intended to limit the scope, applicability, or configuration of the invention. Various changes may be made in the function and arrangement of elements and steps without departing from the spirit and scope of the invention. For example, while embodiments may be described herein using federated management technologies, such as an optimized OpenID protocol for example, to provide user-friendly multi-factor authentication, similar embodiments may be implemented using other authentication entities and functions.

Multi-factor authentication refers to any authentication that uses more than one factor. Example factors include user identifiers (IDs), passwords, tokens, and biometrics of a user. In accordance with various embodiments described herein, implementation and deployment of secure and user friendly multi-factor authentication may include authentication of a user or the user's mobile device based on multiple authentication factors that assess various aspects of user authentication including: what a user knows, what a user is, and what a user has for example.

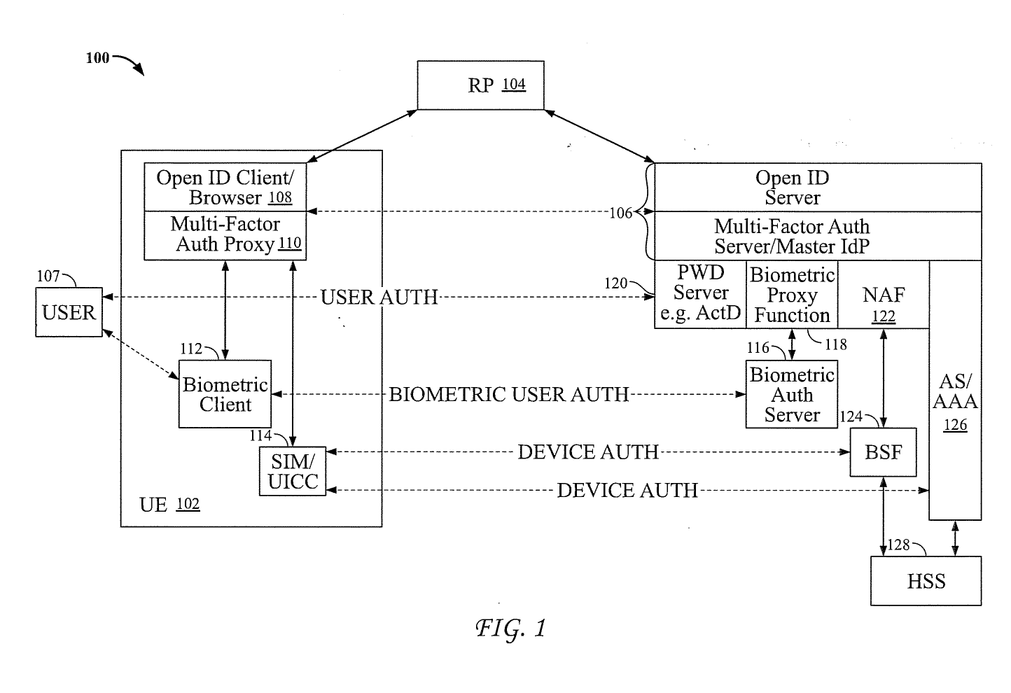

Referring to FIG. 1, an example system 100 includes a user equipment (UE) 102, a relying party (RP) 104, and an OpenID server 106 that may communicate with each other via a network. A user 107 may operate the UE 102. It will be understood that the term user equipment (UE) may refer to a device that includes any appropriate wireless transmit/receive unit (WTRU), as further described below. For example, a WTRU may refer to a fixed or mobile subscriber unit, a pager, a cellular telephone, a personal digital assistant (PDA), a smartphone, a laptop, a tablet computer, a personal computer, a wireless sensor, consumer electronics, or the like. It will be understood that the OpenID (OID) server 106 may be implemented by any appropriate identity provider, and thus the OID server 106 may be referred to as an identity provider 106. Further, the RP 104 may be implemented by any service provider (SP), such as a web service for example, and thus the RP 104 may also be referred to as an SP 104. It will be appreciated that the example system 100 is simplified to facilitate description of the disclosed subject matter and is not intended to limit the scope of this disclosure. Other devices, systems, and configurations may be used to implement the embodiments disclosed herein in addition to, or instead of, a system such as the system 100, and all such embodiments are contemplated as within the scope of the present disclosure.

In accordance with the illustrated embodiment, the OID server 106 may coordinate or facilitate multiple factors of authentication, and thus the OID server 106 may also be referred to as a multi-factor authentication layer (MFAL) 106 or a master IdP 106, although for simplicity the MFAL 106 and the master IdP 106 is referred to herein as a multi-factor authentication server (MFAS) 106. For example, the MFAS 106 may use multiple authentication factors from one or more other identity providers, which collectively can be referred to as the network side. The MFAS 106 may also use authentication factors from the UE 102, which can be referred to as the client side. Thus, the MFAL may enable multi-factor authentication from the network side or the client side. As illustrated, the UE 102 includes an OpenID client 108, which can be any appropriate browser, and thus the OpenID client 108 can also be referred to as a browser 108. As illustrated the UE 102 includes a biometric client 112, which may be configured to receive and process biometric authentication factors, such as fingerprints or eye scans for example. The illustrated UE 102 further includes a subscriber identity module (SIM) 114 or a universal integrated circuit card (UICC) 114, which may be referred to as a SIM/UICC 114. The UE 102 may further include a multi-factor authentication proxy (MFAP) 110, which may be a logical entity coordinate multiple factors of authentication. For example, the MFAP 110 may be accessed using an application programming interface (API) or the MFAP 110 may be implemented as a plugin to the browser 108. The MFAP 110 may have extended functionality and may work as a proxy of the master IdP 106.

The MFAP 110 may perform a variety of functions. For example, the MFAP 110 may maintain a profile of the user 107 and the UE 102. The profile may include capabilities, such as authentication capabilities for example, of the user 107 or the UE 102. The MFAP 110 may negotiate authentication requirements with the RP 104. By way of example, an authentication requirement may refer to an assurance level, which may represent a specific strength of authentication that is required. The MFAP 110 may further negotiate authentication requirements with the user 107 and/or the UE 102. As described further below, the MFAP 110 may translate assurance levels to factors of authentication. In particular, the MFAP 110 may translate assurance levels to a granular level of appropriate authentication methods or protocols. The MFAP 110 may identify appropriate identity providers (IdPs) based on an identity of the UE 102 or the user 107. Further, the MFAP 110 may trigger factors of authentication by invoking corresponding IdPs or corresponding client authentication agents (AAs). In an example embodiment, the MFAP 110 is a policy decision point for authentication. The MFAP 110 may maintain a freshness level for each authentication factor. As used herein, the freshness level that is associated with an authentication factor indicates a time when an authentication using the authentication factor was performed. By way of example, the SP 104 may require a certain freshness level for an authentication factor. By way of further example, the SP 104 may determine that an authentication is acceptable if the authentication took place less than 30 minutes ago, but the authentication is unacceptable if it took place greater than 30 minutes ago. The time of 30 minutes is merely exemplary, and the freshness level requirement may stipulate any appropriate time as desired. Still referring to FIG. 1, the MFAP 110 may consolidate results of a plurality of authentication factors to create an assertion. The assertion may include an assurance level and a freshness level that meets or exceeds a required assurance level and a required freshness level, respectively. The freshness level may be a consolidated freshness level that represents an aggregate freshness of multiple authentication factors. The results of the various authentication factors may be communicated by an Authentications Server (AS) to the MFAS 106. Alternatively, the results may be communicated by the Local Authentication Agents to the MFAP 110, which may then communicate the results/assertions to the MFAS 106. Instead of, or in addition to, the consolidated freshness level, the assertion may include a freshness level for each of the plurality of authentication factors. The MFAP 110 may use multiple devices to perform authentication devices. For example, the user 107 may own or operate each of the multiple devices that are used in a multi-factor authentication. Such a scenario may be referred to as a split-terminal scenario. The MFAP 110 may work with a policy engine, which may also be referred to as a policy layer, such that policy may be locally stored on the UE 102 or policy may synchronized with a network entity, such as the MFAS 106 and/or the RP 104 for example.

With continuing reference to FIG. 1, the MFAP 110 at the client side may perform similar and complementary functions as compared to functions that the master IdP 106 performs. For example, in a scenario where the user 107 is authenticated on the UE 102, which may be referred to as on-device based authentication, the MFAP 106 may mimic at least some of the functions, for instance all of the functions, that the master IdP 106 performs when the master IdP 106 authenticates the user 107. The MFAP 110, via a user interface of the UE 102 or the browser 108, may request that the user 107 begins a password-based authentication. Similarly, the UE 102, and in particular the SIM/UICC 114 may be triggered to perform a device authentication, such as generic bootstrapping architecture (GBA) authentication for example. The biometric client 112 may be invoked to perform a biometric authentication. For each of the authentication clients on the device side, there may be an associated authentication service on the network side. For example, in accordance with the illustrated embodiment, the biometric client 112 may communicate with a biometric authentication server 116, which may be part of the master IdP 106. Alternatively, the biometric authentication server 116 may be separate from the master IdP 106, but communicatively coupled to the master IdP 106 via a biometric proxy function 118 of the master IdP 106. A password server 120 may communicate with the UE 107 to authenticate the user 107 using a password. The password server 120 may be part of the master IdP 106, or alternatively communicatively coupled to the master IdP 106. The master IdP 106 may include, or alternatively be communicatively coupled to, a network application function (NAF) 122 that interacts with a bootstrapping server function (BSF) 124. The master IdP 106 may further include, or alternatively be communicatively coupled to, a AAA server 126 that interacts with a Home Subscriber Server (HSS) 128. The master IdP 106 may invoke, based on an authentication requirement for example, the various authentication services that may be associated with authentication clients on the device side.

In accordance with an example embodiment, after one or more authentication factors are authenticated, the master IdP 106 creates an assertion. The assertion may include an assurance level that is achieved by one or more authentication factors. The assertion may further include freshness information that is associated with the one or more authentication factors. The assertion may be presented to the RP 104 so that the user 107 and the UE 102 may receive access to a service that is provided by the RP 104.

Still referring generally to FIG. 1, multi-factor authentication can be driven by policies, such as policies that are associated with a service that is provided by the SP 104. Described herein are methods that support policy driven multi-factor authentication in federated identity management scenarios. For example, the SP 104 can use a federation service to request multi-factor authentication such that the SP does not need to establish a direct trust relationship with the end user 107. Further, using the system 100 for example, the SP 104 can request a multi-factor authentication without the SP 104 having the infrastructure for multiple authentication factors.

In order to access a service, the user 107 may have to meet authentication requirements of the SP 104 that provides the service. Authentication requirements may be based on authentication policies of the various services. For example, a policy of the SP 104 may require that an authentication meets a predetermined assurance level, which may also be referred to as an authentication strength, before a service that is provided by the SP 104 is accessed. Thus, policies can be expressed as assurance levels. Assurance levels may indicate a strength of an authentication, and a high assurance level may require multiple factors of authentication. In an example embodiment, the assurance level refers to a level of assurance in which a user is authenticated. The assurance level may be based on which authentication protocols are used, a number of factors for authentication, a type of authentication factor (e.g., biometric, device, user) a freshness of the authentication, supplementary conditions, or any appropriate combination thereof. The assurance level may be defined by an external authority. In an example embodiment, desired assurance levels are specified by various external authorities, such as standard bodies including, for example, National Institute of Standards and Technology (NIST), 3rd Generation Partnership Project (3GPP), World Wide Web Consortium (W3C), or the like. For example, an external authority may specify assurance levels based on various criteria such as, for example, security requirements of an application itself, security policies of a company that hosts the requested service, or the like. By way of further example, the SP 104 may specify an assurance level that it requires in order for the SP 104 to provide a requested service to the user 107.

In some cases, a required level of assurance is based on a risk associated with a service that is requested. For example, if the requested service includes the transmitting and receiving of sensitive information, such as a banking service that transmits and receives bank account information for example, the required assurance level may be high. A high assurance level may be satisfied by performing a multi-factor authentication. By way of further example, if the requested service is associated with little risk, for example a service that does not have access to personal information, the required assurance level may be low. For example, a low assurance level may be met by a password authentication. Thus, service providers, such as the SP 104 for example, can provide granular services such that the strength of authentication is matched to the risk associated with the service, thereby avoiding excessive inconvenience to users.

In an example embodiment, the SP 104 discovers the authentication capabilities of the UE 102 and the user 107. Based on the discovered authentication capabilities, the SP 104 may select and specify one or more authentication factors that should be carried out to achieve the required level of assurance. Alternatively, the master IdP 106 may discover the authentication capabilities of the UE 102 and the 107. For example, the SP 104 may delegate discovery of the authentication capabilities to the IdP 106. Thus, based on the discovered authentication capabilities, the IdP 106 may select and specify one or more authentication factors that should be carried out to achieve the required level of assurance. The SP 104 may delegate discovery of capabilities to the IdP 106 by indicating a risk associated with the user 107 accessing a requested service that the SP 104 provides. The SP 104 may also indicate a level of assurance that is required for the user 107 to access a service that is provided by the SP 104. For example, an assurance level requirement may be communicated to the master IdP 106, which can be referred to as the MFAS 106, using various means. By way of example, OpenID Provider Authentication Policy (PAPE) extensions, which can be simply referred to as PAPE extensions, can be implemented such that the RP 104 uses the PAPE extension to provide any necessary details regarding assurance level requirements to the MFAS 106. In an example implementation of the MFAS 106, which can be generally referred to as a policy server, an intelligent policy engine on the MFAS 106 is implemented such that receiving information, the MFAS 106 can dynamically generate required policies and execute the generated polices based on any given assurance level. Example information that can be received by the MFAS 106 to generate policies includes, presented by and way of example and not by way of limitation, a policy of the user 107, a policy of the SP 104, requirements for accessing a particular service provided by the SP 104, or the like.

Still referring to FIG. 1, service providers, such as the SP 104, may have authentication strength requirements for accessing various services. For example, in order to access a service provided by the SP 104, users may need to be authenticated such that the authentication satisfies the authentication requirements of the SP 104. In some cases, an authentication requirement may include a delegated authentication scenario, such as a scenario that uses federated identity management protocols such as OpenID 2.0 or OpenID Connect for example. Because various example embodiments described herein can be implemented using various federated identity protocols (e.g., SAML, OpenID 2.0, OpenID Connect), it will be understood that embodiments that are described in the context of a particular protocol are not so limited. For example, multi-factor authentication may be implemented in various embodiments such that the authentication is not federated and the service provider 104 performs the functions that may be described herein as being performed by the federated identity provider 104. A policy management function described below may be a pluggable module that may be added to an identity management system to enable user-friendly, flexible multi-factor authentication.

As mentioned above, service providers, such as the RP 104 for example, may request that an authentication of a user use multiple factors for the authentication. The RP 104 does not need to have a direct trust relationship with the user 107 or the user's device (UE 102) because the RP 104 may request that other entities authenticate the user 107 or the UE 102. For example, service providers may request authentication using any combination of available authentication factors, without the need for services to implement authentication functions in their applications, services, or servers. Thus, the burden of implementing, maintaining, and managing authentication factors, as well as the enrollment of users and authentication factors, may be handled by the system 100 such that the RP 104 may use multi-factor authentication without investment in its own multi-factor authentication infrastructure. Example authentication systems, such as the system 100, are able to provide a flexible multi-factor authentication solution which caters to different requirements, different users, and different device types. Further, example systems described herein may provide multi-factor authentication as a service (MFAaaS).

In some cases, the SP 104 might request an authentication than cannot be delivered by the user 107 and/or by the user's current device (UE 102). For example, a requested authentication may require an authentication factor, such as a fingerprint authentication for example, that cannot be performed by a particular device. In such cases, the SP 104 may negotiate a service access based on the capabilities of the user/device. For example, the SP 104 may negotiate with the IdP 106 and the UE 102 to adjust a service that can be accessed according to an authentication strength that can be provided by the UE 102 and/or the identity provider 106.

By way of example, consider the case in which the user 107 is using a banking application on the UE 107, which may be a tablet computer for example, and the user 107 wants to make a transaction. The bank, which is the RP 104 in this example, may need to authenticate the user 107 using biometrics, but the user's tablet does not offer biometric authentication. In that case, the banking application might allow the user to check his balance, but will not allow any transaction to another account. Thus, the SP 104 may provide a limited access based on a device's authentication capabilities. The limited access may be less than a full access that was requested, but it may be greater than no access.

As described herein, services may be classified into a plurality of types, for instance two types. For example, services that have strict and clear requirements, such as services that need to get authentication from specific factors, can be referred to herein as Type 1 services. Example services that have requirements that include a level of assurance, which can be referred to as an indication of a required authentication strength, can be referred to as Type 2 services. The required authentication strength can be translated to various authentication factors or combinations of different authentication factors. Service providers that provide Type 1 services may request user and device capabilities and may request authentication using specific factors. Service providers that provide Type 1 services may evaluate authentication results from the different factors on their own. Type 2 services can request a specific level of assurance that needs to be met. The level of assurance that is required may be met by performing one or more authentication factors, which may be selected based on authentication capabilities of a user and device. After the authentication factors are performed, a result that combines results from each of the authentication factors may be returned to the service provider.

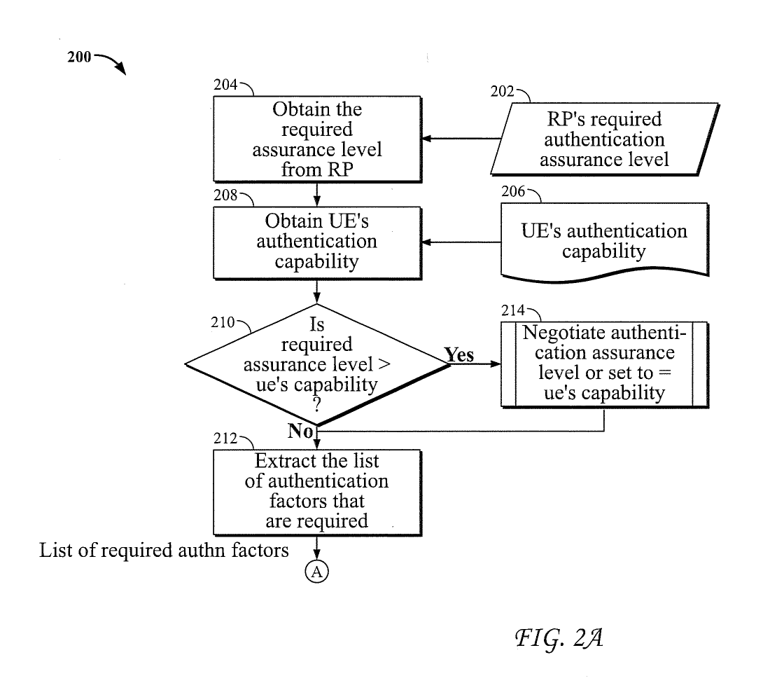

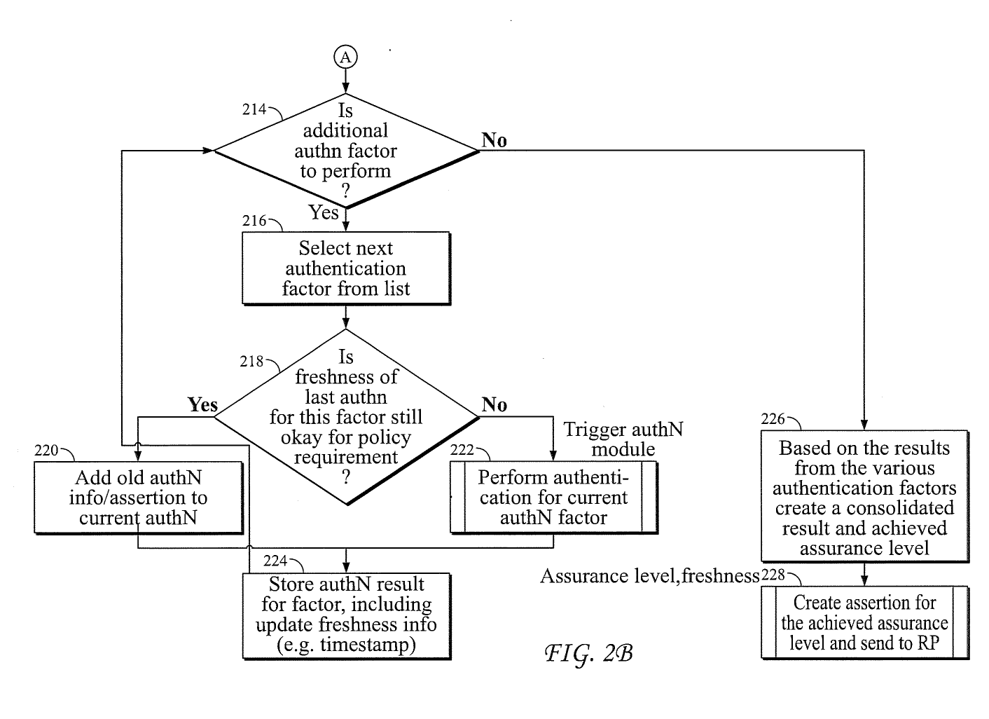

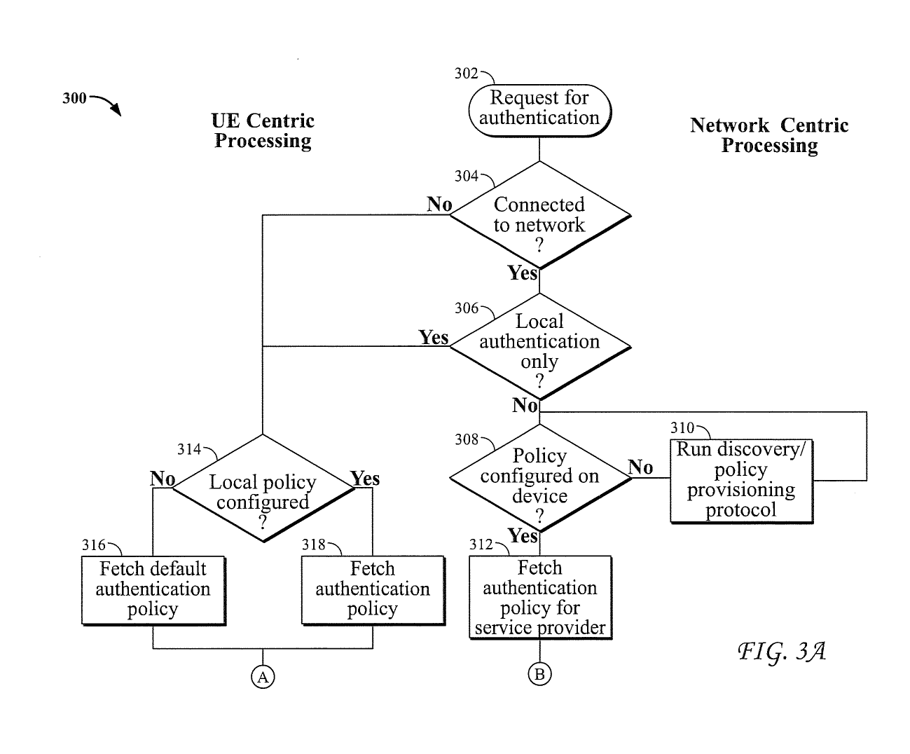

Referring to FIGS. 2A-B, an example multi-factor authentication 200 for a Type 2 service is shown. In an example embodiment, the multi-factor authentication 200 may be performed by the system 100, such as the IdP 106 for example. Referring to FIGS. 1 and 2A-B, in accordance with the illustrated embodiment, the RP 104 includes a required authentication assurance level 202. The authentication assurance level 202 may represent a level of authentication that must be met before the user 107 and the UE can access a particular service that is provided by the RP 104. At 204, the IdP 106 obtains the authentication assurance level 202 from the RP 104. The UE 102 may include an indication of its authentication capability 206. At 208, the IdP 106 obtains or discovers the authentication capability 206 of the UE 102. At 210, in accordance with the illustrated embodiment, the IdP 106 determines whether the discovered UE's authentication capability 206 can meet the authentication assurance level 202. If the UE's authentication capability 206 can meet the required authentication assurance level 202, the IdP 106 may select one or more authentication factors that achieve the required authentication assurance level 202 based on a policy requirement of the RP 104. The required authentication assurance level 202 may also be referred to as a first authentication assurance level 202. For example, at 212, the IdP 106 may extract a list of authentication factors that are required. If the UE's authentication capability 206 cannot meet the required authentication assurance level 202, at 214, the IdP 106 may negotiate with the RP 104 to determine a second authentication assurance level. The second authentication assurance level may be based on the authentication capabilities of the UE 102 such that the second authentication assurance level is equal to the capabilities of the UE 102. By way of example, the second authentication assurance level may be less than the first authentication assurance level. After the authentication assurance level is negotiated, the IdP 106 may select one or more authenticaton factors that achieve the required authentication assurance level, at 212, based on a policy requirement of the RP 104.

Referring to FIG. 2B, in accordance with the illustrated embodiment, at 214, the IdP 106 determines whether one of the selected authentication factors needs to be performed. If one of the authentication factors needs to be performed, the authentication factor is selected from the list at 216. After the authentication factor is selected from the list, at 218, it is determined whether a freshness level associated with the authentication factor is sufficient, based on a policy requirement of the RP 104. If the authentication factor is associated with a sufficient freshness, the authentication for the authentication factor need not be performed, and previous authentication information can be added to an assertion at 220. If the authentication factor is not associated with a sufficient freshness, meaning that that an authentication of the authentication factor has expired or is stale, the authentication for the authentication factor is performed and the information can be added to an assertion at 222. At 224, authentication results, including associated information such as logging information (e.g., time of authentication, number of retries, etc.) can be stored at the IdP 106. The authentication results can include associated freshness information, such as a timestamp that indicates the time that various authentications were performed for example. After a given authentication result is stored, the process may return to step 214 where it is determined whether another authentication factor needs to be performed. If there are no other authentication factors to perform, the process may proceed to 226, where a consolidated assertion is created. The consolidated assertion may be based on one or more authentication results that are associated with the performances of each of the one or more authentication factors. The consolidated assertion, which may be referred to as a consolidated result, achieves an authentication assurance level, for instance the first authentication assurance level or the second authentication assurance level, that is required by the RP 104. At 228, the consolidated assertion is sent to the RP 104, thereby enabling the UE 102 and/or the user 107 to access a service provided by the RP 104.

As illustrated, FIGS. 2A-B illustrate a flow for execution of the authentications at the IdP. Other alternatives are within the scope of this disclosure. For example, as described below, the authentication factors can be performed locally or they can be split such that some factors are performed locally on the UE 102 and others are performed on the IdP 106. Additionally, the assertion may also be generated locally and delivered directly to the RP 104 without involvement of the IdP 106, in accordance with an example embodiment. This may be implemented, for example, if all authentications are coordinated locally on the UE 102.

Referring generally to FIGS. 2A-B, the multi-factor authentication 200 depicts a sequential processing of the individual authentication factors, although authentication factors may be alternatively processed, for instance simultaneously process, as desired. An order of the authentications can, for example, be determined by a strength associated with each authentication factor. For example, the strongest authentication factor can be processed before the weakest authentication factor. By way of another example, an authentication factor that does not require user input may be processed before an authentication factor that requires a user input (e.g., a fingerprint). For each authentication factor, the result of the authentication and freshness information may be stored. As shown, after required authentication factors have been processed by the IdP 106, the IdP 106 can create a combined assertion that represents the results of each of the factors.

Assertions may be flexible data structures that may cover Type 1 and Type 2 services. Assertions may be generated during multi-factor authentication. Assertions may use templates based on a device. Following are some examples of assertion types, presented by way of example and not by way of limitation, a generic authentication assurance level assertion, an assertion for some identifiers used (e.g., IMSI) for accountability/non-repudiation, a full assertion on all factors (e.g., including challenge-response pairs, cryptographic assertion of factor binding), or a chained assertion or a collection of individual assertions that are bound together. The assertions that are bound together may include an indication of how the individual assertions are bound with each other. Assertions may be generated locally on a user device. Such assertions may be combined with assertions generated in the network. An assertion may indicate a generic assurance level (lightweight for the Service Provider) or more detailed as described above.

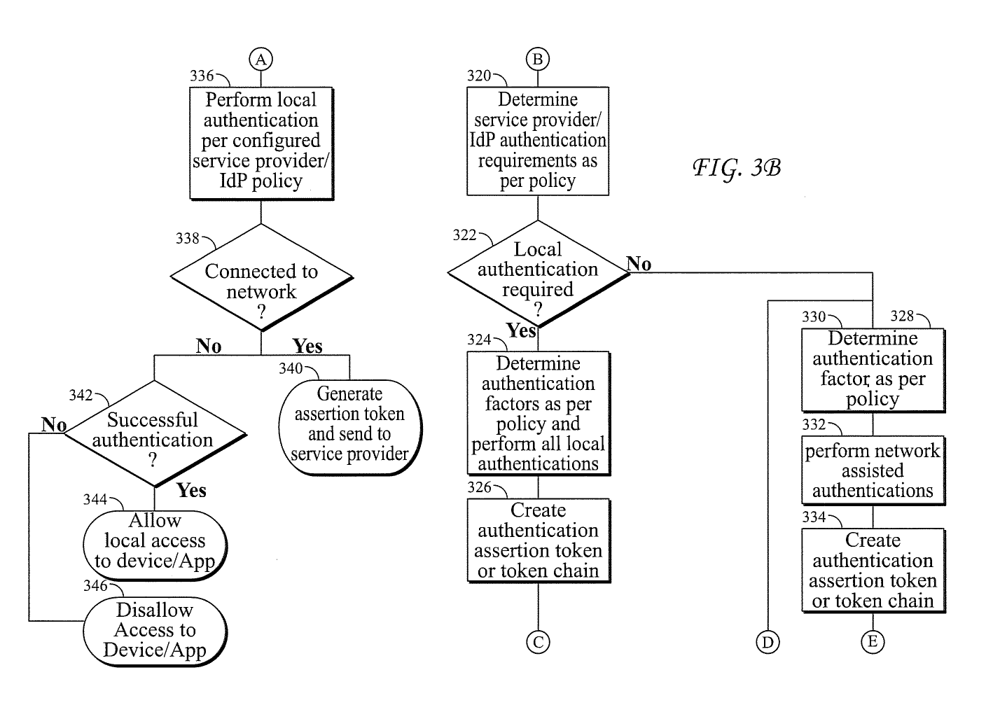

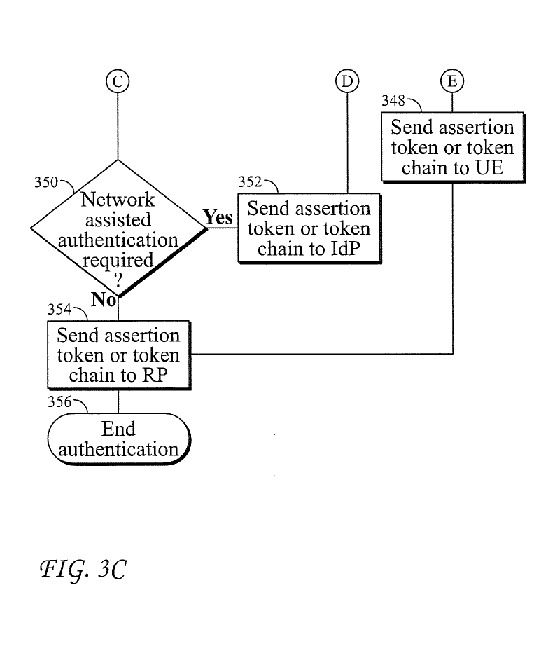

Referring to FIGS. 3A-C an example multi-factor authentication 300 is depicted. The processing of the illustrated multi-factor authentication 300 is divided into two parts. In accordance with the illustrated embodiment, one part is executed on a device, and thus may be referred to as “UE centric processing,” and one part may be executed by various network entities that may communicate with the device via a network. This part may be referred to as “Network centric processing.” The illustrated authentication 300 shows that the multi-factor architecture described herein may be used to authenticate and enable access to local functions on a device as well as access to network services. At 302, a user or an application on a UE issues an authentication request, which may eventually authenticate the user and/or UE toward a network entity, such as a relying party for example. At 304, the UE determines if a network connection is available. If no network connection is available, the illustrated process proceeds to 314, where a UE authentication proxy, for instance the MFAP 110, determines whether a local authentication policy is configured for the requested authentication, so that authentication can be carried out locally. If it is determined at 304 that there is a network connection, the process proceeds to step 306, where the UE, and in particular the MFAP 110, is configured to perform local authentication. At 314, if a specific local authentication policy is available, the UE (MFAP) may fetch the policy at 318. If the specific authentication policy is not available, a default policy may be fetched at 316

With continuing reference to FIGS. 3A-C, at 336, in accordance with the illustrated embodiment, the authentication policy is executed using locally available authentication factors. If a network connection is present, which is determined at 338, the UE, and in particular the MFAP 110, generates a signed token, at 340, and sends it to an SP for accessing a service from the SP. The signed token indicates whether the local authentication is successful or unsuccessful. If network connection is unavailable at 338, the UE/MFAP checks for successful local authentications, at 342. For example, if there has been a successful local authentication (e.g., at 336), access may be permitted to a device resource, at 344. A local device resource may include an application that executes on the UE. In accordance with the example embodiment, if the local authentication was not successful, access to the UE or resource hosted on the UE may be disallowed, at 346. If, at 306, it is determined that network side authentication is possible, a specific authentication policy is looked up at 308. At 308, it is determined whether specific authentication policy is available on the UE. If it is available, the process proceeds to step 312, where the specific policy, which may be associated with a particular SP, is fetched. If, at 308, it is determined that the policy is unavailable, a policy provisioning protocol run is attempted between the UE/MFAP and a network side IdP (e.g., the MFAS 106), at 310. The steps at 308 and 310 may be repeated one or more times. After receiving or fetching the authentication policy that may be associated with the SP, the various network side and local authentication requirements are separated at 320. At 322, it is determined whether only local authentication factors are required by the SP. If only local authentication factors are required, in accordance with the illustrated embodiment, the process proceeds to 324, where the local factors are executed by a function that may be substantially identical to the function used at 336. At 326, a token chain may be prepared. The token chain may contain assertions over the locally executed factors.

Still referring to FIGS. 3A-C, in accordance with the illustrated embodiment, at 350, it is determined whether network-assisted authentication is required to access the requested service that is provided by the SP. If a network-assisted authentication is necessary, the process may proceed to step 352, where the signed token containing the assertions over the local factors is sent to the network IdP/MFAS for execution of the required network assisted factors. If no network assisted factors are required, then the signed token is sent to the SP at 354, and the authentication ends successfully at 356. If at 322, it was determined that no local authentications are applicable as per the specific policy requirements of the SP, or if, at 350, it was determined that network assisted authentication is required in addition to the local authentication factor(s), then, at 328, the network authentication factors are determined at 328/330. At 332, the network authentication factors are initiated and executed. Note that steps, such as step 332, may involve interaction between one or more network entities, such as the MFAS 106 and the MFAP 110 for example, and/or one or more third party authentication servers described herein (e.g., MNO, UICC, etc.). At 334, in accordance with the illustrated embodiment, the assertion token chain, which may already contain the local authentication assertions, is amended by adding assertions corresponding to the one or more network authentication factors that were executed. Thus, the complete token chain, which may be referred to generally as a combined or consolidated assertion, is sent to the SP/RP via the UE at 348 and 354, which ends the authentication process at 356.

As described herein, the authentication capacities of devices, such as the UE 102, may be discovered. Examples of authentication capabilities that may be discovered include capabilities to perform: UICC-based authentications such as authentications that are supported by mobile networks (e.g., using AKA, GBA, or EAP-SIM); authentications that use a secondary channel, such as an OTP sent over SMS for example; biometric authentications using a biometric reader and an associated backend service; authentications using a user name/password used with an Internet IdP (e.g., email address/password); authentications using cryptographic tokens (e.g., NFC chip of a government-issued e-identity card); authentications using user behavioral analytics; or authentications using challenge/response mechanisms operating between the User/UE and an authentication end point, such as an IdP for example.

Authentication capabilities, which may also be referred to as authentication functions, may be detected by an SP or an IdP. An authentication capability may refer to an ability to perform authentication using a particular authentication factor. Thus, it can also be said that authentication factors of a user or a device may be detected by an SP or an IdP. In one embodiment, when authentication capabilities are detected, a secure association between each capability and a single user is maintained at the SP or the IdP. This secure association may allow, at a later time for example, the establishment of an assurance level that corresponds to a user and a particular authentication protocol, which may be required by a particular SP. Further, when authentication factors are detected, identifiers corresponding to each authentication factor may be associated with a user identity or an identifier of a UE, and the association of authentication factors and users or UEs may be stored in a user authentication database. Storing the association may help coordinate performance of various authentication factors by different parties independent of the IdP. For example, fingerprints may be authenticated by one party and passwords may be authenticated by another party. The user authentication data base (DB) may reside at the MFAS 106.

In some cases, one or more authentication factors are built into a device architecture at time of manufacture of the device. In other cases, authentication factors are software functions. Such functions may pre-loaded when the device is purchased or loaded by the user after purchase of the device. Other authentication factors used herein may be a combination of the above. Therefore, it is recognized herein that it is important that the factors of authentication take into consideration the security of the function as implemented and executed on the platform, so as to enable an external authenticator to assess the overall level of assurance or confidence in the performance of the authentication factor. For example, a device may offer a fingerprint authentication capability, but if the security surrounding the performance of the fingerprint-based authentication is weak (not strong) from a device security architecture perspective, then the level of assurance or confidence may be modulated. By way of example for purposes of illustration, the Apple iPhone 5S has a fingerprint authentication capability in which all functions from the capture of the fingerprint to the authentication are carried out in a secure manner, and are not visible to the main processor. By way of further example for purposes of illustration, a different type of phone device (e.g., the Samsung S5) may also possess a fingerprint authentication capability, but the fingerprint authentication capability of the different may be implemented with software and hardware to perform the authentication. If the software is not well protected, for example, then the level of assurance or confidence in the latter processor may be considered less than an Apple iPhone 5S. The above examples illustrate that not all authentication capabilities should be considered the same from a security perspective, even if they rely on the same factor (e.g., fingerprints). The above examples further illustrate that the level of assurance may vary from one device to another for a particular authentication factor, even if the particular factor performed on both devices is of the same type.

Thus, it may be important to securely ascertain not only the type of authentication factor supported by a device, but also the security surrounding the performance of the authentication. In accordance with various example embodiments, this may be assessed by way of a discovery protocol that begins with a unique immutable identifier of the device. Additional information may be gleaned, from the identifier, through trusted third parties. For example, one party may be the manufacturer of the device that has obtained a certification for the device from an independent and trustworthy certification house. Similarly, the software aspects of the device may also be assessed through assessing the security of software components on the platform and their level of certification. This information (e.g., hardware and software certifications) may be included with an attestation of the device. Thus, the total security state of the platform of the device may be ascertained. In particular, for example, an assessment of the authentication capabilities of the device may be gathered in a trustworthy manner to enable assessment of the authentaction assurance level that the device can achieve by using the various factors of authentication that are available on the device.

Referring again to FIG. 1, discovering one or more authentication capabilities of a device or user, for instance the UE 102 or the user 107, is done securely in accordance with various example embodiments. For example, the user 107, using the UE 102, may browse to a website of the IdP 106. The IdP 106 may include the MFAS 106 that enrolls users and devices. A secure channel is established between the user 107 and the MFAS 106 based on a successfully carried out authentication. By way of example, an email may be sent to the user's email address, which is his IdP 106 identifier. The email may contain links to download software from the MFAS 106 to the UE 102, or to multiple devices. This piece of software, downloaded by the user, may act as a local proxy of the MFAS 106, referred to as the MFAP 110. Thus, the MFAP 110 is equipped with the IdP identity of the user.

The MFAP 110 may use various local interfaces and APIs to determine authentication capabilities, for example authentication protocols, that are available on the UE 102. The MFAP 110 may further determine authentication capabilities (functionalities) in a trustworthy manner. The authentication capabilities may also be discoverable by the MFAS 106 such that the information is traceable to a trustworthy third party. For example, the authentication capabilities of the UE 102 may be certified during manufacture of the UE 102 and bound to a permanent immutable device identity, thus providing an externally accessible level of assurance in performing particular authentications that correspond to the certified authentication capabilities. Once at least some, for instance all, of the factors of authentication have been ascertained or discovered, the MFAS 106 may push authentication capabilities and policies to the MFAP 110.

In accordance with an example embodiment, in some cases, the MFAS 106 may autonomously determine specific identifiers associated with authentication capacities. For example, the MFAS 106 may determine an IMSI for the identity (ID) of the UE 102. In some cases, the MFAS 106 may not be able to determine some identifiers. In such cases, the MFAS 106 may prompt the user 107 for the identifier(s). Identifiers may be collected with any other required characteristics, such as address information of backend servers for example, that correspond to the supported authentication capabilities. A user record may be stored, for example, by the MFAS 106. The user record may consist of collected identifiers for the various authentication capabilities that correspond to the user 107 and/or the UE 102. The user record may further include supplementary data that was collected by the MFAS 106.

Still referring generally to FIG. 1, to enable execution of multi-factor authentication between the UE 102 (or user 107) and various entities that perform authentication, which may be collectively referred to as authentication endpoints that are local or in the network, trigger messages are sent to the authentication end points. Trigger messages for each authentication factor may be sent at various stages in a multi-factor authentication.

In some cases, the target of a trigger message is a mobile device, such as the UE 102. In an example scenario in which multi-factor authentication is based on OpenID, there may be an HTTP REDIRECT message coming from the IdP 106, which may be referred to as the OpenID server 106, that is directed toward the UE 102. It is recognized that the redirect message typically redirects the browser 108 to an authentication web page. In an example embodiment, instead of the redirect message redirecting the browser 108 to a web address of the form “HTTP REDIRECT http:// . . . ”, a different URI scheme may be used to call for a different handling of the transmitted URI by the UE 102.

In another embodiment, various protocols may be used to carry-out Multi-Factor Authentication, which can be non-federated or federated. For example, OpenID is one such protocol. SAML may also be used to perform a certain subset of Multi-Factor authentications. The combined result of the authentications and the assertions may be transported using a single assertion, based on OpenID/OpenID Connect for example, or via SAML. Alternatively, a combination of protocols may be used to transport authentications and assertions.

In accordance with an example embodiment, one of the functions of the MFAP 110 is to support tailored front ends of the UE 102 that support authentication of the user 107 (user authentication). A tailored front end of the UE 102 may support various combinations of authentication factors that need to be used to achieve assurance of authentication. Such a front end may be generated by an authentication front end (AFE).

The AFE may dynamically generate a user front end that is used to guide the authentication flow on the UE 102. The user front end may be generated using various protocols, such as HTML5 or Javascript for example. The front end may be generated by the AFE autonomously or by user interaction with the UE 102. For example, authentication factors such as biometrics, passwords, or the like may require user interaction and have confirmation built in. Alternatively, mobile network based factors for device authentication, such as GBA and EAP-SIM for example, may be carried out without the user 107 interacting with the UE 102. In order to protect from malicious and hidden creation of assertions and authentications, authentication factors may be at least confirmed by the user. User interaction can include receiving permission from the user 107 to allow the use of various credentials related to the user for authentication. Credentials may include device information or other stored information. For example, user permissions may be received by the UE 102 via one or more buttons the user 107 needs to press before the authentication factors are triggered. A user interface of the UE 102, such as a display, can render an indication, such as a color (e.g., green) indication, after each authentication is complete.

In various example embodiments, the user 107 is presented with a confirmation screen that shows information about the factor being used. The confirmation screen may further display the web page or service for which the authentication factor is being used. The user 107 may have an opportunity to verify that his or her authentication information can be used. The user interfaces may be dynamically generated such that they are tailored based on the user, the device, the service, or the authentication. For this dynamic user interface generation not to burden the service, it may be offloaded to the AFE, as described below.

The front end that may be generated by the AFE may interface to the MFAP 110 via an API, and the MFAP 110 interface with various authentication factors via their specific APIs. The AFE may also communicate with the MFAP 110 via a device connector to enable the MFAP 110 to generate the front end and locally execute multi-factor authentication. A similar mechanism may also facilitate coordination of the authentication with the MFAS 106.

As described further below, authentication factors may be logged and synchronized with a network policy entity. A log stored on the UE 102, which may be referred to as a local log, may be used, for example, when connectivity to the MFAS 106. The local log may allow for synchronization with the MFAS 106 when connectivity becomes available. The log may include a session handle, an indication of specific authentication carried out, time associated with the authentication, a number of retries, an outcome of the authentication, or the like.

In some cases, a freshness of each individual authentication factor is checked to determine if a previous authentication result may be re-used without burdening the user 107 by repeating an authenticating process. Further, authentication requests may be lessened when authentication factors are fresh, which may decrease the burden on network authentication servers. In one embodiment, the MFAS 106 is to generate an assertion for the desired assurance level based on authentication factors that are fresh. In an example scenario, at least one, for instance all, of a plurality of authenticated results can be re-used if the individual factors of the multi-factor authentication are fresh. For example, the MFAS 106 can assert to a lower assurance level after some of the factors have become stale. Such a lower level may be adequate to access a service, and thus MFAS 106 may assert to the lower assurance level so that it does not need to trigger new authentications to be performed. In an alternative embodiment, the MFAP 110 controls freshness. For example, when the user 107 locally authenticates to the UE 102 (e.g., using biometrics) independently from service access, the freshness of the user authentication with the UE 102 may be updated each time the user 107 authenticates with the UE 102, and the update may be signaled to the MFAS 106. Each assertion may contain freshness information association with the assertion.

Referring again to FIG. 1, as described above, the SP 104 may require an authentication before the UE 102 and the user 107 are allowed to access a service that is provided by the SP 104. The SP 104 may set the requirement for user authentication, for instance according to a company policy or legal requirements. The required may also be based on the type of data or service that is being accessed. In an example embodiment, to enable the multi-factor authentication according to a service policy, the assurance level and the policy on carrying out the multi-factor authentication is transported between entities, such as the RP 104, the UE 102, and the IdP 106 for example. For example, the RP 104 may communicate authentication requirements during an association between the RP 104 and the IdP 106, which may be an OpenID identity provider (OP), and thus the IdP 106 may also be referred to as an OP 106. The OP 106 may advertise supported authentication assurance levels in discovery protocols based on Yadis, for example.

An example way to pose policy requirements in an OpenID protocol run is for the RP 104 to use PAPE. PAPE contains generic terms that may be used to request multi-factor authentication and factor freshness. PAPE further includes a mechanism to define extensions in order to transport custom assurance level designations.

The MFAS 106 may include an interface for service providers to communicate authentication factors or negotiate authentication factors before an authentication is performed. Using an example discovery protocol, which may be integrated into the existing OpenID 2.0 or OpenID Connect discovery protocols, for example, the SP 104 may determine a list of authentication factors that are available for a specific user, such as the user 107. In an example embodiment, an assurance level database and logic function, which may be part of the MFAS 106, translates a risk requirement of a service to factors of authentication with corresponding freshness requirements. Alternatively, the service may directly specify a set of authentication factors based on the supplied authentication capabilities of the UE 102. Depending on the configuration and identity mapping for the user 107, for example, the MFAS 106 can return a list of all devices associated with the user 107 and all factors associated with the user 107. Alternatively, the MFAS 106 can return a list of authentication factors that are associated with only the current device 102 that the user 107 is using. Based on the list of authentication capabilities, the SP 104 may select a suitable authentication factor or combination of multiple factors, and request authentication according to the selected one or more factors.

Still referring generally to FIG. 1, in another example scenario, the SP 104 may request that the UE/user be authenticated to an assurance level that matches a required risk profile, for example, in order to avoid the burden of ascertaining the factors of authentication that are supported by different users/UEs. For example, the SP 104 can request a minimum (and also a maximum if desired) level of assurance that it requires for the UE 102 to access the service. The MFAS 106 may then compile a list of authentication factors to use for the authentication. The list may compiled based on a best fit or an ease of use for the user 107 to achieve this assurance level.

The MFAS 106 can take into account different characteristics to determine the list of authentication factors. Example parameters include a cost of authentication, user preferences, least friction to the user, privacy requirements, security of the authentication process, energy consumption on the device, bandwidth load on the network and backend, legal conditions, freshness and re-usability of existing authentications, or the like. Based on the assessment of these example characteristics, the MFAS 106 can derive the list of factors that can be used in order to achieve the desired level of assurance.

As mentioned above, specific authentication factors may be required by the SP 104. For different services or URL domains, the service may be associated with different assurance levels. At the MFAS 106, for example, static URL policies may be matched against different authentication factors and those authentication factors can be invoked for different URL domains.

In one embodiment, at the MFAS 106, the mapping of URL substrings against authentication factors is used to execute the corresponding authentication factors for the static service provider URLs. Additionally, sub-domains of a particular service provider may also request different authentication requirements. By way of example, in an Amazon checkout scenario, a URL substring Amazon/cart is mapped against an authentication requirement, which may be required assurance level. If the “openid.return_to” contains this substring, then the specified authentication factors are invoked. In other words, an RP may have a corresponding (e.g., more granular) assurance level requirements based on the services that are being requested from the RP. A high risk transaction may require a higher assurance level as compared to a lower risk transaction. Thus, the assurance levels requirements might not tie directly to the RP, but instead to the services being offered by the RP. Referring again to FIG. 1, a desired authentication requirement may be dynamically relayed by the RP 104 to the OP 106. Authentication based on selected authentication factors may be performed by the MFAS 106, and the result of the authentication that includes the selected authentication factors may be communicated to the RP 104 from the MFAS 106.

An example message for trigger an authentication factor is: soid.scheme://<method>.<factor>/<factor-data>, where “soid.scheme” is a URI schema to call on a generic function in the UE 102 that handles authentication factors. This internal entity's main task is to dispatch the factor authentication process within the UE 102. For example, the dispatch may include a call to an appropriate function within the UE 102 to perform the authentication. It will be appreciated that functionality to handle of different URI schemas may be contained in a platform operating system of the UE 102. For dispatching, the location information in the URL part of the URI may be used. For example, this can be done in a hierarchical fashion as shown above, where <method> denotes a handler function that controls a subset of authentication factors with common traits, such as biometric factors or factors residing on a secure element such as the SIM card 114. The <factor> key may in turn denote the actual factor to be authenticated. The <factor-data> may be used to transport any data necessary for the authentication function on the UE 102 to perform its task. For example, it may hold challenge values when the factor is a challenge response authentication. Examples of the <factor-data> include, presented by way of example without limitation:

soid.scheme://sim.eap-sim/?challenge_rand=<RAND>,challenge_autn=
<AUTN>,...
soid.scheme://biometric.fingerprint-biokey/...
soid.scheme://soid.local/?<OpenID-parameter-set>
soid.scheme://soid.simple-password/?salted-
digest=<SALTED_DIGEST_VALUE>,salt=<SALT_VALUE>

It will be appreciated that the “soid.scheme://soid.local/?<OpenID-parameter-set> above denotes that the factor is an OpenID provider entity located on the UE 102, which may be referred to as a local OP. The last example listed above is a different scheme in which a password is locally requested from the user 107. A local authentication agent may authenticate the user 107 in this case, for example, by hashing the password provided by the user 107, combining it with a standard cryptographic method (e.g., using an HMAC) with the salt parameter, and comparing it with the slated-digest parameter. This method may be at least partly analogous to HTTP-DIGEST authentication.

An example extension of the above-described trigger messages is given by the following example: soid.scheme://soid.multi/?<multi-factor-policy>. A local entity on the UE 102 can handle such authentication factor requests (called by the ‘soid’ key), and the local entity may include a sub-component that is able to handle multiple authentication factors. That sub-component is called by the key ‘multi’ in accordance with the example. Any necessary data for the single authentication factors, and additionally policies on their joint execution, such as freshness required for single factors, may be included in the attached parameter set.

Alternatively, UE local factor authentication called from a server may be called custom JavaScript code inserted in a Web page and custom API calls therein, to initiate a local authentication client. Examples of such calls are described in 3GPP TR 33.823.

Still referring generally to FIG. 1, due to the distributed and federated nature of the system 100, service providers, in particular the SP 104, may request more factors or stronger authentication than can be delivered by the user 107. If the achievable or achieved authentication strength does not match the service requirements, the SP 104 can deny access because the presented authentication assertion is not according to the request, or the SP 104 can downgrade the service functionality based on the received authentication assertion.

In one embodiment, if the desired level of assurance cannot be reached by any combination of authentication factors, the IdP 106 may instigate a network/UE/user assisted mechanism to improve the authentication strength or assurance level. For example, the IdP 106 may start an interactive protocol in a bidding process with the SP 104, where the MFAS can respond with the highest assurance level that is reasonably reachable for the given user 107 and device 102. The SP 104 can then request authentication to the new assurance level, or the SP 104 downgrade or change the service offering such that service can be accessed with less assurance. Alternatively, by performing a challenge-response protocol for example, a stronger form of authentication factor may result to enable the initially requested service to be accessed.

As part of discovering the authentication assurance level that is achievable by the UE 107 or the user 102, the MFAS 106 can also take into account the freshness of past authentication factors to possibly re-use previous authentications. Freshness requirements may be different per authentication factor and per service. As part of a negotiation, service providers may indicate a ‘relaxed’ policy mode in which certain authentication factors are required with at least a relaxed freshness requirement. Varying freshness requirements depending on the authentication factor accounts for measured authentication factors that may decay over time at different rates.

In some cases, where there exists a capability to perform continuous authentication, for example using behavioral or biometric analytics, then the MFAS 106 may take advantage of that capability and utilize the measured assurance level of that authentication factor appropriately. Continuous authentication has the benefit of being able to authenticate a user without intrusion or with minimal interaction.

Different services or URL domains may be associated with different assurance levels. At the MFAS, static URL policies may be matched against different authentication factors, and those authentication factors are invoked for different URL domains. In one embodiment, at the MFAS 106, assurance level mappings of URL substrings against authentication factors are used to execute the corresponding authentication factors for the static service provider URLs. Additionally, subdomains of a particular service provider may also request different authentication requirements. As an example, for an Amazon checkout scenario, a URL substring Amazon/cart may be mapped against the required authentication requirement. If the “openid.return_to” contains this substring, then the authentication factors corresponding to the specified authentication assurance level are invoked.

The desired assurance level may be dynamically relayed by the RP 104 to the OP 106. Based on the communicated assurance level, the required authentication factors for the requesting user 107 are performed by the MFAS 106, and the attained assurance level and further information on the performed authentications is communicated to the RP 104 in accordance with various example embodiments. PAPE extensions may be used to communicate various information. The PAPE extensions are URL based and may provide information to the OP 106 related to the required assurance level. PAPE messaging may require proper request and response messaging schema to be consistently used.

In an example embodiment, the following parameters are included during an OpenID authentication request by the RP 104:
openid.ns.pape
Value: http://specs.openid.net/extensions/pape/1.0
openid.pape.preferred_authpolicies: Zero or more authentication policy URIs representing authentication policies that the OP 106 should satisfy when authenticating the user 107. If multiple policies are requested, the OP 106 should satisfy as many of them as it can. If no policies are requested, the RP 104 may be interested in other information such as the authentication age for example. This parameter provides a separated list of authentication policy URIs. Examples include:
openid.pape.preferred_auth_policies=http://schemas.openid.net/pape/policies/2007/06/phishing-resistant (or) http://schemas.openid.net/pape/policies/2007/06/multi-factor
openid.pape.auth_level.ns.<cust>: (Optional) This represents the name space for the custom Assurance Level. Assurance levels and their name spaces are defined by various parties, such as country or industry specific standards bodies, or other groups or individuals. This parameter includes URL that represents this Assurance Level.
Examples include:

openid.pape.auth_level.ns.nist=http://csrc.nist.gov/publications/
nistpubs/800-63/SP800-63V1_0_2.pdf
openid.pape.auth_level.ns.jisa=http://www.jisa.or.jp/spec/auth_level.html

In an example embodiment, the above field may be used to define a custom assurance level standard that is defined by the MFAS 106. The overall policies defined at the MFAS for the assurance level specifying the mapping to different authentication factors may be used as a reference.
openid.pape.preferred_auth_level_types: (Optional) A list of the name space aliases for the custom Assurance Level name spaces that the RP requests be present in the response, in the order of its preference. This parameter includes a pace separated list of the name space aliases, in the order of the RP's preference. An example:
openid.pape.preferred_auth_levels=jisa nist

This custom field may be used to send the required authentication level for this user that may be interpreted at the MFAS, and corresponding authentication factors may be invoked.

In response to a Relying Party's request, the following parameters are be included in the OpenID Authentication Response in accordance with an example embodiment. The response parameters are be included in the signature of the Authentication Response. An OP that supports this extension may include the following parameters even if not requested by the Relying Party. The response parameters describe the End User's current session with the OpenID Provider in accordance with an example embodiment. Example response parameters include, presented by way of example without limitation:
openid.ns.pape
Value: http://specs.openid.net/extensions/pape/1.0
openid.pape.authpolicies: One or more authentication policy URIs representing policies that the OP satisfied when authenticating the End User. If no policies were met though the OP wishes to convey other information in the response, this parameter is included with the value of http://schemas.openid.net/pape/policies/2007/06/none in accordance with an example embodiment. This parameter may provide a space separated list of authentication policy URIs, for example:
openid.pape.authpolicies=http://schemas.openid.net/pape/policies/2007/06/multi-factor or http://schemas.openid.net/pape/policies/2007/06/multi-factor-physical
openid.pape.auth_time:(Optional) The most recent timestamp when the End User has actively authenticated to the OP in a manner fitting the asserted policies. In accordance with an example embodiment, the times are formatted in the UTC time zone, indicated with a “Z”. No fractional seconds are included according to one example. An example of this parameter is: 2005-05-15T17:11:51Z. If the RP's request included the “openid.pape.max_auth_age” parameter then the OP includes “openid.pape.auth_time” in its response according to an example embodiment. If “openid.pape.max_auth_age” was not requested, the OP may choose to include “openid.pape.auth_time” in its response.
openid.pape.auth_level.ns.<cust>: (Optional) The name space for the custom Assurance Level defined by various parties, such as a country or industry specific standards body, or other groups or individuals. This parameter may provide URL that represents this Assurance Level. For example:
openid.pape.auth_level.ns.nist=http://csrc.nist.gov/publications/nistpubs/800-63/SP800-63V1_0_2.pdf
openid.pape.auth_level.ns.jisa=http://www.jisa.or.jp/spec/auth_level.html
openid.pape.auth_level.<cust>: (Optional) The Assurance Level as defined by the above standards body, group, or individual that corresponds to the authentication method and policies employed by the OP when authenticating the End User. A custom Assurance Level definition may define additional subparameter values that are expressed within its namespace, although for reasons of simplicity, this may be avoided if possible. This parameter may provide strings defined according to this Assurance Level.
Examples include:

openid.pape.auth_level.nist=1
openid.pape.auth_level.jisa=2

The above described PAPE extensions may allow for communication between the relying party 104 and the MFAS 106. The openid4java library provides certain classes to be used for PAPE communications. Those classes can be manipulated to communicate the needed information between the OP 106 and the relying party 104 regarding required and satisfied assurance levels, etc.

For the dynamic assurance level functionality described above, the MFAS 106 may store a mapping of at least some, for instance all, possible policies for assurance levels. For example, assurance levels may be mapped against the required number of network and local authentication factors. The MFAS 106 may also maintain a list of possible network and local authentication factors that the users may choose from depending on their device capabilities. The user 107 may be allowed to specify policies or preferences during a registration process. From the overall set of policies at the MFAS 106 and the capabilities of the user 107 and the UE 102, the MFAS 106 may create a policy subset from which it can choose to authenticate.

In accordance with various example embodiments, assurance levels map enumerations of levels of assurance of user authenticity defined by some trustworthy authority, to authentication protocols and supplementary conditions, such as freshness of authentication. The desired assurance levels can be decided by different external authorities. In some cases, a relying party or a service provider can be the external authority that determines the assurance level that required to provide a requested service to a user. The external authority might fix these assurance levels based on different set of criteria. Example criteria includes security requirements for the application or service itself, or security policies of the company that hosts the requested services.

Once the desired assurance levels are specified by the responsible authority, in accordance with an example embodiment, it is determined whether the user or the UE, referred to collectively as the user agent, that needs to perform the desired authentication has the capability to do so. After evaluating this, “per-device authentication mapping policies” may be generate based on the required assurance level and the capabilities of the user equipment in question. Mapping policies may be further generated based on a user preference of various forms of authentication factors. For example, a given user may not tolerate a challenge-response based authentication. By way of further example, a given user may prefer a biometric authentication as compared to a password-based authentication.

For example, a banking application may request a high assurance level and/or biometric authentication for full access to a bank account provided by the baking application. If a given UE does not provide biometric security capabilities, the IdP can negotiate with the RP. For example, the IdP can offer an EAP-SIM device authentication that is one of the authentication capabilities of the given UE. In response to the offer, the RP can then downgrade the service that it provides. For example, instead of providing a full access to the bank account, the RP may limit the transaction values or restrict certain transaction types. Alternatively, the IdP may perform a challenge-response protocol to increase the assurance level to the desired level, at the cost of inconvenience to the user. It is inconvenient to the user because the user may have to answer security questions so that the user is further verified (e.g., What is your mother's maiden name? What is the name of your first pet? Where were you born? etc.).

An assurance level mapping may change over time in accordance with an example embodiment. For example, the authentication capabilities of a device may change based on features being enabled or disabled, based on user preferences changing, or the like. A device may need to re-enrolled, as described below, when capacities change.

At the end of a multi-factor authentication, the SP may obtain a single assertion on the successful authentication(s) using the single factors, or a combined assertion according to an assurance level. There are different ways to compose and transport such assertions in accordance with various embodiments.

A standard method to create signed assertions is specified by the OpenID standards specifications. It consists of first establishing a shared key between an OpenID Provider (OP) entity and the Relying Party (RP), which requests the authentication of a user. This process is called association. In the present case, the OP entity is part of the MFAS system, also referred to as the OP Service function (OPSF), which establishes said shared key when an authentication request is received from an RP, and before executing the multi-factor authentication. After the successful execution of a multi-factor authentication policy, the MFAS may hand control to the OPSF entity, which then uses the aforementioned shared key to sign an OpenID assertion. The assertion may have different formats, such as a string of characters or a JSON Web token for example, according to standard specifications. In one example embodiment, an assertion also contain various data representing information elements that may represent, for example: specific details of the executed multi-factor authentication, the user identity that has been authenticated, or other contextual information. Some example options of how to compose meaningful assertions are detailed below.

In an embodiment in which PAPE was used to signal the assurance level and/or required factors, then that very information is automatically carried forward in an OpenID protocol run. After the authentications have been performed, the OpenID Provider signs the assertion, where the signature is carried out over the parameters included in the OpenID assertion request, including any PAPE parameters. That is, the signed OpenID assertion may contain an implicit assertion to the information regarding the authentication factors. In this case, it may be the OpenID Provider's obligation to vouch for the assurance level and the contained factor authentications.

In another embodiment, information about an identified user is exchanged using OpenID attribute exchange (AX) mechanisms. OpenID AX is an extensible mechanism for an OpenID Provider to store information about a subject (e.g., an identified user) and provide it to a requesting relying party. For instance, it may be assumed that a particular SP has completed the verification of a generic authentication assertion issued by the MFAS, which signifies that a multi-factor authentication has been successfully completed with the user and the UE. For example, an OpenID assertion may contain a PAPE field as described above. The RP/SP may be interested in details about the single factor authentications. For example, the RP/SP may desire signed assertions for each of the single factor authentications for forensic use. To obtain such information, the RP may send an OpenID AX Fetch Request to the OP, to request the list of available information. Example of requests follows:

openid.ns.ax=http://openid.net/srv/ax/1.0
openid.ax.mode=fetch_request
openid.ax.type.name=http://axschema.org/namePerson
openid.ax.type.mauthitem=http://multi-factor.org/schema/multi-auth-listing
openid.ax.type.auth_time=http://multi-factor.org/schema/timestamp
openid.ax.type.mauth_sig=http://multi-factor.org/schema/generic-signed
openid.ax.count.mauth=unlimited
openid.ax.required=name,mauthlist,mauth_signed

The above requests include a request for the list of actual authentications and also a request that the list of available information be signed by the identity provider. As an example, a user's real name may also be requested. It may also be important for the fullness of the authentication assertion to contain a timestamp, which may be defined as carrying the time at which the original OpenID assertion was created. Example responses include:

openid.ns.ax=http://openid.net/srv/ax/1.0
openid.ax.mode=fetch_response
openid.ax.type.mauthitem=http://multi-factor.org/schema/multi-auth-listing
openid.ax.type.mauth_signed=http://multi-factor.org/schema/generic-
signed
openid.ax.value.name=John Doe
openid.ax.count.mauth=3
openid.ax.value.mauth.1=eap_sim
openid.ax.value.mauth.2=password
openid.ax.value.mauth.3=biometric.fingerprint
openid.ax.value.mauth_sig= iVBORw0KGgoAAAANSUhEUgAAAAUA
AAAFCAYAAACNbyblAAAAHElEQVQI12P4==

The above example response to the fetch request contains the list of two authentications carried out. In the example, the full response, excluding the signature attribute line, is signed by the OP. The signature may be bound to the original OpenID assertion by using the same signing key to sign it. This may also the RP to immediately verify the response.

Because the RP knows the identifiers of the individual authentication factors, the RP may carry on to request more information about the individual factors, which may be required for forensic or general compliance purposes for example. For instance, the Service Provider (RP) may request information on the EAP SIM authentication, such as the following information:

openid.ns.ax=http://openid.net/srv/ax/1.0
openid.ax.mode=fetch_request
openid.ax.type.mno_realm=http://multi-factor.org/schema/eap-sim/realm
openid.ax.type.sim_imsi=http://multi-factor.org/schema/eap-sim/imsi
openid.ax.type.sim_triplet=http://multi-factor.org/schema/eap-sim/triplet
openid.ax.type.eap_sim_sig=http://multi-factor.org/schema/generic-
signed
openid.ax.required=realm,triplet,mauth_signed
openid.ax.if_available=imsi

The OP may respond to the request for information from the SP. An example response may include:

openid.ns.ax=http://openid.net/srv/ax/1.0
openid.ax.mode=fetch_response
openid.ax.type.mno_realm=http://multi-factor.org/schema/eap-sim/realm
openid.ax.type.sim_imsi=http://multi-factor.org/schema/eap-sim/imsi
openid.ax.type.sim_triplet=http://multi-factor.org/schema/eap-sim/triplet
openid.ax.type.eap_sim_sig=http://multi-factor.org/schema/generic-
signed
openid.ax.value.realm=mno.com
openid.ax.value.triplet=64BC736EF7684de1921F9C9C0E0679E2,
0B7e4e4b,D2119f41D8840400
openid.ax.value.eap_sim_sig=w38GIAXDIBKE0DHxgljNBAAO
9TXL0Y4OHwAAAABJRU5ErkJggg==

Referring to the above example response, the signature may be obtained using the same signing secret as for the original assertion. In this response, the OP may omit the IMSI as per operator policy, to protect user privacy for instance. Although the SIM triplet received may be useless for authentication or re-tracing authentication forensically, the operator that carried out the EAP SIM authentication can later be reached by the information on the operator realm contained in the response. For example, the operator may associate the triplet to an IMSI and validate its correctness.

In various example embodiments, other attribute exchanges are used for other authentication factors. By way of example in which a fingerprint is used for authentication, the attribute exchange may include:

openid.ns.ax=http://openid.net/srv/ax/1.0
openid.ax.mode=fetch_request
openid.ax.type.fp_authority=http://multi-factor.org/schema/generic-auth-
authority
openid.ax.type.fp_transaction_id=http://multi-factor.org/schema/generic-
auth-transaction-id
openid.ax.type.fp_request_protoocl=http://multi-factor.org/schema/
generic-auth-protocol-id
openid.ax.type.fp_sig=http://multi-factor.org/schema/generic-signed
openid.ax.required=fp_authority,fp_transaction_id,fp_sig
openid.ax.if_available=fp_request_protocol

As shown above in the fingerprint example, a third party, referred to as an ‘authority’, provides the authentication using the fingerprint. For example the third party may process a biometric input and match it against a template database to perform a biometric authentication. In such a case, the OP would not yield data about the authentication in accordance with an example embodiment. Instead, the OP may direct the RP to the authority which is able to provide the authentication data. Therefore, the types for such attribute requests may be generic and not depend on the actual kind of authentication factor, while the names of the corresponding attributes are specific to the fingerprint authentication factor, as shown above. Thus, referring to the above example, fp_authority may be a well-formed URL from which the SP can request, at any later time, detailed information about the authentication using the identifier ‘transaction_id’. Further, the SP can request a protocol such as ‘fp_request_protocol’. The response may be constructed in accordance with the example request. While the above example illustrates an example fingerprint authentication, it will be understood that other authentication factors can be implemented as desired, such as a password authentication for example. In some cases in which fingerprints or passwords are authenticated, the fingerprint template data or passwords, which may referred to as the actual credential data, is not included in the attribute exchange with the OP or the factor authentication authority. For example, including the actual credential data may lessen the security of the authentication.

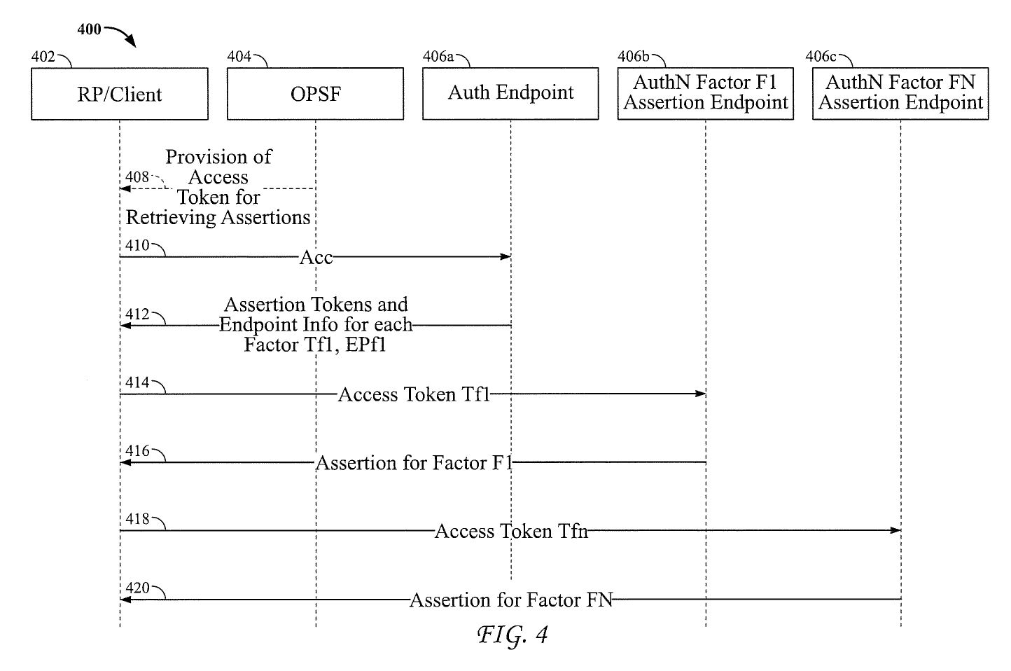

Referring now to FIG. 4, an example authentication system 400 includes one or more authentication endpoints 406, for instance a first authentication endpoint 406a, a second authentication endpoint 406b, and a third authentication endpoint 406c. The system 400 further includes an RP 402, which may also be referred to as a client 402, and an OpenID server function (OPSF) 404. The OPSF 404, the RP 402, and the authentication endpoints 406 may communicate with each other via a network.

In some cases, OpenID assertions are created after successful authentication by the OPSF 404, and are taken to appropriate relying parties through the user. The assertions may provide information on the authentication type, authentication strength, for the like, to the relying party 402. OpenID 2.0 uses a long signed assertion when many details are added. Open ID Connect simplifies this process to a great extent by way of its operation that uses tokens.

In a multifactor authentication, there may be a need to understand more information about the nature of each of the authentications involved. Open ID Connect can be used, via tokens, to fetch needed information from designated endpoints. For example, in forensics, it might be beneficial to obtain information on individual assertions for each authentication factor. Thus, each of the endpoints 406 may correspond to a respective authentication factor. Thus, each of the endpoints 406 may provide details on the assertion created for that factor in the authentication process. For example, in accordance with the illustrated embodiment, at 402, the OPSF 404 provisions one or more access tokens for retrieving authentication assertions. At 410, the RP 402 provides a first access token of the one or more tokens to the first authentication endpoint 406a. In response, at 412, the RP 402 receives an assertion and other information related to a first authentication factor. At 414, the RP 402 provides a second access token of the one or more tokens to the second authentication endpoint 406b. In response, at 416, the RP 402 receives an assertion and other information related to a second authentication factor. At 418, the RP 402 provides a third access token of the one or more tokens to the third authentication endpoint 406c. In response, at 420, the RP 402 receives an assertion and other information related to a third authentication factor.

Referring generally to FIG. 1, authentications may be performed locally on the UE 102 via the MFAP 110, which may also be referred to as a single sign-on (SSO) subsystem or a local OpenID Identity Provider (OP). In some cases in which authentication may be performed locally, authentication capabilities of the UE 102 are mapping to identifiers, and the mapping is stored locally on the UE, in a secure environment for example. Policy information that is gathered and maintained at the network during a discovery or enrollment process may be also available on the UE 102, and in particular the MFAP 110. For example, the network MFAS 106 may configure the mapping information at the MFAP 110. In order to maintain a clear separation of duties, for example, the MFAP 110 may mimic the network side MFAS 106 policy mapping functionality using the available authentication factors. The MFAP 110 may then map a specific user, such as the user 107, and an associated user identifier with the desired policy, and thus authentication factors. Thus, a user's privacy may be preserved when the device and user authentication capabilities do not need to be exposed to a third party.

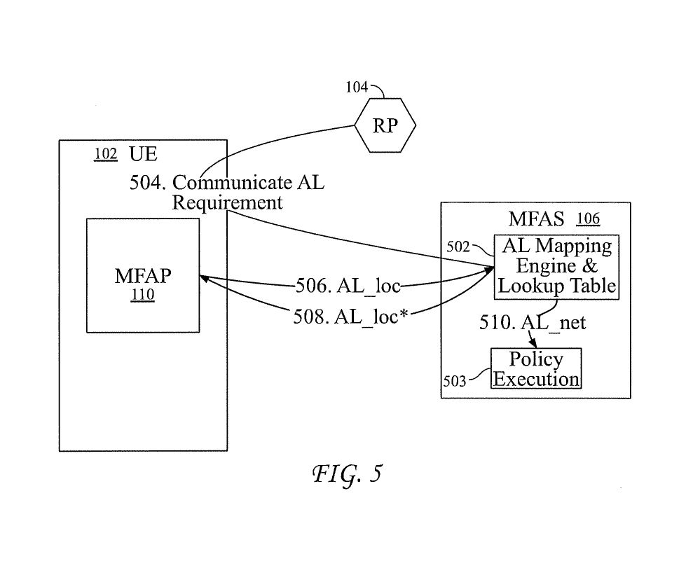

Referring also to FIG. 5, the MFAS 106 and the MFAP 110 can function in different ways according to various policies such different authentication methods on the network and the device side can be executed. At the MFAS 106, a highly feature-rich policy engine, such as a policy engine 503, may cater to different security requirements, user requirements, and service-provider requirements. For example, there may be a list of possible authentication capabilities for every user and the device(s) that the user uses, and the policy engine 503 may dynamically choose from the combination of network and local authentication factors that the user is capable of performing to satisfy the assurance level requirements from the RP 104. In a simplified example scenario, there may be a static list of network and local authentication factors that the user can perform for the different devices of the user that are enrolled at the MFAS 106, and the policy engine 503 may choose from this static list of network and local authentication factor combinations.

The duties of the MFAS 106 and the MFAP 110 vary in accordance with various embodiments. In one embodiment, a master-slave relation exists between the MFAS 106 and the 110 MFAP. For example, policies pertaining to the user 107 and the service providers are available at the MFAS 106, and the MFAS 106 initiates the execution of the relevant policies both at the network side and the device side. In accordance with the example embodiment, the MFAP 110 obeys the orders it receives from the MFAS 106 by executing local authentication factors in a given sequence. Thus, in one embodiment, there is no policy engine at the MFAP 110.

In another embodiment, once the user 107 communicates with the MFAS 106 from the RP 104, the policy engine 503 at the MFAS 106 dynamically returns a clear separation of the network side policies that will be handled by the MFAS 106 and local policies that are handled at the MFAP 110 on the device 102, which it can handle using a proxy policy engine. In this embodiment, the MFAP 110 might not be directly controlled by the MFAS 106, except for during a policy push. The policy push may occur on a per authentication basis or may occur as an initial policy push what includes subsequent pushes if there are updates to the policies.

In the example embodiments, described above, the MFAS 106 may maintain information containing the concrete local authentication capabilities of the UE 102 and the configured policy and mapping information. In addition, the policy may be based on authentication factors to be used to achieve a desired authentication assurance or assurance level mapping to authentication factors.

Referring to FIG. 5, in accordance with yet another example embodiment, the mapping of assurance level to authentication policy can be separated between the MFAS 106 and the MFAP 110. That is, the requested (by the RP 103) assurance level (AL) may be split into a local assurance level (AL_loc) and a network assurance level (AL_net) that is met by various entities according to policies, pre-defined rules, and mapping tables. For example, the MFAS 106 can execute the split and send the AL_loc to the MFAP 110 in an authentication request. In another example, the MFAP 110 may negotiate a requirement with the MFAS 106. The MFAP 110 may respond to a negotiation with a message indicating a lower AL_loc capability, upon which the MFAS may adapt AL_net accordingly (e.g., raise it) to still achieve the overall AL or adapt the MFAP policy to meet the requirement. The response of the MFAP 110 may be based on local conditions and/or the locally maintained device capability information (e.g., light conditions are currently insufficient for face recognition biometry).

Still referring to FIG. 5, in accordance with the illustrated embodiment, at 504, the overall AL is communicated to the MFAS 106. An AL mapping engine may derive tentative values of the AL_loc and AL_net, for example, using a computational engine, a database, or a lookup table, which may be referred to as AL mapping engine and lookup table 502. At 506, the AL_loc is communicated to the UE 102 and the MFAP 110. At 508, the MFAP 110 may then evaluate local conditions on the UE 102 and respond to the MFAS 106 with a AL_loc* representing its current capabilities. The local assurance level is based on current conditions of the UE 102, and thus is referenced in FIG. 5 with an asterisk to denote the same. The local authentication may already have been carried out and the AL_loc* may thus be part of a signed assertion message that states the locally achieved assurance level. In this case, the message at 506 may also contain a lower threshold value assurance level that represents the minimum required local assurance level (AL_loc_min), so as to let the MFAP 110 decide on whether to carry out the local authentications or break the operation in case that even the lower threshold is not achievable. Based upon the assurance level that is sent at 508, the MFAS 106 may start the network based authentications by submitting AL_net to the policy execution engine 503, at 510.

An example benefit derived from using the MFAP 110 is that the local MFAP provisioned policy may execute authentication even when, for example, the device 102 is not connected to the MFAS 106. For example, in some cases, it is not possible to communicate with the MFAS 106 because the device 102 is not connected to the network. In other cases, communications to the MFAS 106 are limited in order to, for example, reduce network traffic or reduce a processing burden on the MFAS 106. The locally enforced authentication policy may be synchronized with the network policy function and updated or re-synchronized over time because the capabilities may change or the assurance level to factors of authentication mapping may change, for example.

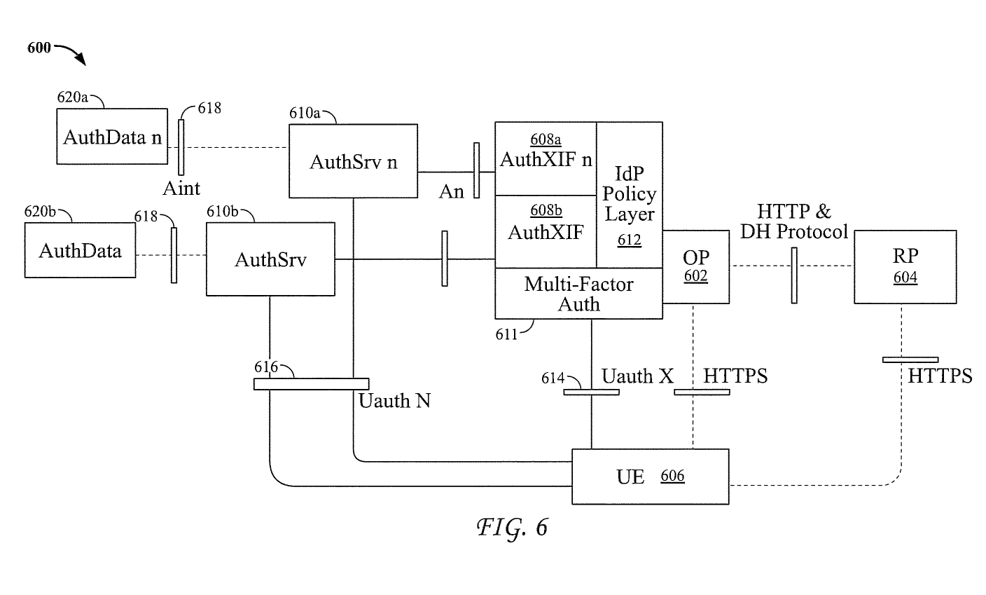

In accordance with an example embodiment, an OP server can be extended to implement the multi-factor authentication embodiments described herein. For example, referring to an example system 600 depicted in FIG. 6, an OP server 602 can be extended to include additional interfaces without conflicting with OpenID specifications. The OP server 602 may have the final decision on whether to sign an assertion or not, according to an example embodiment. For example, after the assertion is sent out to a user/UE 606, an RP 604 may accept the assertion if it is valid. The OP server 602 may implement the HTTPS based endpoints for the RP 604 and the user 606. It will be understood that biometric authentications can be via proprietary protocols as long as the user agent 606 can execute the protocols. It will further be understood that it is not required that the OP 602 performs the actual authentication. Thus, authentications may be performed by other authentication services. The other authentication services may return results of the authentication securely to the OP 602. The OP 602 and/or other authentication services may generate a random nonce to include in the authentication process, for example, to bind various authentications together. Further, the message that contains the results may include an indication of the freshness of the authentication, and a session identifier so that the OP 6-2 can map the success/fail message to an ongoing user login session.

Referring to FIG. 6, in accordance with the illustrated embodiment, the OP 602 refers to any OpenID Identity provider, such as an OpenID 2.0 entity for example. The RP 604 refers to an OpenID Relying Party, such an Open ID 2.0 RP for example. The UE 606 may represent any user agent, such as a mobile device having a user. Authentication extension interfaces (AuthXIF) 608 at the OP 602, connects the OP 602 to authentication servers 610. Each of the authentication servers 610 may run the actual user/UE authentication method. For example, the authentication servers 610 may store authentication data, which is information necessary to perform user authentication (e.g., SLF in the case of GBA). A multi-factor authentication layer 611 may be a component that is integrated into the OP 602, which enables multi-factor authentication to take place. The multi-factor authentication layer 611 may further provide an interface for the OP 602 and a policy layer 612 to trigger multiple authentication factors and collect/bind results from different authentications. The IdP Policy Layer 612 may serve as a cross layer function that determines which authentication methods to trigger based on required policies. The policy layer 612 may also evaluate the outcome of the multiple authentications, and convey the result of the combined authentication (e.g., based on matching to a required policy) back to the OP 602, which may then create the (combined) assertion.

Still referring to FIG. 6, a user authentication extension interface 614 may be required by the OP 602 to initiate an authentication process for the user/UE 606. The interface may be HTTP(S) based, but it will be understood that the interface can be alternatively based, such as based in a proprietary protocol for example. A user authentication interface 616, in accordance with the illustrated embodiment, is used by the authentication servers 610 to run the user authentication mechanism. For example, the interface 616 can be used to request GBA keys, request fingerprints, request EAP-SIM, etc. While the interface 616 is depicted as being HTTP(S) based, it will be understood that any appropriate transport protocol may be used to pass data between the UE 606 and the authentication servers 610. An interface 618 may represent an internal interface for the authentication servers 6120 to connect respective credential databases 620. The interface 618 may be invisible from the perspective of the OP 602, the RP 604, and the UE 606.

If multiple authentication factors are to be used, additional interfaces 608 may be added to the OP 602. For example, the illustrated system 600 shows a first interface 608a that couples the OP 602 to a first authentication server 610a. The system further includes a second interface 608b that couples the OP 602 to a second authentication server 610b. The authentication extension interfaces 608 may be a library/module that provided by the respective authentication server 610. For example the interfaces 608 may be a web key application code for Web key, a NAF library for GBA, or the like. The example system 600 provides a unified interface for the OP 602 to include different authentication methods. The OP 602 can trigger the different authentications to get their results, build the appropriate assertion message, and send the signed assertion that may include various information concerning the authentication methods (e.g., using PAPE) to the RP 604. The RP 640 can then check if the authentication methods are sufficient to at least meet the requested and required levels of authentication strength. It will be understood that various libraries may be integrated with the OP 602. Further, authentication factors may be triggered sequentially or in parallel with each other. The AuthXIF components may be integrated into the OP 602 via internal interfaces, for example as libraries or modules to the server implementation/code.

As described above, authentications and assertions may be carried out in a variety of ways in accordance with various embodiments. For example, authentication may be performed on a server (network) and combined with a network generated assertion. An authentication may be performed on the UE (On-Device or Local) and combined with an On-Device (Local) generated assertion. An authentication may be On-Device (Local) and combined with a network generated assertion. An authentication may be On-Device (Local) and combined with an On-Server (Network) Authentication

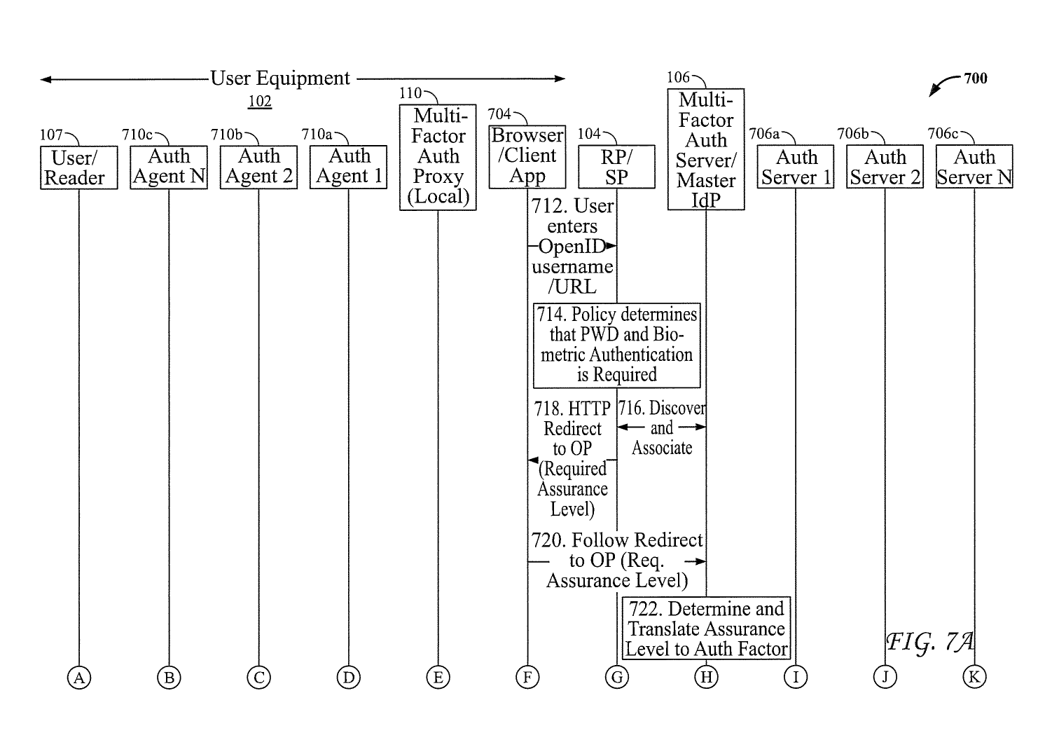

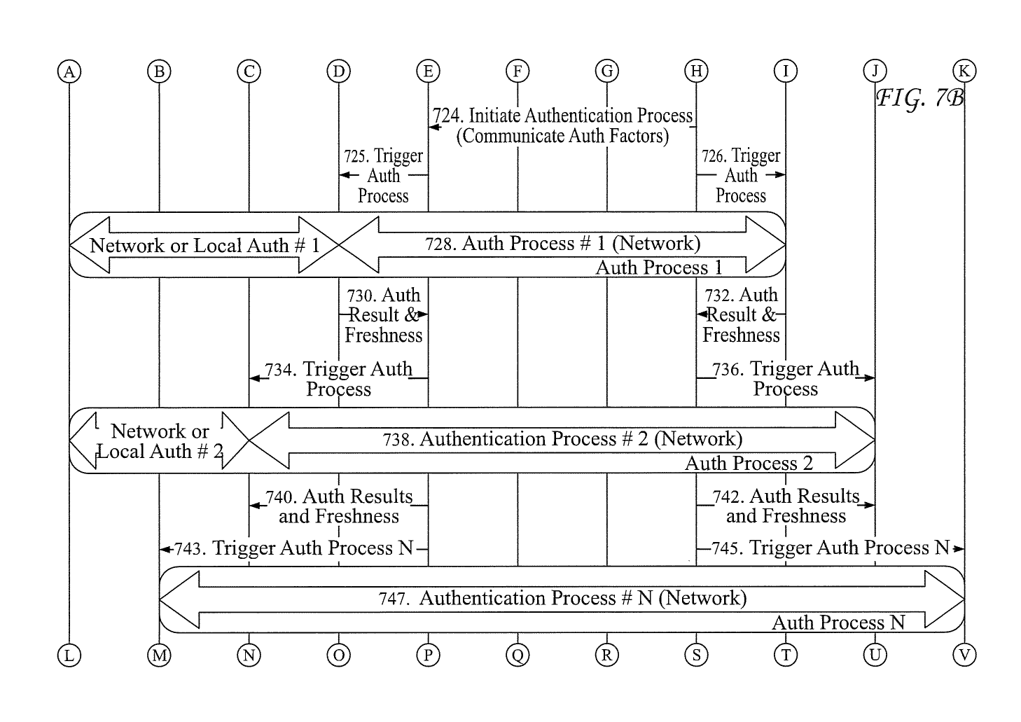

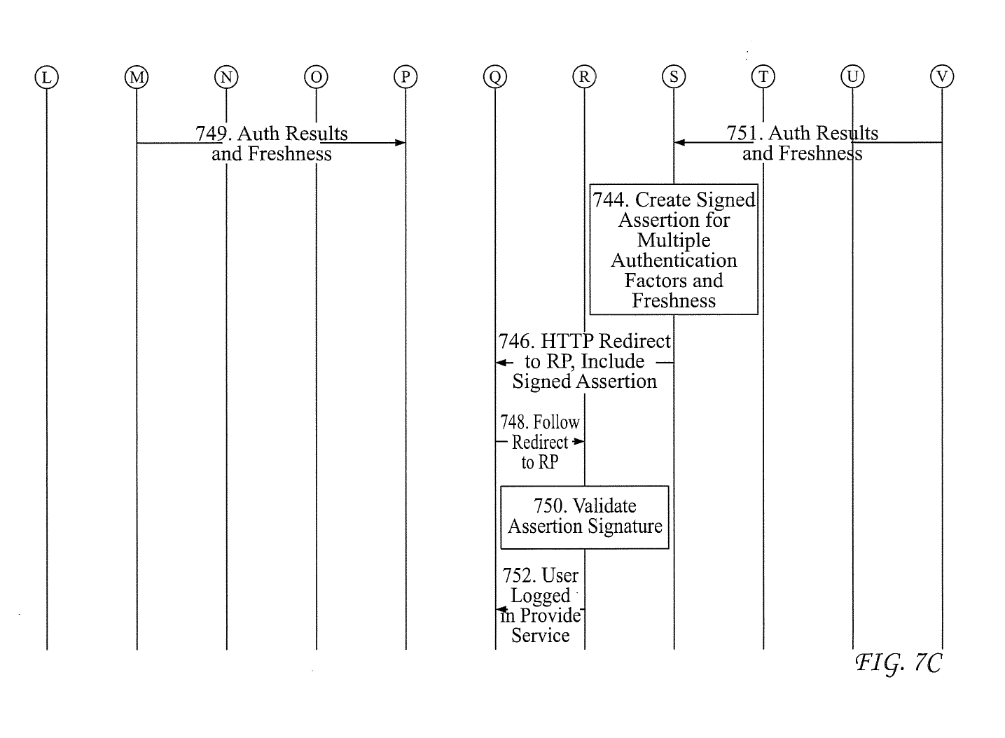

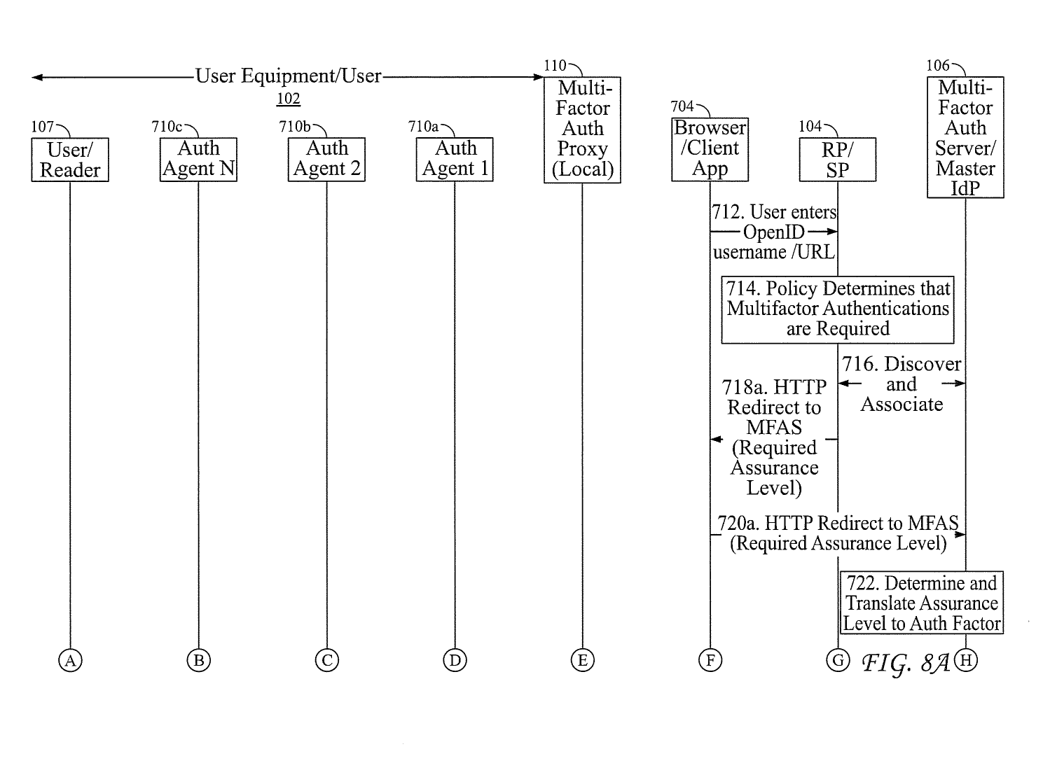

Referring now to FIGS. 7A-C, an example authentication system 700 includes one or more authentication agents (AAs) 710, for instance a first authentication agent (AA) 710a, a second AA 710b, and a third AA 710c. FIGS. 7A-C illustrate an example of a network-based multi-factor authentication. The authentication agents may be part of a UE 102, and the UE 102 may be operated by the user 107. The UE 102, and thus the system 700, includes a client application 704, which may also be referred to as a browser 704, without limitation. The client application 704 may also be, and thus may also be referred to as, a mobile application, such as an Andriod or iOS application for example. The system 700 further includes the master IdP/MFAS 106, the RP/SP 104, and one or more authentication servers 706. Reference numbers are repeated throughout the figures for convenience, and it will be understood that reference numbers that appear in more than one figure refer to the same or similar features in each figure in which they appear. While three authentication agents are illustrated in the authentication system 700, it will be understood that the number of authentication agents in the authentication system 700 may vary as desired. In accordance with the illustrated embodiment, the first authentication agent 710a is associated with a first authentication server 706a, the second authentication agent 710b is associated with a second authentication server 706b, and the third authentication agent 710c is associated with a third authentication agent 706c. Further, the authentication agents 710 and the authentication servers enable a three-factor authentication so that the browser 704 can be provided with access to services offered by the SP 104. The master IdP 106, and the authentication servers 706 may collectively be referred to as the network-side of the authentication system 700. Although an example three-factor authentication is illustrated in FIGS. 7A-C, it will be understood that the call flow shown in FIGS. 7A-C may be extended for an authentication that uses more or less than three-factors. In accordance with the illustrated embodiment, the MFAP 110 assesses the policy requirements of the SP 104 and the master IdP 106 translates the policies to determine parameters of authentication protocols that will meet the policy requirements.

Still referring to FIGS. 7A-C, in accordance with the illustrated embodiment, at 712, the user 107 requests access to a service (provided by the SP 104) via the browser 704. The browser may communicate with the SP 104, and the communication may include a user ID that is associated with the user 107. Based on the user ID, at 716, the SP 104 performs a discovery and associates with the master IdP 106 that is associated with the user ID. The master IdP 106 may perform functionality that is associated with an OpenID Identity Provider (OP) or a network access function (NAF), and thus the master IdP 106 may also be referred to as an OP 106 or a NAF 106. At 714, in accordance with the illustrated embodiment, the SP 104, for example based on a policy of the SP 104, determines that a multi-factor authentication is required in order for the user 107 to access the requested service that is provided by the SP 104. In accordance with the illustrated embodiment, the SP 104 determines that a password authentication and a biometric authentication are required to access the service. The SP 104 may also determine the level of assurance of the authentication that is required in order for the user to access the requested service that is provided by the SP 104. At 718 and 720, in accordance with the illustrated embodiment, the SP 104 communicates its assurance level requirement to the MFAS/master IdP 106 via the browser 704, using an HTTP redirect mechansim at 720.

In accordance with the illustrated embodiment, the browser 704 also transports the assurance information that is required by the SP 104. At 722, based on the level of assurance that is required to access the service, for example, the MFAS 106 determines the types and strengths of the authentication factors that can be performed to achieve the required assurance level. The MFAS 106 may further identify authentication agents that can perform the required authentications. For example, in accordance with the illustrated embodiment, the MFAS 106 determines that the first AA 710a, the second AA 710b, and the third AA 710c are associated with the determined types and strengths of authentication factors. After the first authentication agent 710a is identified, at 725, the MFAS 106 may trigger the first AA authentication agent 710 to perform the authentication of the first authentication factor. At 726, the MFAS 106 may also trigger the first authentication server 706a to perform the authentication of the first authentication factor. For example, the MFAS 106 may communicate with the first authentication server 706a that is associated with the first AA 710a to request that the first authentication server 706a create a context for the first AA-initiated authentication. At 724, the MFAS 106 may optionally initiate the first authentication factor by sending a message to the MFAP 110 that includes the first authentication factor or at least mechanism to prepare for a first authentication factor. The steps performed at 725 and 726 may be performed in parallel with each other. In an alternative embodiment, instead of performing 725 and 726 in parallel with each other, only the message at 726 is sent, and the trigger to perform the authentication at 725 is carried out at 728, described below.

With continuing reference to FIG. 7B, in accordance with the illustrated embodiment, at 728, the first AA 710a and the first authentication server 706a may carry out an authentication. The authentication may also require input from the user 107. For example, the authentication may comprise an authentication of the user of the browser 704 (e.g., a biometric of the user), of the browser 704, of the UE 102, or the like. Success or Failure of an authentication carried out at 728 may be communicated by the authentication server 706a to the AA 710a, at 728. The authentication carried out at 728 may involve a number of round-trip messaging, which may also include Challenge-Response messages, for example. An assertion, such as a first assertion for example, may be generated by the first authentication server 706a upon a successful authentication. The first assertion may be sent by the first authentication server 706a to the MFAS 106, at 732. The first assertion may represent an authentication result that includes a freshness of the authentication result. Alternatively, in accordance with the illustrated embodiment, the first assertion may be generated by the first AA 710a and sent to the MFAP 110, at 730. Regardless, at the end of the authentication, both the first AA 710a and the first authentication server 706a may have proof of the authentication, and the proof is referred to as the first assertion in accordance with FIG. 7. In addition, the MFAS 106 and the MFAP 110 may have the knowledge and proof of the first authentications that was carried out at 728.

At 730, in response to the trigger that was received at 725, the first AA 710a may send a trigger response that comprises the first assertion. The trigger response may be sent to the MFAP 110, and the trigger response may prove that a successful authentication was performed. At 732, at the network-side, the first authentication server 706a may send the first assertion and its associated freshness (e.g., date/time of when the authentication was carried out) to the MFAS 106.

At 736, in accordance with the illustrated embodiment, the MFAS 106 sends a trigger to the second authentication server 706b to create a second authentication context. The second authentication context that is triggered is associated with the second authentication, using the second authentication factor, that is performed by the second authentication server 706b and the second AA 710b. At 734, based on policies for example, the MFAS 106 may initiate the start of a second authentication using a second authentication factor by sending a trigger to the second AA 710b via the MFAP 110, or alternativey triggered by the MFAP 110. The steps at 734 and 736 may be performed in parallel with each other, or, in an alternative embodiment, only the trigger from the MFAS 106 to the second authentication server 706 is carried out at 736. At 738, in accordance with the illustrated embodiment, a second factor authentication is carried out between the second AA 710b and the second authentication server 706b. The second factor that is used to perform the second factor authentication may be a biometric of a user, another factor associated with the user 107, a factor associated with the device 102, a factor associated with a behavioral analysis of the user 107, or the like. Alternatively, for example, the second factor authentication may be carried between the second AA 710b and the user 107. Such an authentication may include, for example, a biometric authentication, an authentication of a factor associated with the user device, or a factor associated with a behavioral analysis of the user. At the end of the second factor authentication, the second authentication server 706b may generate an assertion, such as a second assertion for example. The second assertion may comprise a random nonce and/or the ticket may be cryptographically generated. The second assertion may be sent to the second AA 710b. Alternatively, in an example embodiment, the second AA 710b generates the second ticket using similar mechanisms used by the second authentication server 706b to generate the second ticket, and thus the second ticket is not sent to the second AA 710b from the second authentication server 706b. At 740, in response to the trigger that was sent at 734, the second AA 710b sends the second assertion and its associated freshness to the MFAP 110. Similarly, at 742, the second authentication server 706b may send the second assertion and the freshness of the authentication associated with the assertion to the MFAS 106. Alternatively, for example if a local authentication is carried out by the second AA 710b, the second AA 710b may generate the second assertion and forward the second assertion to the MFAP 110. It will be understood that any number of authentication factors as desired. Thus, steps 743 and 745 may be performed like steps 734 and 736, respectively, except the third AA 710c and the third authentication server 706c are used in place of the second AA 710b and the second authentication server 706b, respectively. Further, steps 747, 749, and 751 may be performed as described above with reference to steps 738, 740, and 742, respectively.

With continuing reference to FIGS. 7A-C, in accordance with the illustrated embodiment, at 744, the MFAS 106 consolidates the first, second, and third assertions to create a consolidated assertion for multiple authentication factors. In one example, an aggregate assurance level is computed by summing the assurance level associated with each authentication factor together. By way of another example, assurance levels may be weighted such that one authentication factor is weighed more heavily as compared to another authentication factor in the aggregate assurance level that corresponds to both authentication factors. Additional parameters, such as a freshness decay function, which factors in the age of each authentication factor, may be considered in computing the aggregate assurance level. In another embodiment, MFAS 106 does not send the computed aggregate assurance level. For example, MFAS 106 may send the result of each authentication. At 746, the browser 704 receives the consolidated assertion from the MFAS 106. At 748, the browser 704 re-directs and sends the assertion to the SP 104. The signed assertion, which may contain the aggregate assurance level, is communicated by the MFAS 106 to the SP 104 via the UE browser at 746, for example by using an HTTP redirect message. Alternatively, the signed assertion containing the aggregrate assurance level may be communicated directly by the MFAS 106 to the SP 104 using other channels. The signed assertion that is sent may include the freshness level for each authentication factor and the assurance level that was achieved by the multi-factor authentication that was performed. At 750, in accordance with the illustrated embodiment, the SP 104 verifies the assertion, and in particular the assertion signature, and provides the user 107 of the browser 704 with access to the requested service provided by the SP 104, at 752.

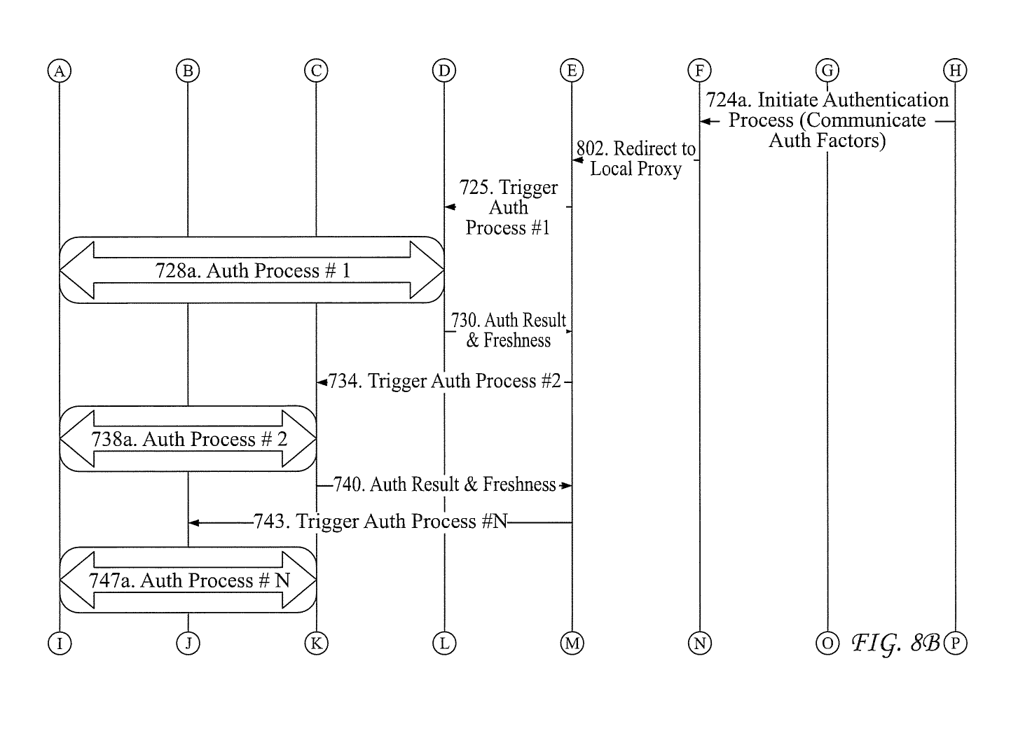

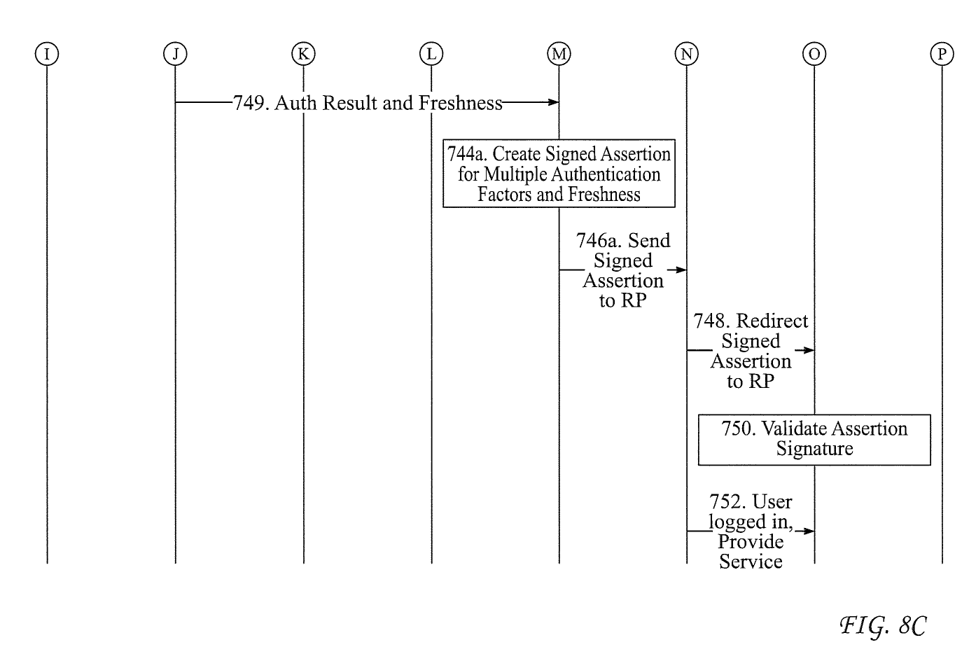

FIGS. 8A-C illustrate a variation of FIGS. 7A-C in which authentication is performed on the UE 102. Most of the steps that are illustrated in FIGS. 8A-C are described with respect to FIGS. 7A-C. Referring in particular to FIG. 8A, at 718a, in accordance with the illustrated embodiment, the SP 104 communicates its assurance level requirement to the MFAS 106 via the browser 704. Alternatively, the SP 104 may communicate its assurance level requirement through a channel that is established directly between the SP 104 and the MFAS 106. Such a channel may be established as part of the discovery and association that occurs at 716. At 720a, the browser 704 is redirected to the MFAS 106 such that the SP 104 invokes services of the MFAS 106 via the browser 704. At 722, the MFAS 106 determines the type and number of authentication factors that may have to be invoked in order to achieve the assurance level requested by the SP 104. At 724a, the MFAS 106 initiates the multi-factor authentication factor by sending a message or trigger to the MFAP 110 via the browser 704. The message or trigger may includes the authentication factors. The message or trigger may also include required assurance level that is sent instead or, or in addition to, the authentication factors. The MFAP 110 may use the assurance level to determine the authentication factors. At 802, the browser 704 is redirected to the MFAP 110 or the MFAP 110 is triggered. After the first authentication agent 710a is identified, at 725, the MFAS 106 may trigger the first AA authentication agent 710a to perform the authentication of the first authentication factor. At 728a, referring in particular to FIG. 8B, the first AA 710a and the user 107 may carry out an authentication. The user 107 may also refer to a reader, such as biometric reader for example. The authentication at 728a may require input from the user 107. In accordance with the illustrated embodiment, a first assertion may be generated by the first AA 710a and sent to the MFAP 110, at 730. Similarly, at 738a, the second AA 710b and the user 107 may carry out an authentication, in response to a trigger sent by the MFAP 110 to the second AA 710b to create the second authentication result. At 740, the second AA 710b sends the second authentication result to the MFAP 110. Further, at 747a, the third AA 710c and the user 107, and in particular the reader, may carry out an authentication to create the third authentication result based on a trigger initiated by the MFAP 110 to the third AA 710c. At 749, with continuing reference to FIGS. 7A-C, in accordance with the illustrated embodiment, the result of the third authentication is sent by the third AA 710c to the MFAP 110. At 744a, the MFAP 110 consolidates the first, second, and third authentication assertions to create a consolidated assertion for multiple authentication factors. The MFAP 110 signs the consolidated assertion. The MFAP 110 may further compute an aggregate achieved assurance level and freshness level. In one example, an aggregate assurance level is computed by summing the assurance level associated with each authentication factor together. By way of another example, assurance levels may be weighted such that one authentication factor is weighed more heavily as compared to another authentication factor in the aggregate assurance level that corresponds to both authentication factors. Additional parameters, such as a freshness decay function, which factors in the age of each authentication factor, may be considered in computing the aggregate assurance level. In another embodiment, MFAS 106 does not send the computed aggregate assurance level. At 746a, the browser 704 receives the consolidate assertion from the MFAP 110. At 748, the browser 704 sends the assertion to the SP 104. The assertion that is sent may include the assurance level and the freshness level that was achieved by the multi-factor authentication that was performed. At 750, in accordance with the illustrated embodiment, the SP 104 verifies the assertion, and in particular the assertion signature, and provides the user 107 of the browser 704 with access to the requested service provided by the SP 104, at 752.

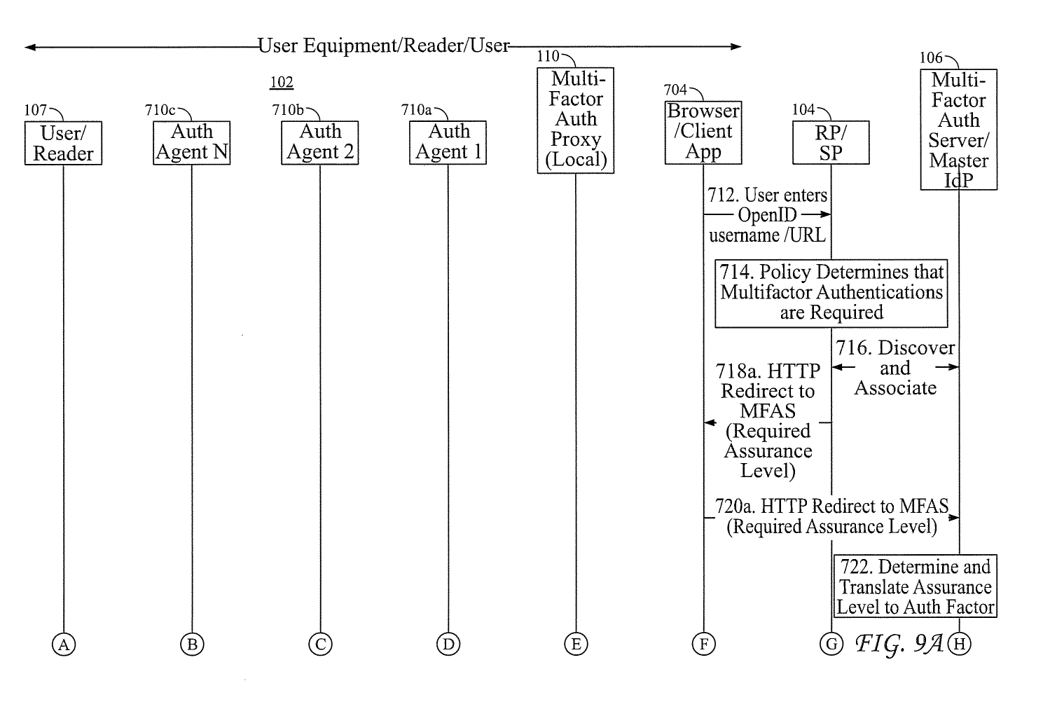

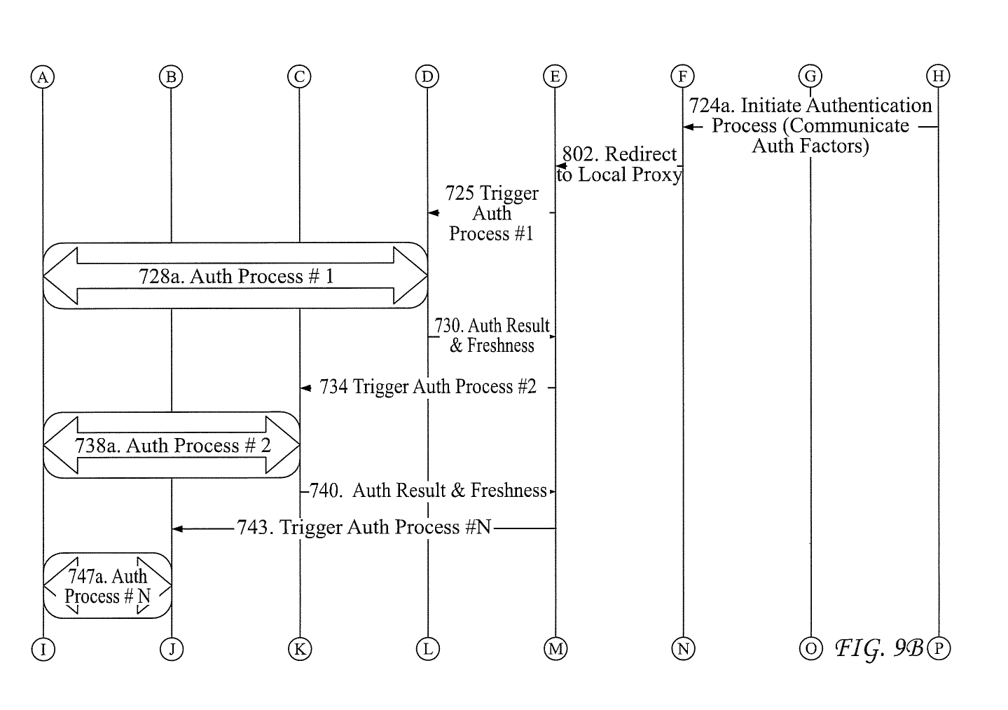

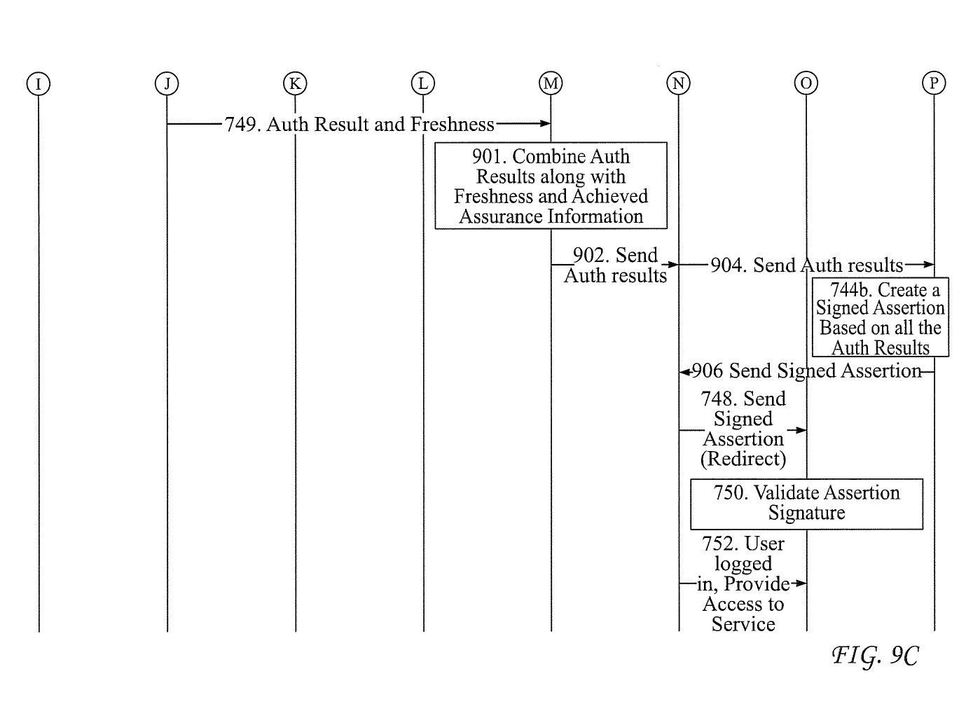

FIGS. 9A-C illustrate a variation of FIGS. 7A-C and FIGS. 8A-C in which an assertion may be carried out by the network, while the authentications may be carried out on the UE 102 by means of the MFAP 110. Most of the steps that are illustrated in FIGS. 9A-C are described with respect to FIGS. 7A-C and FIGS. 8A-C. Referring to FIGS. 9A-C, in accordance with the illustrated embodiment, at 901, the MFAP 110 combines the first, second, and third authentication results. The MFAP 110 may further compute an aggregate achieved assurance level and freshness level for the browser 704. In one example, an aggregate assurance level is computed by summing the assurance level associated with each authentication factor together. By way of another example, assurance levels may be weighted such that one authentication factor is weighed more heavily as compared to another authentication factor in the aggregate assurance level that corresponds to both authentication factors. Additional parameters, such as a freshness decay function, which factors in the age of each authentication factor, may be considered in computing the aggregate assurance factor. At 902 and 904, the MFAP 110 sends the combined result with associated information to the MFAS 106 via the browser 704. At 744b, the MFAS 106 creates a signed assertion based on the received authentication results. The MFAS 106 signs the consolidated assertion in accordance with the embodiment depicted in FIGS. 9A-C. At 906, the MFAS 106 sends the signed assertion using the browser 704. The browser 704 receives the consolidate assertion from the MFAS 106. At 748, the browser 704 re-directs the assertion to the SP 104. The assertion that is sent may include the assurance level and the freshness level that was achieved by the multi-factor authentication that was performed. At 750, in accordance with the illustrated embodiment, the SP 104 verifies the assertion, and in particular the assertion signature, and provides the user 107 of the browser 704 with access to the requested service provided by the SP 104, at 752. It will be understood that at least one of the above-described on-device authentication or the on-network authentication may be carried out according to one or more policies. Further, the signed assertion may be generated on the UE 102 by measns of the MFAP 110, of the signed assertion may be generated on the IdP/MFAS 106.

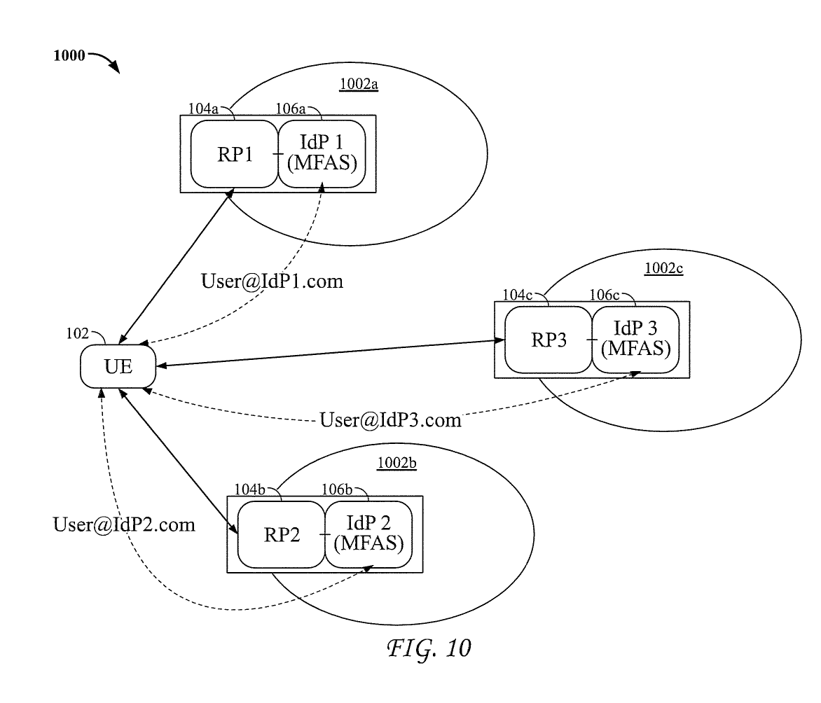

Referring now to FIG. 10, an example system 1000 includes a service provider function that includes a first RP 104a and a first IdP 106a collapsed into a first network entity 1002a. Similarly, a second network entity 1002a includes a second RP 104b and a second IdP 106b, and a third network entity 1002c includes third RP 104c and a third IdP 106c. Thus, the network entities 10002 can each host an MFAS function at their respective RP in order to provide for stronger authentication services. In accordance with the illustrated embodiment, the illustrated relying parties may also perform the role of an IdP that is able to perform multiple authentication factors. Thus, a given RP, such as a bank for example, that currently uses one factor for authentication, such as a password, may evolve toward multi-factor authentication by hosting the MFAS function which is controlled within the collapsed RP/IdP. The configuration of the network entities 1002 may also enable RPs to connect to other authentication factors that are provided by third parties, such as mobile network operators for example.

Still referring generally to FIG. 10, the illustrated RP/IdP collapsed function may preserve privacy, as described below. For example, OpenID provides a mechanism for identity privacy known as the identifier select mode of operation. A pseudo identity (PID) may be achieved in an alternative manner in accordance with an example embodiment. By way of example, if a user is authenticated by an IdP using the services of the MFAS, then a temporary identity may be created, which can be referred to as the (PID). A user who wants to obtain the services of an RP may then gain seamless access to the RP by leveraging an existing authentication with the IdP using the PID, assuming that the authentication assurance and freshness is sufficient for the specific service being accessed. In an example embodiment, the PID is presented together with the service provider issued identity as the user's identity, and pre-authentication information is recovered through discovery. For example, if the pre-authentication information suffices for the access then seamless and transparent access is provided without performing another authentication. This can be useful, for example, when a user is authenticated once and then the PID is valid for a period of time (e.g., an hour), and thus any subsequent attempts to access other RPs are provided seamlessly without user intervention until the period of time (e.g., the hour) expires such that the authentication requires refreshing.

An example of how the PID may be derived is shown as follows, which is presented by way of example and not presented by way of limitation:

SesssionString=UserID@IdP1|sessionID|Nonce|RP-ID|“String”

The sessionID may be associated with the HTTP session or a TLS-master secret. The Nonce may be generated by the MFAS for each new generation of the PID. The RP-ID may be a domain ID of the RP (e.g., the domain information within the server certificate such as www.bankofamerica.com or the like). The “String” may be something that is optional and identifies the type of operation, such as a PID generation for example. The “SessionString” is a concatenation of the various parameters shown above in accordance with the example:

PIDKey = HMAC-SHA-256 (Shared key, Nonce)
tempID = HMAC-SHA-256(PIDKey, SessionString);
PID = tempID@IdP1.com

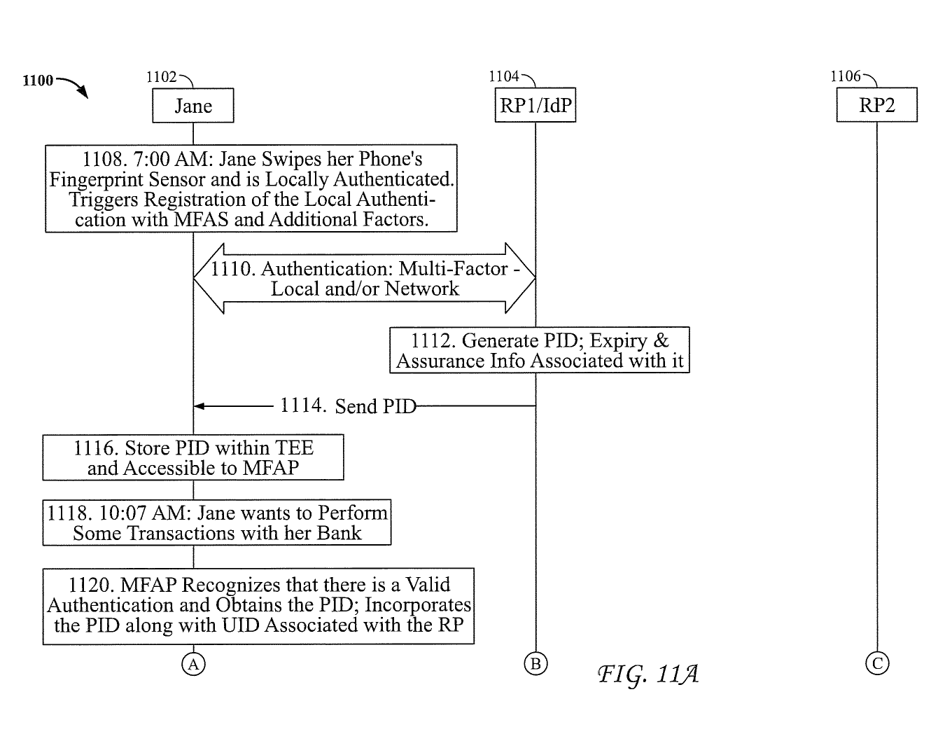

Referring to FIG. 11, an example system 1100 that includes user 1102, a network entity 1104 that includes a first RP and IdP having combined functionality, and a second RP 1106. The network entity 1104 may also include an MFAS, as described above. The user 1102 is referred to as “Jane” in FIG. 11. It will be appreciated that the example system 1100 is simplified to facilitate description of the disclosed subject matter and is not intended to limit the scope of this disclosure. Other devices, systems, and configurations may be used to implement the embodiments disclosed herein in addition to, or instead of, a system such as the system 1100, and all such embodiments are contemplated as within the scope of the present disclosure.

In accordance with the illustrated embodiment, at 1108, the user 1102 is locally authenticated at her UE. For example, the user 1102 may swipe the UE's fingerprint sensor so that a biometric authentication occurs. Once a biometric authentication is completed, it may then trigger a registration of the local authentication with the MFAS on the network entity 1104. Additional authentication factors may be performed locally, and they may be facilitated by the MFAP 110 that is located on the UE 1102, or additional authentications may be performed on the network using services of the IdP 1104. For example, a network authentication may be performed by the network entity 1104, and in particular the MFAS, at 1110. Based on the authentication at 1110, at 1112, a temporary identity, which may be a Pseudo Identity (ID) (PID), is created. The PID may have an associated lifetime and assurance level corresponding to the authentication that was previously carried out. At 1114, the PID is sent to the user 1102. At 1116, the PID is stored within a secure element, such as trusted platform module (TPM) or a trusted execution environment (TEE) for example, such that the PID is only accessible to the MFAP 110. At 1118, the user wants to access services provided by the second RP 1106, which may be the user's bank for example. At 1120, an MFAP on the user's UE recognizes that there is a valid authentication with a valid lifetime (not expired). The valid authentication represents the authentication that was previously carried out. The MFAP on the user's UE obtains the PID, and incorporates the PID with a user identity (UID) that is associated with the second RP 1106. At 1122, the UE sends the PID and the UID associated with the second RP 1106 to the second RP 1106. At 1124, the second RP 1106 may optionally verify the PID that is associated with the UID, based on domain information provided with the PID for example. At 1126, the RP 1106 performs a discovery process based on the PID, in order to discover the network entity 1104, which may also be referred to as the RP 1/IdP 1104. The RP 1106 determines an assurance level (AL) requirement that is required for the user (Jane) to access the service that the user requested. At 1128 and 1130, the user 1102 is redirected by the RP 1106 to the network entity 1104, and in particular the IdP 1104. The re-direction may include information indicative of the assurance level requirements. At 1132, the MFAS recognized that there is a valid authentication for that PID. The MFAS incorporates the PID and optionally may include parameters that are associated with the user's profile information. The MFAS creates a signed assertion that is sent by the IdP 1104 to the second RP 1106. At 1134, the network entity, and in particular the MFAS, sends a signed assertion to second RP 1106 via the user 1102 (e.g., via Jane's web browser). The user 1102, via the UE, forwards the signed assertion to the RP 1106. At 1138, the second RP 1106 verifies the signed assertion that it receives from the UE. If the signed assertion is valid, the RP 1106 sends a success message to the user 1102, and the user/UE can receive access to the service that is provided by the RP 1106, at 1142. Thus, the user 1102 is seamlessly authenticated by the RP 1106 by leveraging an existing authentication with the RP that is part of the network entity 1102.

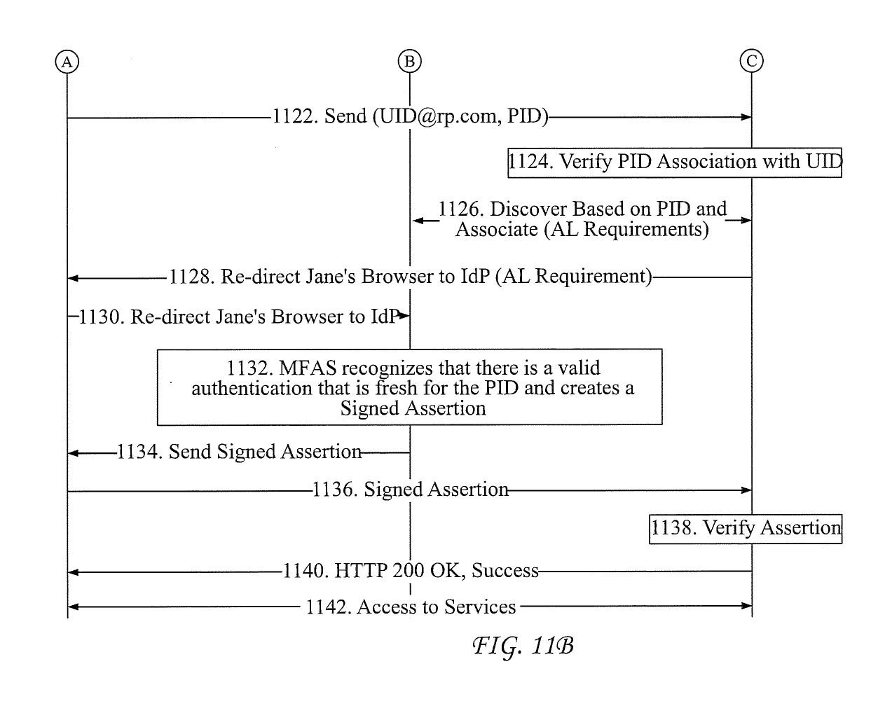

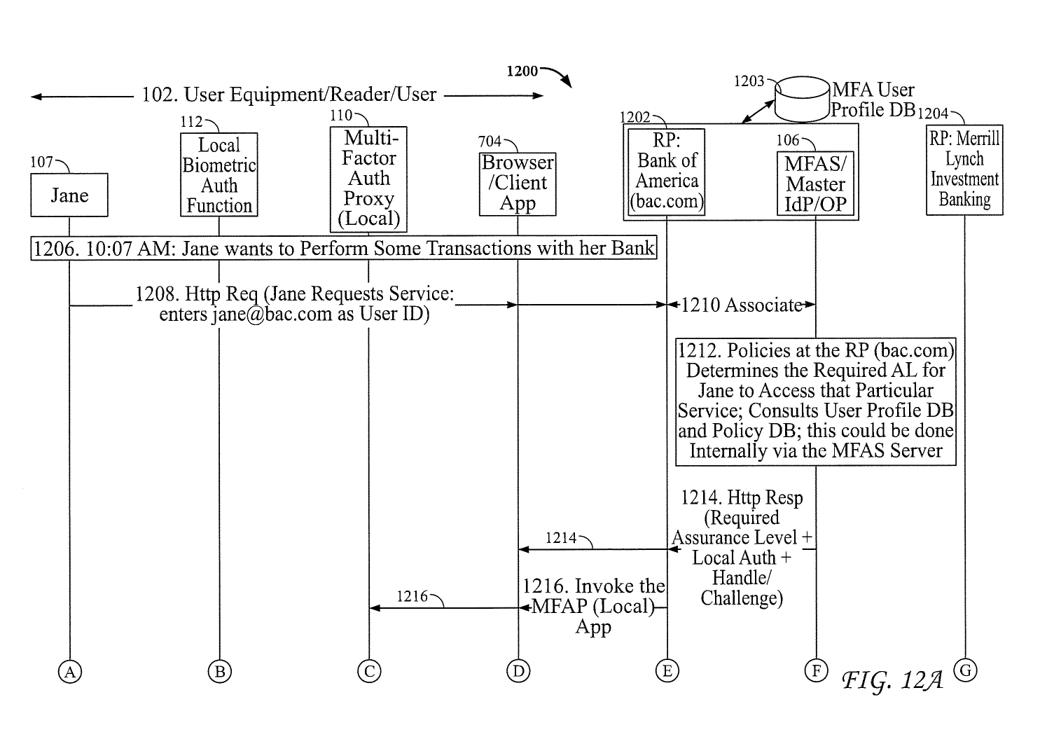

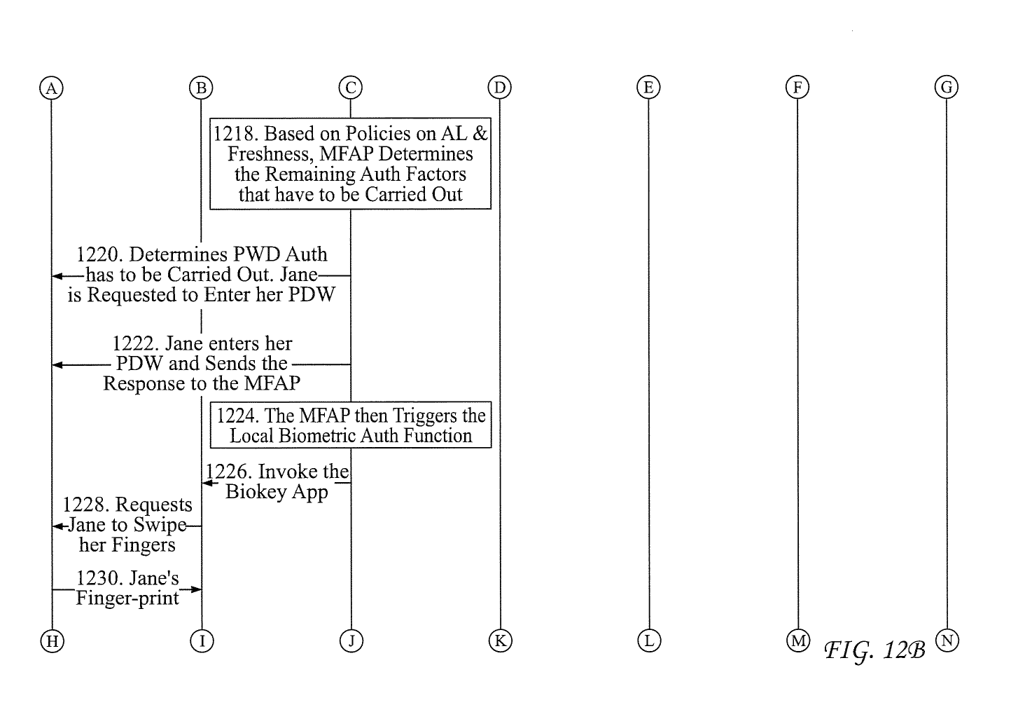

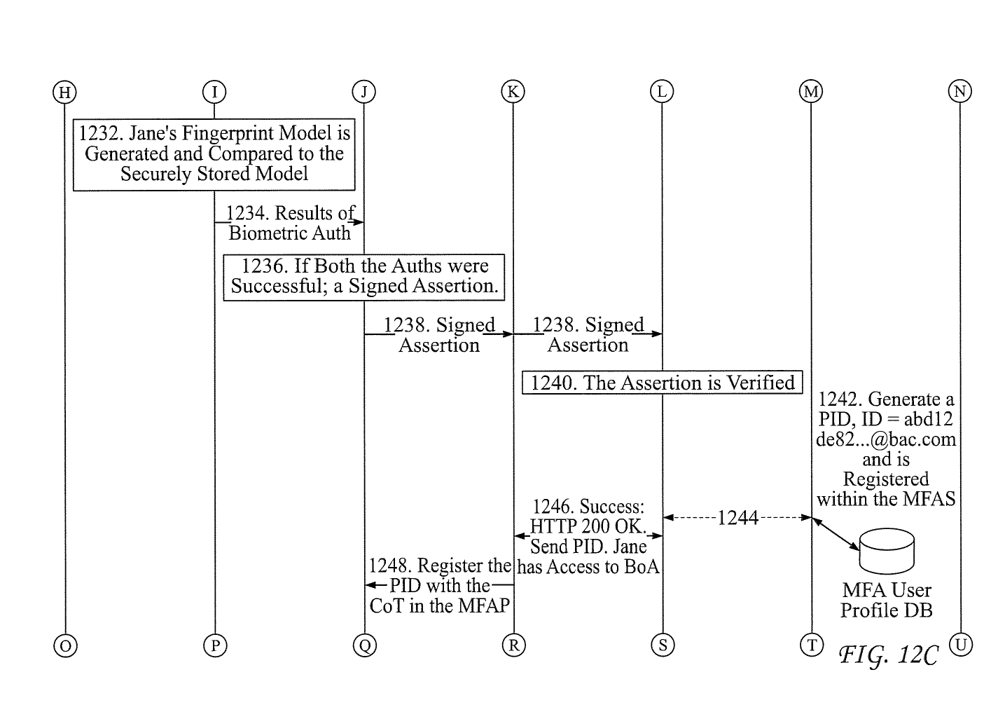

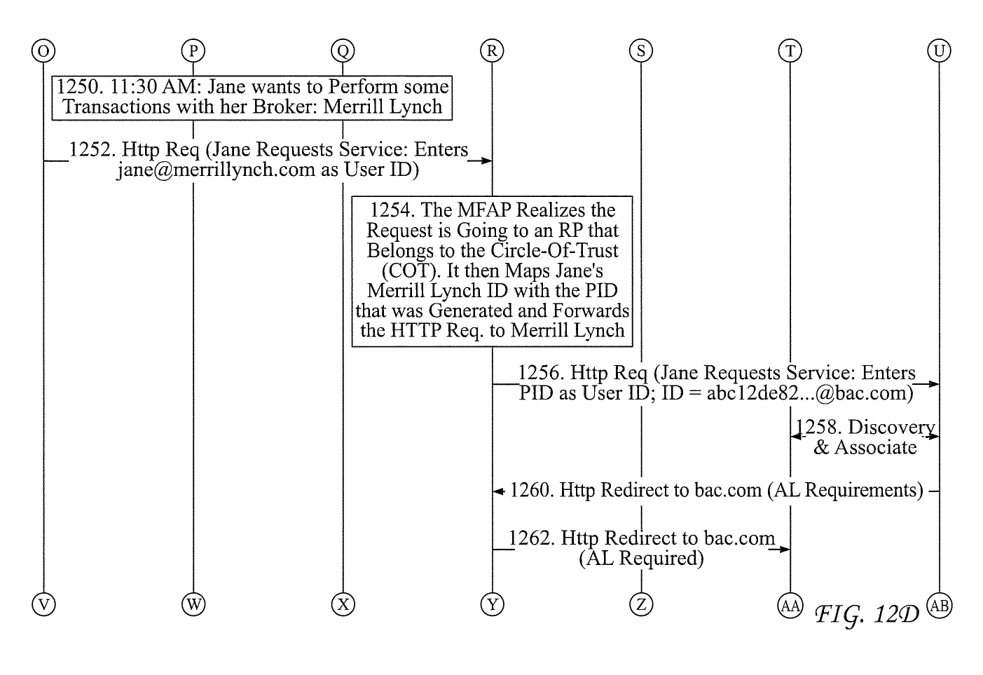

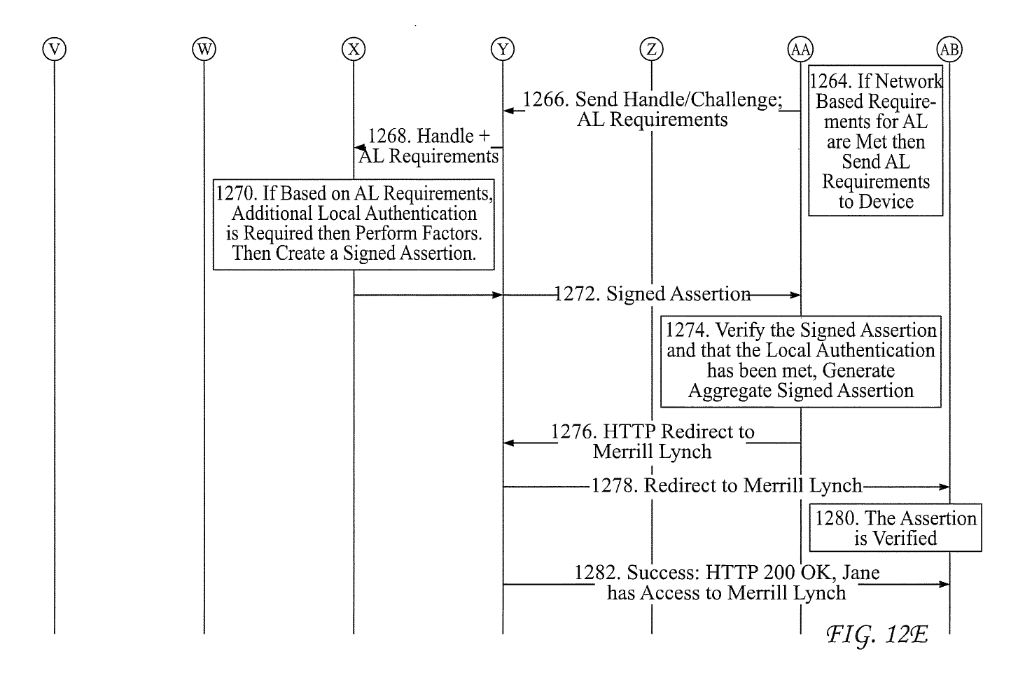

Referring now to FIGS. 12A-E, and also generally to FIG. 1, an example system 1200 includes the UE 102 having the user 107, who is referred to as “Jane” in FIGS. 12A-E. The UE 102 includes the biometric client 112, which can also be referred to as local biometric authentication function 112. The UE 102 further includes the MFAP 110 and the browser 704. The system 1200 further includes a first RP 1202, a second RP 1204, and the MFAS 106, which may also be referred to as the master IdP 106.

Referring in particular to FIG. 12A, in accordance with the illustrated embodiment, at 1206, at a first time, the user 107 wants to perform at least one transaction with her bank (www.bac.com). which is the first RP 1202. At 1208, the user 107 enters her user identity (e.g., jane@bac.com) within a “user id” field of a portal provided by the first RP 1202. The browser 704 or a browser plugin may determine whether there is a PID that may be used. At 1210, the first RP 1202 associates with the MFAS based on the user identity for example. At 1212, in accordance with the illustrated embodiment, policies at the RP 1202 (www.bac.com) determine a required assurance level for the user 107 to access the service that is being requested. The required assurance level may be determined based on user profile information related to the user 107. For example, the MFAS may 106 may retrieve user profile information from a user profile database (DB) 1203. The required assurance level (AL) may also be determined based on policies stored within a policy DB. The policy engine and the DBs may be located at the Master IdP/MFAS/OP 106. At 1214, the RP 1202 responds with the required assurance level, which may be referred to generally as the authentication requirement, and a Session Handle or Challenge via the Browser 704. At 16, an intent calls the MFAP 110.

Referring in particular to FIG. 12, in accordance with the illustrated embodiment, at 1218, based on policies and the AL required by the RP 1202 and the fresh authentications that have been carried out, the MFAP 110 determines the remaining authentication factors that will have to be carried out. At 1220, the MFAP 110 may determine that as password (PWD) authentication has to be carried out and therefore requests the user 107 to enter her PWD. At 1222, the user 107 enters her PWD and the PWD is received at the MFAP 110. At 1224, the MFAP 110 checks the password and based on the policies, it determines that a Local Biometric authentication should occur. At 1226, the MFAP 110 invokes the local biometric authentication function 112, which may also be referred to as a biometric application 112. At 1228, the Biometric application 112 may request the user 107 to swipe her fingers over a fingerprint reader. At 1230, the user 107 runs her finger over a sensor coupled to the fingerprint reader and fingerprint(s) is sent to the biometric application 112.

Referring in particular to FIG. 12C, in accordance with the illustrated embodiment, at 1232, the biometric application 112 generates a fingerprint model out of the received fingerprints and compares the model to the locally stored and secured fingerprint model that was created during a fingerprint enrollment process. At 1234, the results of the biometric authentication are sent by the biometric application 112 to the MFAP 110. At 1236, if both of the above described authentication factors are successfully carried out, then a signed assertion is created using a Handle/Challenge provided by the RP 1202. The Signing Key may be a shared secret between the MasterIdP/MFAS 106, the RP 1202, and the MFAP 110. Alternatively, a private key of the MFAP 110 may be used for Signing the Assertion and the corresponding public key of the MFAP 110 may have been registered with the MFAS 106 during a registration process. The signed assertion may be sent to the RP 1202 via the browser 704. In addition a PID is generated in accordance with the example embodiment, at 1242. For example, the PID may be equal to a functions such as HMAC-SHA-256(PIDKey, SessionString)@bac.com for example. At 1238, the MFAP 110 sends the Signed Assertion along with the PID to the MFAS/Master IdP 106. At 1240, the MFAS 106 verifies the Signed Assertion and the Assurance Level that was obtained. Further, the MFAS 106 may register the PID within the User Profile DB 1203 at 1244. At 1246, in accordance with the illustrated embodiment, the MFAS 106 confirms the registration of the PID and sends a HTTP 200 OK message to the MFAP 110. At 1248, the browser 704 updates a User DB on the UE 102 with the PID information for that particular circle of trust (CoT), which is described further below. Thus, the PID is registered within the MFAP 110 and the user 108 has access to services provided by the first RP 1204 (e.g., www.bac.com)

Referring in particular to FIG. 12D, at a second time that is later than the first time, the user wants to perform some transactions with the second RP 1204, which may be a broker (e.g., Merrill Lynch) for example. It will be understood that the first and second RPs may be any service providers as desired. At 1242, the user 107 attempts to send her service request to the second RP 1204 using her id (jane@merrillynch.com) that is associated with the second RP 1204. At 1254, the Browser plugin 704 determines that the request is made to the RP 1204 that belongs within the same CoT as the first RP 1202. Further, the browser 704 determines that the PID already exists for that user 107. Thus, the user identity is replaced with the PID. At 1256, the PID (e.g., abc12de82 . . . bac.com) is sent as the “user id” to the RP 1204 (www.merrillynch.com). At 1258, based on the domain name associated with the PID (e.g., bac.com), discovery and association using OpenID is carried out between the MFAS 106 and the second RP 1204. At 1260 and 1262, the HTTP messages are re-directed to the master IdP 106 (www.bac.com), which may also be the RP 1204 in this example scenario. At 1264, in accordance with the illustrated example, the IdP 106 checks the AL requirements and determines that the network based authentication is acceptable and a fresh local authentication is required.

Referring in particular to FIG. 12E, in accordance with the illustrated embodiment, the MFAS 106 sends a Handle/Challenge and the AL requirements to the MFAP 110 via the browser 704. At 1268, the Handle/Challenge and the AL requirements are sent to the MFAP 110. At 1270, the MFAP 110 determines whether any local authentications/factors have to be carried out based on the policies and freshness of the authentications that have been requested. In accordance with the illustrated example, the MFAP 110 creates a signed assertion at 1270. At 1272, the Signed Assertion is forwarded to the MFAS 106 via the browser 704. At 1274, the MFAS 106 verifies the signed assertion and verifies if the required AL has been achieved. At 1276, following the OID protocol, for example, a redirect message containing the Signed Assertion is sent to second RP 1204 (www.merrillynch.com). At 1280, the Assertion is verified by the RP 1204. At 1282, the RP sends a HTTP 200 Ok message to the user, and the user 107 can access the requested service provided by the second RP 1204. Thus, the PID that is generated during a first authentication can later be used to gain seamless and automated access to services provided by other service providers without user intervention.

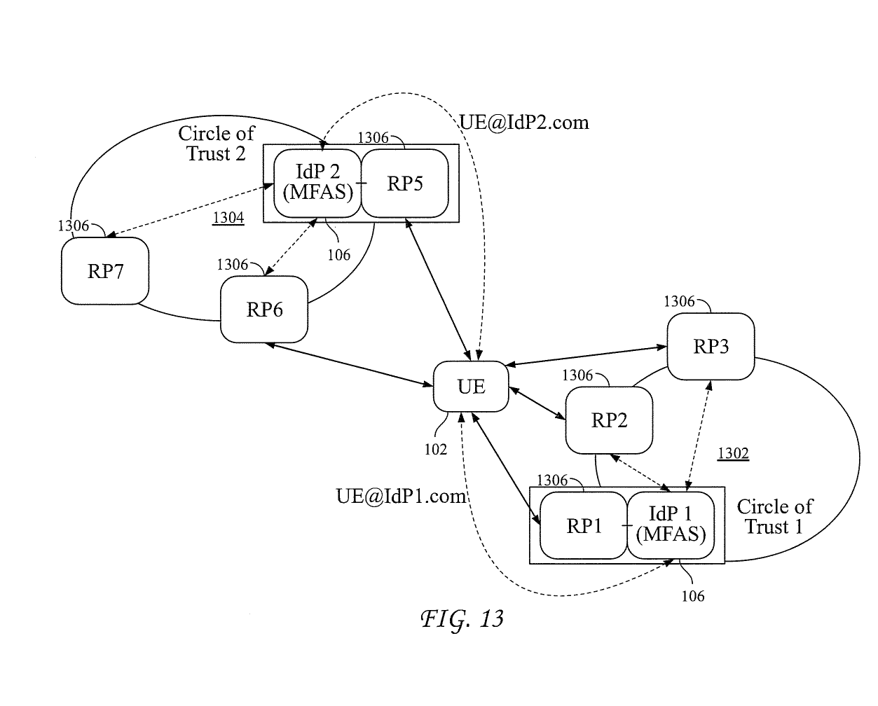

Referring to FIGS. 13 and 14, a first circle-of-trust (CoT) 1302 and a second CoT 1304 may be associated with the UE 102. Each CoT may include one more relying parties 1306. In an example embodiment, RPs may provide a variety of services through partners that are in the same CoT. For example an RP may provide IdP services to other RPs (partners) within a CoT. In some cases, the first RP with which a user interacts can act as the IdP to members within a CoT. It is possible that there is only a single or a small number of RPs that may work as an IdP for users within a CoT. While the UE 102 is shown is connected to two CoTs, in particular the first and the second CoT 1302 and 1304, it will appreciated that the UE 102 may be connected with any number of CoTs as desired. In some cases, an RP may belong to multiple CoTs that the UE/User 102 is associated with. The UE 102 may have an identity that is associated with each CoT, and each identity may be unique with respect to each other. When a user or UE wants to obtain the services of an RP within a CoT, then the associated identity associated with that CoT may be used. The relationship between an idenity and a CoT may be pre-configured within the device. Referring to FIG. 14, if an authentication, which may be a multi-factor authentication, has been carried out between the UE/User 102 (using the UE@IdP1 identity) and the combined entity of RP 1304 and IdP1/MFAS 106, then a PID that is generated as part of that authentication process is used for future authentications by the UE/User 102 with other RPs 1306 within the CoT 1302. For example, if the validity or timestamp associated with a PID has expired, then a re-authentication with the IdP1/MFAS 106 may be carried out. By way of another example, re-authenticaiton may be carried out on a continuous basis in order to ensure that valid authentications are available all the time.

In an example embodiment, the privacy of the PID ensures that RPs within the same CoT are not privy to the permanent identities of the user associated with each of the other RPs within the CoT. In some cases, only the PIDs are used to identify the authentication carried out with the IdP (MFAS 106). A browser plugin or application that securely stores the PID and the associated CoT and RP information may be presented as follows, presented by way of example and not presented by way of limitation:

TABLE 1

| CoT | PID |
|---|---|
| BAC | 73a32de822f118392ad8b. . .@bankofamerica.com |
| TD | 27951e37acc34279d234d232Bb. . .@tdcanadatrust.com |

In some cases, a particular user has a user profile with corresponding Authentication Credentials (e.g., UID/PWD, Tokens, Public/Private Keys etc.) associated with each of the RP/IdPs. Thus, the authentication credentials may vary between members within the CoT. Thus, the AL of an authentication carried-out with a first RP/IdP may be different from than an AL of an authentication carried out with a second RP/IdP, even though each RP/IdP may be in the same CoT. Further, messages and Challenges/Handles may be signed with unique signing keys (RP<-> User), while at the same time having Assertions signed by (User <-> IdP/RP) keys. This may provide an additional level of Security. Example keys are presented in Table 2.

TABLE 2

| | | | Private Key or Shared Secret |
|---|---|---|---|
| | | | (Stored within for example |
| COT | RPs | Public Key | a TEE/Secure Element) |
| BAC | www.bankofamerica.com | 23473574224bb312b. . . | 2abab23438238ef32b231. . . |
| | www.merrillynch.com | 90412db4a83412ada. . . | dbab2343248ef32234ffea. . . |
| | http://www.balboainsurance.com | 3742342342d23412aa. . . | 23487923794723e92374. . . |
| | www.tdcanadatrust.com | 23781df92131209. . . | 9529bbee234237497d23. . . |
| TD | www.ameritrade.com | 21fdeab32718. . . | 7363b66341aee32323d23. . . |
| | www.tdbankusa.com | 374387ccfe2c4ab3. . . | Afa23423b22cdc3123f3f. . . |

The pseudo IDs constructed and used as describe above may enable pseudonymous access to services. In one embodiment, the PIDs are one-time identifiers, and thus they prevent the user to obtain personalized services from the RPs that receive the PIDs. For example, PIDs may be like ‘membership cards’ that state that a user is a ‘member’ of the CoT of a particular IdP, for example, without having a name or other personally identifiable information being part of the PID.

In accordance with an example embodiment, a user may receive consistent service because PIDs can be linkable with each other. For example, PIDs used in a particular sequence can be linkable. By way of example, the MFAP 110 may store a last used PID for each RP accessed and send it together with the current PID to a particular RP. For confirmation and prevention of replay attacks, the new PID may then be constructed as follows, for example:

PID_new=HMAC-SHA-256(PIDKey, SessionString).

The linkability can be broken at any time in accordance with an example embodiment. For example, the linkability may be broken by request of the user or by, for instance, creating a fresh PID that is not linked to a previously used PID.

As used below, the term “federation target” may refer to network authentication provider functions (e.g., OP/NAFs, BSFs, etc.), IdP technologies (OpenID, Liberty, RADIUS, LDAP, etc.), network authentication security anchors (UICC, smart card, NFC secure element, token, etc.), user authentication methods (PIN, Biometry, OTP, token, multi-factor, etc.), on-device applications (browser, app), or the like. In various example embodiments, a user's client device has a finer granular structure than what is typical, and thus the device may include separate entities, such as secure elements and applications for example, which themselves are federation targets.

For convenience, an example list of federation targets is presented in Table 3 by way of example, and without limitation.

TABLE 3
Federation Targets

| Device World | | Network World | |
|---|---|---|---|
| Examples | Entity Class | Entity Class | Examples |
| BYOD user, | Users | Identity | OpenID Provider, |
| (Web) shop | (Identitites) | Providers | Liberty (SAML) |
| client, clerk | | | Provider, RADIUS |
| | | | server, LDAP |
| | | | server, HLR/HSS |
| Tablet, | Devices | [Device | Dev. Mfg., OMA-DM |
| Laptop, | (identifiers) | Manager] | service, remediation |
| Smartphone; | | | server, firmware |
| | | | update server |
| Browser, | Applications | Services | Shop, WiFi |
| business/ | | | AP network, |
| banking/ | | | cloud service, |
| other app, | | | corporate VPN |
| VPN client, | | | |
| WiFi CM | | | |
| PIN, | Local | Authentication | GIT Kit, |
| password, | User | Frontends | OpenID |
| biometry, | Authentication | | plugins for |
| OTP, token, | Methods | | Web-Shops |
| e-ID card, | | | (Magento) |
| multi-factor | | | |
| UICC, | Network | Network | NAF, BSF, |
| MSC, other | Authentication | Authentication | running EAP- |
| smart card, | | | SIM/AKA/ |
| other | | | AKA’, GBA |
| Secure Element, | (Security | Trust | |
| mTPM in | Anchors) | Endpoint | |
| a TEE, vSIM | Delegate | | |

Referring to Table 3, the device world and network world may exhibit a partial “mirror image” symmetry. In some cases, this symmetry may indicate a trust relationship, such as between a user and the identity provider with which the user is registered for example, or between the physical security anchors associated with network authentication. In other cases, the connection between the device and network world may be a functional one, such as a generic WiFi client application facilitating access to a multitude of WiFi networks for example, in which case this application itself may become part of the means to federate across a type of services.

The federation targets, as entity classes or as concrete instantiations thereof, appear in the example SSO architectures described below. Apart from them, there also may be functional building blocks that may be instrumental in achieving federation for one or more target entity classes. For instance, the term “SSO Framework” refers to a functional nexus on the device, which may play a central role in federating user authentication methods, applications, and security anchors.

The below abbreviations may be used for the entity classes introduced above. The following table lists some acronyms. Other acronyms used herein may be well-known. Referring to Table 4, U and UID may represent a distinction between users and their identities, which are embodied as identifiers. For example, one user may have more than one identity.

TABLE 4
Federation Targets

| Device World | | Network World | |
|---|---|---|---|
| Abbreviation | Entity Class | Entity Class | Abbreviation |
| U (UID) | Users | Identity | IDP |
| | (Identitites) | Providers | |
| DEV (DID) | Devices | | |
| | (Identifiers) | | |
| APP | Applications | Services | SRV |
| LAUTH | Local User | Authentication | AFRO |
| | Authentication | Frontends | |
| | Methods | | |
| NAD | Network | Network | NAE |
| | Authentication | Authentication | |
| | (Security | Trust | |
| | Anchors) | Endpoint | |
| | Delegate | | |

As used herein the term relying party (RP) may refer to an entity that accepts and/or evaluates identity assertions for users. A service (SRV) can refer to a service provider, without limitation. Further, a service can be, but need not be, an RP.

By way of background, via federated identity management systems, service providers have a means of accessing a third party for authentication assertions. This makes authentication more user-friendly for users by limiting the number of credentials they need to remember to access multiple service providers (SRV). However, as users access variable grade services from low value services to high value services, the strength of an authentication may also vary in a granular fashion. Rather than encumber users with the highest grade of authentication, it is recognized herein that it may be beneficial to only burden users when necessary. Thus, providing variable grade authentication to federated systems may simplify the authentication experience for users, while still providing a high strength authentication when required.

By way of further background, IdPs often generically provide user identities (e.g., named IDs, such as email addresses) and user specific data (such as billing and shipping information or consumer preferences). But IdPs themselves normally do not provide user authentication methods stronger than a user name/password. Various attempts by IdPs to employ stronger authentication methods remain hitherto scattered, proprietary, and fragmented (such as employing SMS OTPs as factors using a secondary channel, or special cryptographic tokens), or costly to implement in scale (such as key fobs). Therefore, current technology is inflexible to service providers, which are not enabled to choose authentication methods for users. Also, the fragmentation of the authentication method technologies negatively impacts scalability and deployment cost.

Current technologies do not enable service providers to describe and enforce policies to flexibly govern multi-factor authentication of users in different circumstances, e.g., first log-on to a Web shop as opposed to checkout and payment. Also, service providers cannot easily connect to network-based authentication methods such as, e.g., 3GPP network authentication using GBA, to access multiple additional authentication factors.

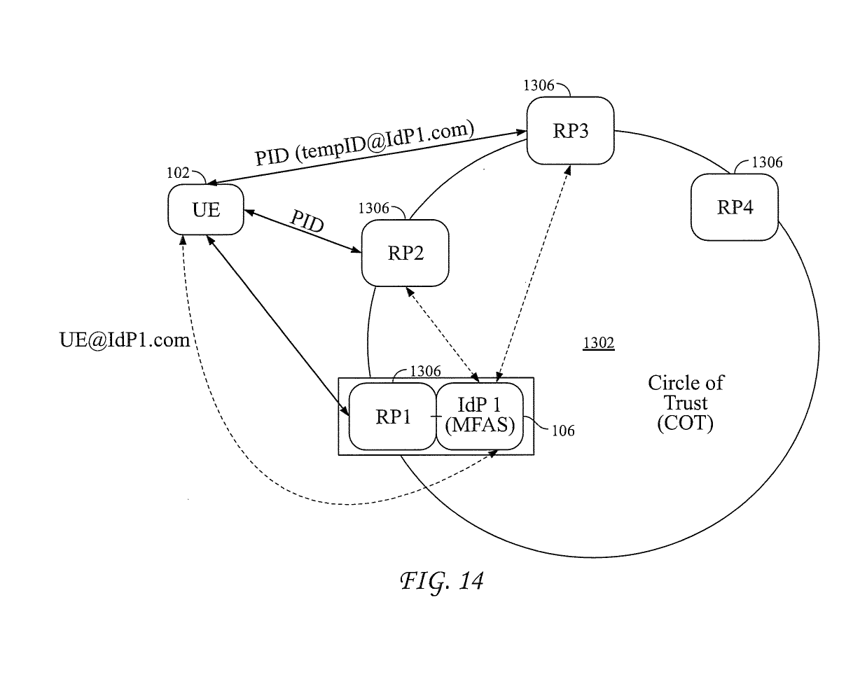

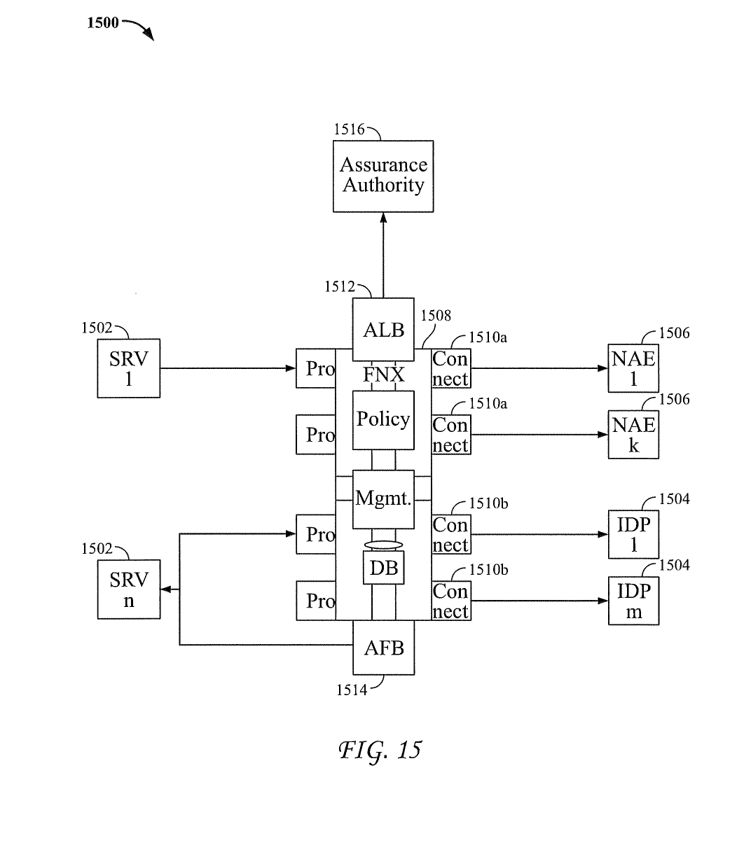

Referring to FIG. 15, in accordance with the illustrated embodiment, an example architecture 1500 provides an intermediate layer between services 1502 and IdPs (IDP) 1504, and between services 1502 and network authentication entities (NAE) 1506. The intermediary may be referred to as a Federation Nexus (FNX) 1508. The FNX 1508 may perform a generic master IdP role that, in addition to performing a classic identity provider role, controls connectors 1510 and brokers, which may be considered classes of subfunctions. The FNX 1508 may be a logical entity that resides on the MFAP 110 or the MFAS 106 (see FIG. 1).

Still referring to FIG. 15, in accordance with the illustrated embodiment, the connectors 1510 may be NAE connectors 1510a that provide interfaces to various standardized or proprietary network based authentication methods. The connectors 1510 may be IDP connectors 1510b that provide interfaces to IDPs 1506 which in turn may release user identifiers and user information. The connectors 1510 may be service connectors 1510c that provide interfaces to various services for user authentication and management, such as AAA for example.

Still referring to FIG. 15, in accordance with an example embodiment, an Assurance Level Broker (ALB) 1512 is a database and logic function that may allow for an essential function of the FNX 1508. The ALB 1512 may map assurance levels as described above. Assurance levels may refer to enumerations of levels of assurance of user authenticity defined by some authority, for example as assurance authority 1516. Thus, the ALB 1512 may map assurance levels to authentication methods and supplementary conditions, such as freshness of authentication for example. In accordance with an example embodiment, an Authentication Front End (AFE) broker (AFB) 1514 may be a broker that provides tailored front-ends (e.g., Web pages or active Web elements such as javascripts or ActiveX elements) to support user authentication. The AFE 1514 may provide tailored front-ends that represent combined authentications (e.g., reflecting to and requesting acceptance from, a user that a NAE authentication such as EAP-SIM, is used to authenticate to an IDP identity such as an email address).

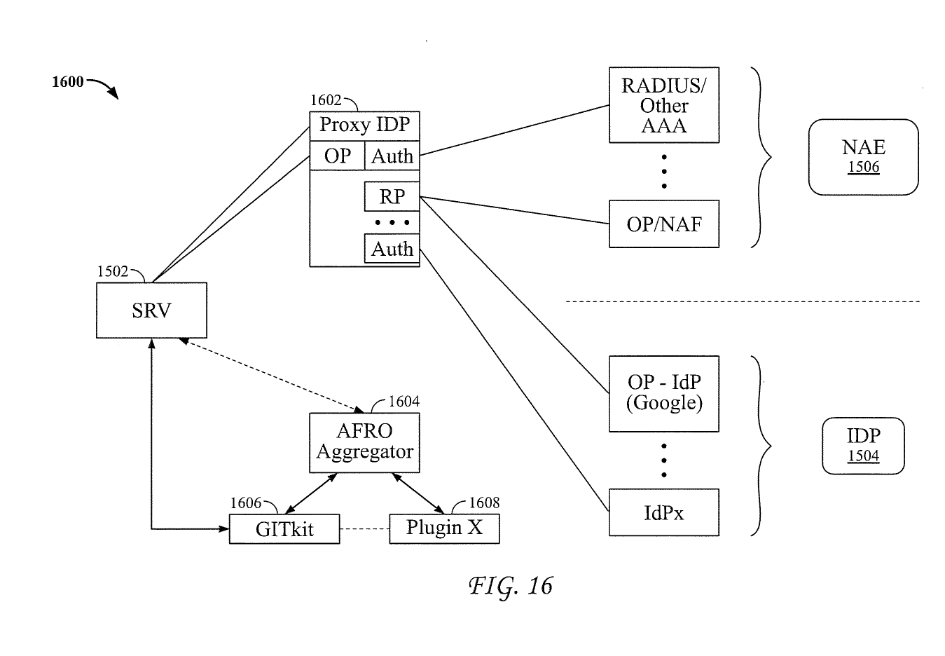

Referring now to FIG. 16, an example architecture 1600 includes a Proxy IdP 1602 that mediates and interfaces between services 1502 and ‘backend’ IdPs 1504. In accordance with the illustrated embodiment, the Proxy IDP 1602 may establish an intermediate aggregation layer between services 1502 and backend authentication and identity services, which can be referred to generally as the IDP 1504 and NAE 1506 entities. The proxy IDP 1602 may include connections to other IdPs. The Proxy IdP 1506 may also have custom connections to IdPs/NAEs.

The example architecture 1600 further includes an authentication front end (AFRO) Aggregator 1604 that connects SRV 1502 to authentication front ends, such as a google toolkit 1606 or a plugin 1608 for example. The AFRO aggregator 1604 may provide information exchange from an AFRO to the Proxy IDP 1602. Thus, different AFROs can be used to trigger various IDP and NAE methods. Also, the AFRO Aggregator 1604 may facilitate use cases involving multiple SRV 1502, by for example by providing inter-communication via triggers.

The Proxy IDP 1602 may provide a connection to multiple different NAE protocols such as EAP-SIM, GBA, AKA, AKA′, or the like, for example. The proxy IDP 1602 may provide a connection to IDPs via different interfaces such as, for example, OpenID Connect providers, SAML Authorities, X.509 CAs, RADIUS and LDAP servers, or the like. The proxy IdP 1602 may trigger NAE authentications. The proxy IdP can map a UID between different identity domains, either by using its own mapping database or by triggering a mapping by another entity that may reside on a UE. The proxy IDP 1602 can communication with the AFRO Aggregator 1604, for instance for process synchronization. The proxy IDP 1602 may maintain and enforce policies regarding user authentication.

The AFRO Aggregator 1604 may perform a variety of functions. By way of example, the AFRO Aggregator 1604 may dynamically create authentication trigger elements, such as buttons that are accompanied by JavaScript code. The aggregator 1604 may send trigger elements to services and/or user devices. The aggregator 1604 can dynamically create code elements that can be sent to a user device. The code elements can be used by the device to interact, for instance trigger, authentication methods, such as NAE or user authentication methods for example. It will be understood that some entities illustrated in FIG. 16 may be collapsed and/or integrated with roles of other entities. For instance, an NAE may also be an IdP. Further, a Proxy IDP and an AFRO Aggregator might be integrated with each other in accordance with an example embodiment. The interface between SRV 1502 and Proxy IDP 1602 may be a predefined interface, such as OpenID for example. Thus, the SRV 1502 may connect directly to an OP function in the Proxy IDP 1602. Alternatively, the Proxy IDP 1602 may integrate a multitude of interfaces as per SRV preferences.

An example scenario is described below to further describe example advantageous functions enabled by the Proxy IDP 1602. By way of example, a user logs in to an online shop on his laptop computer using an identity provided by a large Internet IDP (e.g. google). Once his basket is filled he proceeds to checkout. The checkout function of the shop requires authentication by a stronger factor, in this example case an NAE (e.g., using OpenID/GBA). To perform this, the Proxy IDP 1602 triggers the OpenID/GBA authentication on the user's smartphone. As a prerequisite, the Proxy IDP 1602 maps the user identity from the Internet IDP to the identifier used for NAE second factor authentication (e.g., an IMSI). In the example described above, privacy may be preserved. For example, it is not necessary for the online IDP to know the NAE identifier of the user. Similarly, the NAE need not know the online UID used for the shop. The above described online IDP and/or NAE may provide additional backend functions to the checkout, such as billing for example, but without necessitating an interconnection between them. Further, authentication factors may be orchestrated and combined at will, according to requirements for example.

Another example scenario described below illustrates an example enrollment of a user from one IDP to another, using a determined NAE and/or a user authentication method. By way of example, a user's device may discover a previously unknown WiFi hotspot network in the vicinity to which the user would like to connect. The hotspot network announces that it accepts the user's Google Mail identities, in case the user can also show an MNO subscription for billing. The Proxy IDP 1602 may enable this example use case by mapping, or triggering the mapping of, the Google Mail identity to an MNO identity (e.g., an IMSI). The Proxy IDP 1602 may check if the user preferences and hotspot network usage policies are in accordance with each other. The Proxy IDP 1602 may connect to a suitable frontend via the AFRO aggregator 1604 to display the hotspot networks terms and conditions to the user and obtain acceptance thereof by the user. Further, the Proxy IdP may transfer (or trigger a transfer of) certain user information that may be required by the hotspot network.

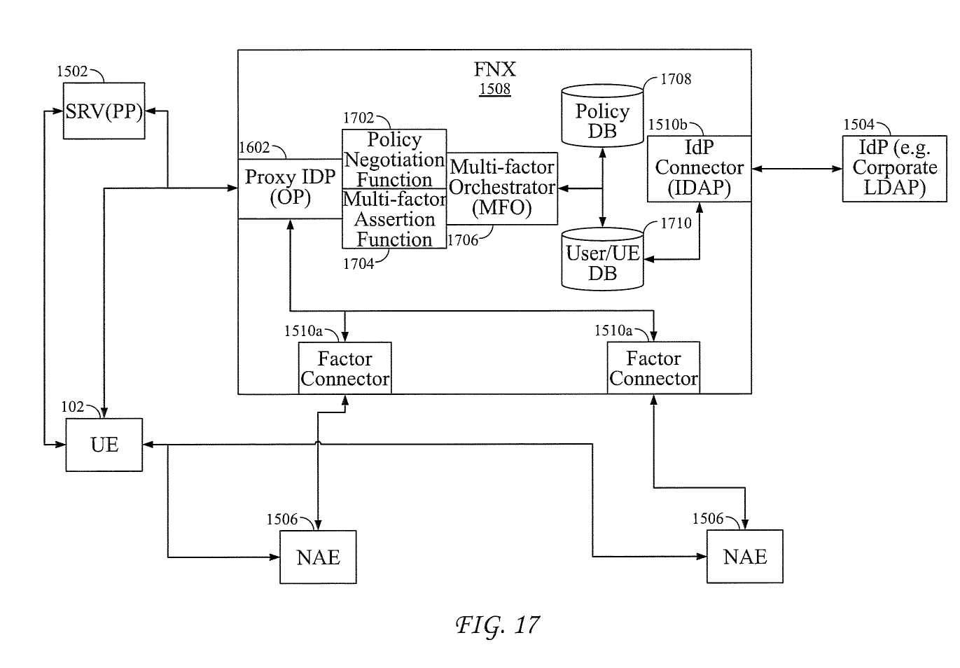

Referring now to FIG. 17, the FNX 1508 may enable authentications using multiple authentication factors as requested by SRV 1502 based on their respective policies for authentication assurance levels, for example. In accordance with the illustrated embodiment, the proxy IdP 1602, for example an OpenID Provider instance, is the technical endpoint. Thus, additional logic for the multi-factor authentication, such as a policy negotiation function 1702 and a multi-factor assertion function 1704, may be separate and hidden from SRV 1502. As illustrated, the additional logic is concentrated in a steering entity, which is referred to as a Multi-Factor Orchestrator (MFO) 1706. The MFO 1706 may control the OP in the case when the OP is integrated with the FNX 1508 as a front-end.

To carry out multi-factor authentications, the OP may require additional functions to initiate and to complete the overall authentication procedure. For example, the OP may require a particular a policy negotiation function, for the example the policy negotiation function 1702, that finds a match between the requirements of authentication posed by the SRV 1502, which may be stored in a policy DB 1708, and the capabilities/preferences of each user and UE, which may be stored in a user/UE database 1710.

Still referring to FIG. 17, the Multi-Factor Assertion Function 1704 may prepare and assert specifics of the multi-factor authentications that have taken place. As shown, MFO, Policy Negotiation, Assertion generation, and OP endpoint may be tightly integrated, but they might also be loosely coupled and connected by application layer interfaces. The actual, single authentications may be carried out in a transparent manner such that they are each agnostic with respect to the whole multi-factor process.

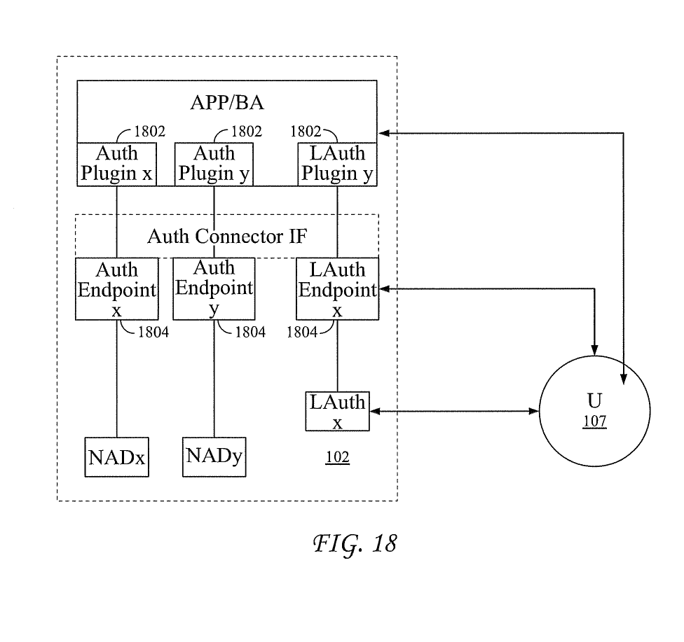

Referring generally to FIG. 18, the device world federation architecture is constructed symmetrically to the network world architecture. In an example case, a device can be considered a passive entity that is remotely controlled by a backend entity, in particular the MFAS 106 for example, for the purpose of federation. This type of scenario poses the least requirements in terms of deployment of federation technology onto devices. As a consequence, current federation procedures using a level one device side architecture concentrate on ‘federation in the cloud’. Thus, the main tasks of federation, such as combination of authentication factors, may be borne by the network world entities MFAS and NAEs.

Referring to FIG. 18, local authentication functions, which may be pre-existing on the device 102, such as EAP-SIM authentication in a UICC, may be exposed by browsers and other applications. These plugin elements may perform simplified communication interfacing between the authentication NADs and the network backend through the MFAS 106. The communication trigger the NAD authentication.

Various authentication plugins, such as plugins 1802 may operate their respective NADs through certain authentication endpoints 1804. For instance, an authentication endpoint may consist of an EAP-SIM or AKA protocol stack. In turn the authentication endpoints 1804 may access the actual NAD authentication via pre-defined interfaces. In some cases, multiple authentication endpoints and NADs may be accessed through a common API, such as for instance the OpenMobile API, which allows access to various secure elements from the Android operating system.

Specific authentication factors may include local user authentication factors such as biometric factors for example. Their authentication endpoints and NADs (biometric readers) may consist of proprietary technology, such as provided by BioKey's WebKey. Some other authentication factors may also involve user interaction and/or local user authentication. In some cases, such interactions are reduced to accepting authentication actions by pressing a button or entering a PIN.

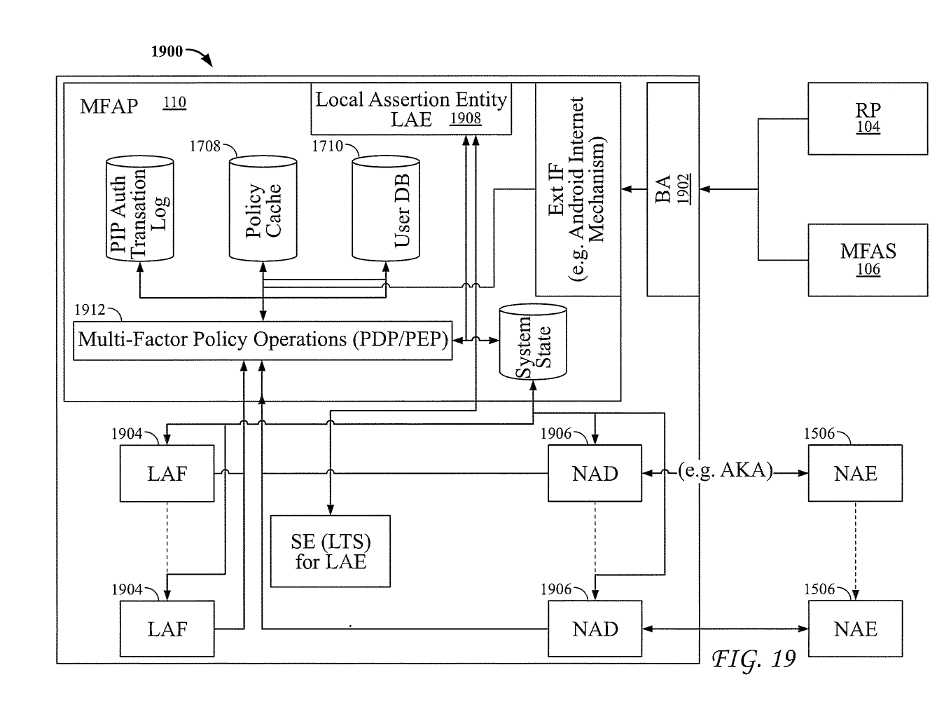

Referring also to FIG. 19, an example architecture 1900 can be used for multi-factor authentication on the device 102, which may interworking with a server-side MFAS 106. The architecture 1900 is different than the above-described passive device architecture in a variety of ways. For instance, the architecture 1900 include the MFAP 110 on the device 102.

Referring to FIG. 19, in accordance with an example embodiment, a Trusted Execution Environment (TEE) of the device 102 may protect various functions in the architecture 1900 such that tampering with the critical data is not possible. More details on example security requirements are detailed below.

For the sake of example, example functions of the multi-factor architecture 1900 are described based on an Android platform, but it will be appreciated that the architecture may also apply to other platforms as desired. The policy operation may be the first activity to be called in the Multi Factor Authentication Proxy 110, which may also be referred to as an MFAL 110, when an Android application registered with Android OS schema “soid.scheme://<method>.<factor>/<factor-data>” is triggered using a Browser Agent (BA) 1902. This layer of the Android application may make a decision and filter out the policy for multifactor authentication. For example, it may be determined that various authentication factors are required based on an access right policy. Based on a policy defined for the device-local authentication, different Local Authentication Factors (LAF) 1904 and Network Authentication Delegates (NAD) 1906 are called for processing the authentication request. The different authentication factors may be part of different activities in the Android application.

The state of MFAL 110 and the Local Authentication Factors 1904 LAF may be updated to an application system state application of the Android OS. This system state application should, if possible, run in the TEE because it may contain authentication sensitive information, such as a number of authentication factors, the state of the authentication factors (e.g., success, fail), a number of retries, session information, or the like.

In some cases, LAF 19004 can be factors that only require a local entity of the UE 102 for authentication. For example, such factors may include a local password authentication against a local database, a local fingerprint authentication, a local iris scan, behavioral patterns authentication, or the like.

Network Authentication Delegate (NAD) 1906 may require communicating with servers of internal/external network. Example authentications include MNO authentication, SIM based device authentication, fingerprint authentication, or the like.

A Local Assertion Entity (LAE) 1908 that is included in the illustrated MFAL 110 may be a central point to issue assertions concerning locally executed authentications. Even in a local authentication scenario, there can be a LAE on the network (e.g., Local Auth+Network Assert scenario described above). The LAE 1908 may issue assertions to the peer MFAS 1906 after a MFAL Policy Processor 1912 has successfully executed the authentication policy for local authentications, as received from the MFAS 106.

When putting functions, logic, and data on the user device 102 that is endowed with trusted functions such as user authentication, it is recognized herein that security is of the essence. Described below is some embodiments which implement security on the example architecture 1900.

In one embodiment, the function of single authentication factors is not necessarily included in a TEE, because the security of each factor may be assessed separately. Thus, in authentication factors performed locally on the device may have software security levels that use soft credential stores. Further, authentication factors may have hardware security provided by smart cards. By way of another example, local authentication factors may have intermediate levels, for instance a secure fingerprint reader may be combined with a software matching algorithm running in user space. Further, specific authentication factors may use TEE resources in accordance with various embodiments.

Data paths from authentication factor NADs 1906 and LAFs 1904 may be secured by TEE resources, for instance encrypted/integrity protected messaging. Also, the data paths to/from the user to LAF/NAD may be secured by TEE resources. In addition, the data paths in which authentication results are sent between the MFAL 110 and the MFAS 106 are protected in an example embodiment.

Databases are not necessarily included in TEE-protected storage, but may be protected, for example at least for integrity, by TEE resources. In some cases, DBs containing user/UE data are encrypted for privacy.

If the MFAL 110 contains a local assertion production entity, for example, its logic may be protected inside the TEE. Furthermore, root credentials and the actual signing process of locally generated assertions may be protected by the TEE or by a separate secure element that may be denoted as SE for LA. The SE may have a Long Term Secret (LTS).

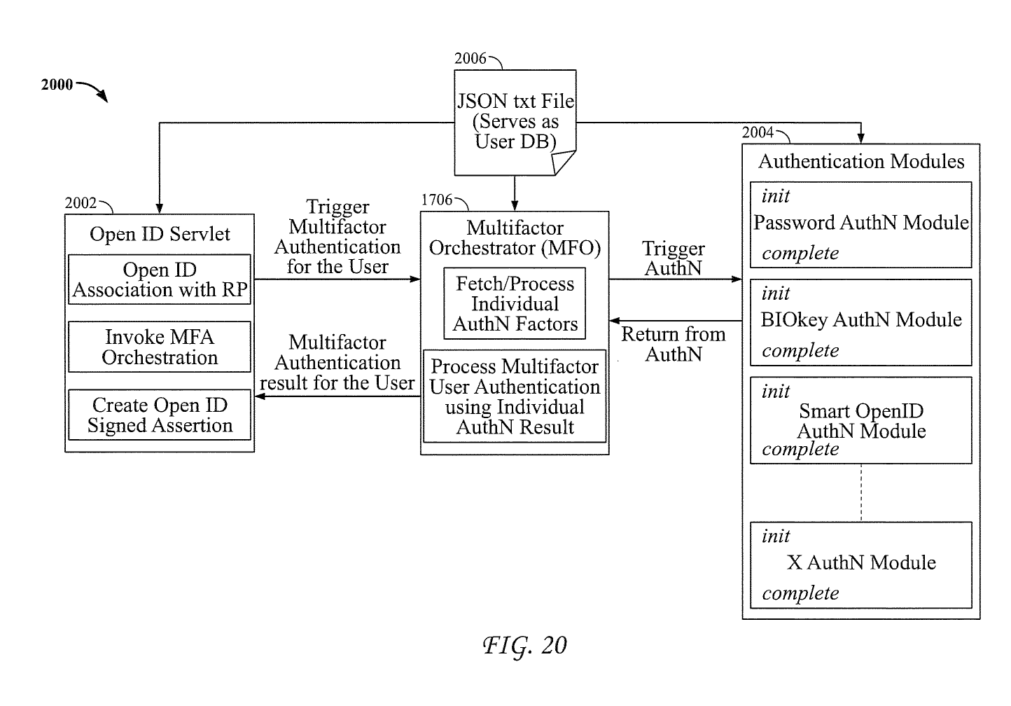

Referring to FIG. 20, an example servlet architecture 2000 is shown in accordance with an example embodiment. The example architecture 2000 consists of an OpenID Servlet 2002, the Multi factor Orchestrator (MFO) 1706, and individual authentication modules 2004. The components maintain modularity, so that further extensions to the existing base system can be implemented. The implemented modular and loosely coupled design provides the possibility of adding additional functionality such as a policy system described herein, or an additional authentication factor as a new authentication module 2004. From a development and deployment perspective, the architecture 2000 provides a benefit because other systems may integrate with existing system with comparatively minimum effort.

In accordance with the illustrated embodiment, the OpenID Servlet 2002 contains OpenID protocol functionality. The OpenID servlet 2002 may be responsible for creating the OpenID association with the RP 104 and for creating the OpenID signed assertions. The MFO Orchestrator 1706 interfaces to the OpenID Servlet 2002, and provides multifactor authentication functionality. For example, the OpenID servlet 2002 may invoke multifactor authentication by triggering the MFO 1706. By having these independent servlets, for example, the functionalities of the OpenID protocol and functionalities of multifactor authentication may be kept isolated from one another to reduce code dependency.

The MFO 1706 may be the core functional component for the multifactor authentication. In an example embodiment, the MFO 1706 can perform various functionalities that include fetching the authentication factors, ordering the processing of individual factors, determining exit conditions for authentication modules, and consolidating the individual authentication results based on underlying policies. At a higher level, the MFO 1706 can be considered as a gateway between the OpenID servlet 2002 and the Authentication modules 2004. The MFO 1706 provides the possibility of further extension of the existing system as most of the major functionalities of authentication may be implemented in this module.

In accordance with the illustrated embodiment, the authentication module 2004 contains various authentication components based on the type of authentication factor (e.g., password authentication (auth) module, Biokey auth module, smart OpenID auth module). In accordance with the example embodiment, the MFO 1706 fetches each user's profile, which may be stored as a JSON Object, and determines the type of authentication factors the user can perform. Further, MFO 1706 may determine an order in which the authentication factors are to be carried out. The authentication module 2004 that implements the corresponding auth factor (e.g., Biokey, Smart OpenID, EAP SIM) is triggered by the MFO 1706. In one example embodiment, once the execution of the code specific to one auth factor is complete, control is returned back to the MFO 1706, which repeats the same procedure until it has iterated over all of the needed auth factors for that user. Thus, the multifactor authentication process may end when at least one, for instance all, of the auth factors have been successfully completed by the user.

A JSON txt file 2006 may contain the object with the corresponding key/value pairs with username identifier as the object and corresponding user data as key/value that can be seen in the JSON Snippet. In one embodiment, it may be a user database that stores various information, such as, for example:

```
{
“janesmith”: {
  “email”: “janesmithnovalyst@gmail.com”,
  “nickname”: “jane”,
  “fullname”: “Jane Smith”,
  “dob”: “27-07-2012”,
  “gender”: “F”,
    “postcode”: “12345”,
  “country”: “US”,
  “language”: “us”,
  “timezone”: “America/Los_Angeles”,
  “biokeyID”: “janesmith”,
  “authFactors”: “/biokey,/password”
  }
}
```

Referring to the example JSON Snippet above, the JSON Snippet may include the OpenID protocol information that includes the OpenID identifier, the type of auth factor used for authentication for this particular user, the order of execution of the auth factors for each user (which may be order in which the auth factors are specified in the JSON file), and a Biokey person ID. The JSON snippet may also contain various information associated with the user such as, for example, a full name, email, city, or the like.

Still referring to FIG. 20, the illustrated authentication modules 2004 are not external modules, but are an integral part of MFAS 110. In some cases, the modules 2004 may use information from the JSON user DB 2006 to complete their job. For instance, in the case of biometric authentication with a BioKey, an authentication module 2004 may use the DB to match the returned BioKey ID to the user's Biokey ID.

Retry and freshness information for a particular authentication factor may also be stored within the auth result object. Assurance level mapping to auth factors for users may also be kept bounded to the user profile.

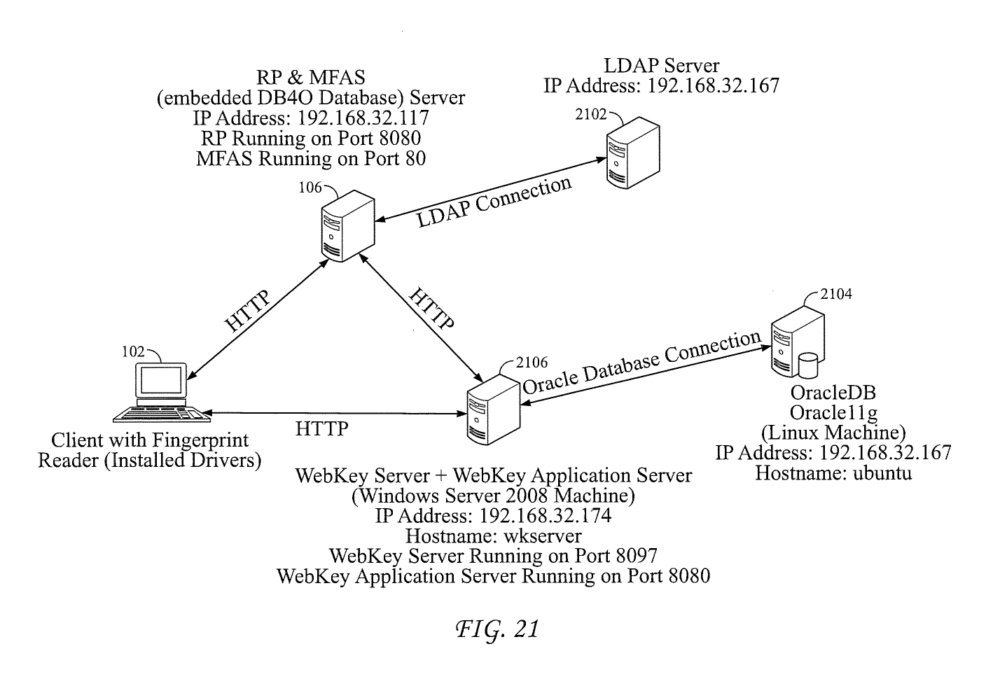

Referring to FIG. 21, in accordance with one embodiment, each user who uses the MFAS 106 may have an internal DB4O user record that is used for operations internally within the server 106. In an example embodiment, referring to FIG. 21, the MFAS 106 interacts with an LDAP 2102 via an operations module that utilizes an open source library. Thus, the MFAS 106 may contain the operations to connect to the LDAP 2102 and fetch user information based on a user ID from the LDAP 2102. For example, the UE 102 that is using a regular browser may hit the relying party's URL and enter his or her OpenID identifier. The relying party triggers the MFAS 106 to execute the OpenID protocol based on the OpenID identifier. A DB4O Operations module on the MFAS 106 may populate user profile information that is fetched from LDAP 2102. The DB4O operations may contain the functionality to store, read, and update user profile information. As illustrated, the LDAP server 2102 may be an external entity that is reachable by the MFAS server 106 by establishing a LDAP connection. An Oracle Database 2104 is an external entity that may be part of the Biokey setup. The Oracle database 2104 may be reachable by a webkey server 2106 by establishing an Oracle database connection.

Still referring to FIG. 21, in accordance with the illustrated embodiment, the client machine 102 is installed with drivers for finger print enrollment and identification purposes. The Client Machine 102 is able to reach the RP 102, MFAS 106, webkey server 2106, and the webkey application server over HTTP. The communication between the MFAS server 106 and the WebKey sever 2106 may be over HTTP.

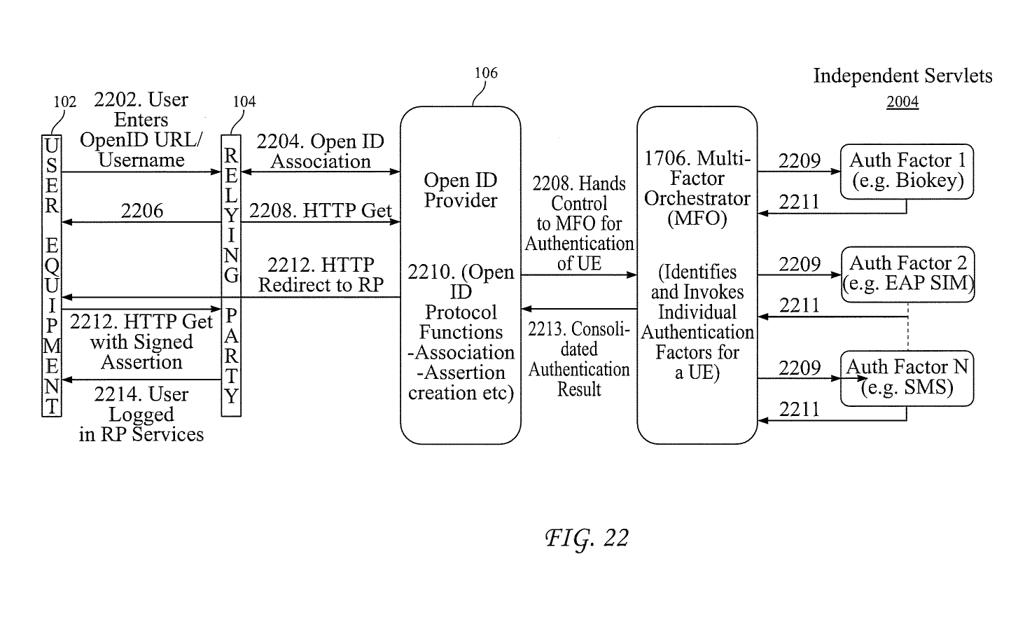

Referring to FIG. 22 and FIG. 20, in accordance with the illustrated embodiment, at 2202, the user 107 the user enters the OpenID URL/username. At 2204, the relying party 104 discovers the OpenID provider 106 and establishes the association. At 2206, the RP 104 redirects the user equipment 102 to the OP 106. At 2208, the user 102/107 follows the redirect to the Open ID provider 106. The OpenID provider 106 hands the control to the MFO 1706 for authentication of UE 102. The OpenID servlet 2002 accesses the user DB JSON file 2006 to check for the existence of the user identifier. The Multi Factor Orchestration (MFO) 1706 fetches the required user info from the JSON file 2006, including the auth factors for the user, and processes individual auth factor. The MFO 1706 reads the auth factors and the order of execution from the JSON file for the user. At 2209, the MFO 1706 passes control to individual authentication modules 2004, such as password modules, biokey modules EAP-SIM modules, or the like. At 2211, after each individual auth factor is executed, it returns control to the MFO 1706, which triggers the next auth factor. Thus, steps 2209 and 2211 may be repeated for each authentication factor until all the factors for a particular user are completed. At 2213, once all the auth factors have been processed for example, the Multifactor Orchestrator (MFO) 1706 processes the consolidated multifactor user authentication result using the individual auth factor results. At 2210, once the multifactor authentication result for the user is successful, for example, the OpenID servlet 2002 creates the OpenID signed assertion. At 2212, by following the HTTP redirect, the user 107 takes this signed assertion to the RP 104. Thus, at 2214, the user 107 and the UE 102 are can access the services provided by the RP 104.

Referring to FIG. 20, the OpenID servlet 2002 and the MFO 1706 include integration points for additional features that are implemented in an example embodiment. For example, the OpenID servlet 2002 may further include a policy negotiation function that can enable negotiation with an RP. The OpenID servlet may also include an assertion creation function such that it can create and sign multi-factor authentication assertions for individual authentication factors. The MFO 1706 may further include functionality that allow it to check freshness, track authentication retries, enforce policies, and evaluate attributes that are returned from factors, such as Biokey identifiers for example.

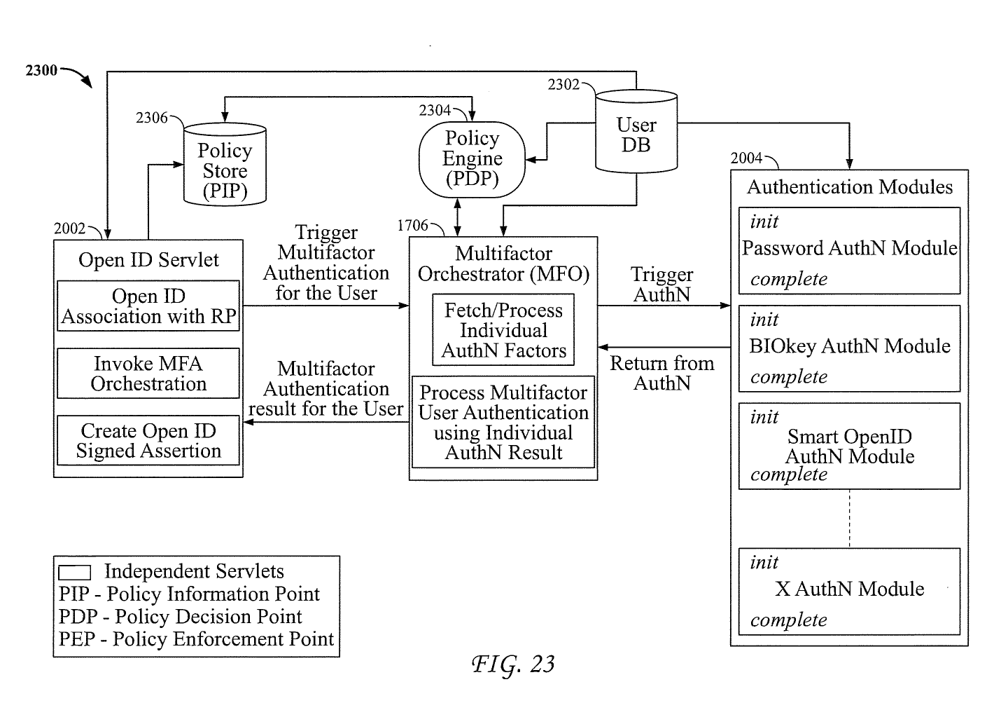

Referring now to FIG. 23, an example policy based authentication architecture 2300 is shown. The architecture 2300 includes a user DB 2302 that may contain various user information such as, for example, OpenID identifiers and other user attributes described above that may be used in multi-factor authentication. The architecture 2300 may further include a policy store 2306, which may also be referred to as a policy information point (PIP) 2306, and a policy engine 2304, which may also be referred to as a policy decision point 2304.

In one embodiment, the PIP 2306 acts as a source of information point that collects information from various internal or external entities. The OpenID Servlet 2002 may act as an entity that feeds the PIP 2306 with the information for policy negotiation with an RP. Thus, the RP is able to identify user device capabilities for a required authentication. There may be additional entities that influence the policy engine 2304 to make decisions. The policy engine 2304 is a decision making point that collects relevant information from the PIP 2306 about a particular user or about policies. In one embodiment, the policy engine 2304 publishes policy decisions to one or more policy enforcement points (PEP), which are tasked with enforcing policies. For example, the MFO 1706 may be a PEP which can enforce policies based on a number of retries, freshness checks, or the like.

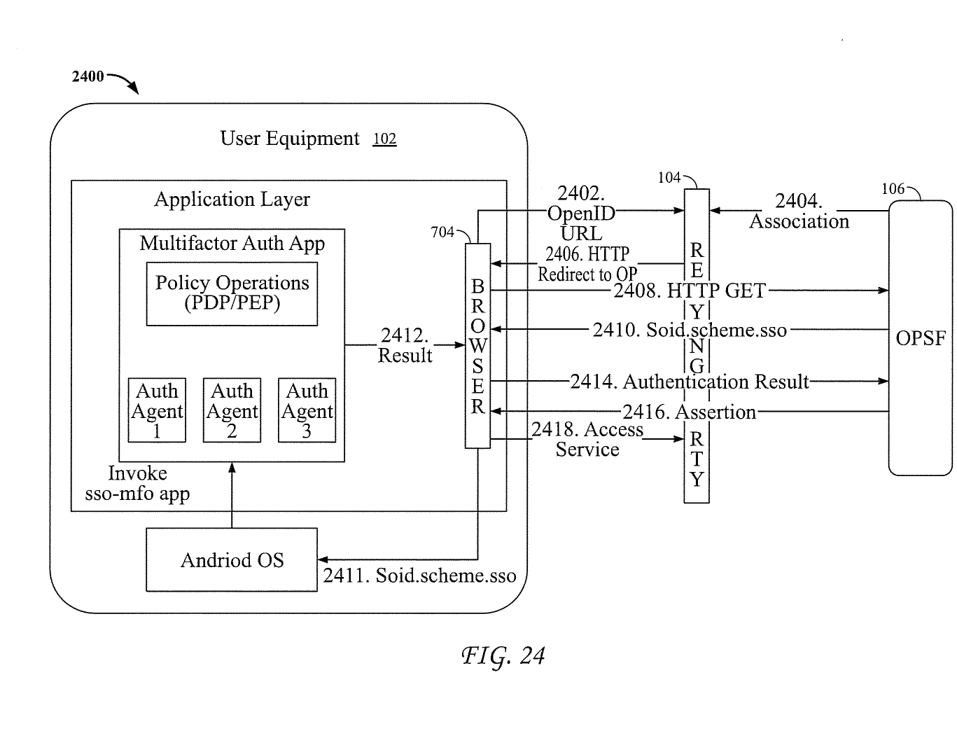

Referring now to FIG. 24, an example system 2400 implements multi-factor authentication based on Smart OpenID. FIG. 24 shows an example architecture of the UE 102. At 2402, in accordance with the illustrated embodiment, the UE 102 requests service from the RP 104. At 2404, the RP 104 performs a discovery and association with the OPSF 106. The UE 102 is redirected to the OPSF 106 at 2406 and 2408. At 24100, OPSF initiates a local user authentication. An authentication is performed on the UE 102 using one of the local authentication agents, and, at 2412, an authentication result is sent to the browser 704. The browser 704 forwards the authentication result to 2414 to the OPSF 106, at 2414. The OPSF 106 provides an authentication assurance to the browser 704, at 2416. At 2418, the UE 102 can receive access to the service provided by the RP 104, based on the assertion.

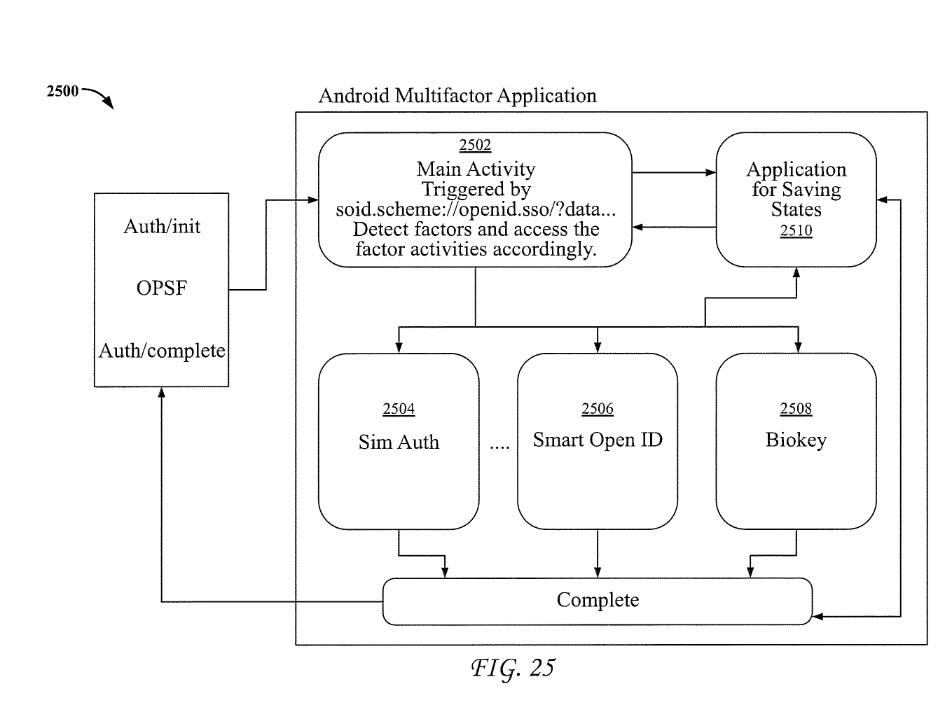

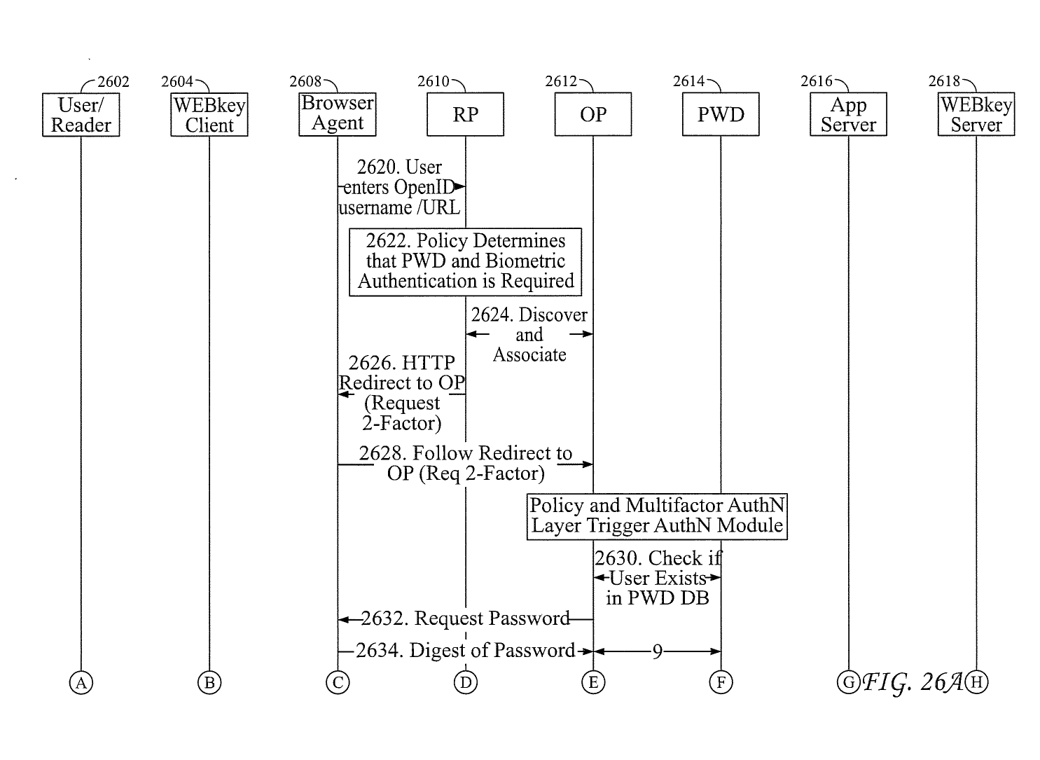

Referring now to FIG. 25, an example multi-factor application 2500 is shown. While the application is illustrated as an Android application, it will appreciated that the multi-factor application may be implemented on an alternative platform as desired. The application 2500 includes one or more activities that can be launched as authentication factors by a main activity 2502. The one or more activities include a Sim Auth activity 2504, a Smart OpenID activity 2506, and a Biokey activity 2508. Each of the activities 2504, 2506, and 2508 can also be referred to as authentication factor activities. The authentication factor activities can each update its status to a state application 2510. Examples of statuses include authentication and not authenticated. In accordance with the illustrated embodiments, after each of the factors have been performed for the authentication of the device, control is given complete activity as shown in FIG. 25. This complete activity may send an authentication result to the OPSF 106, as shown in FIG. 24. An auth/complete servlet may receive the authentication result and then authenticate the device.

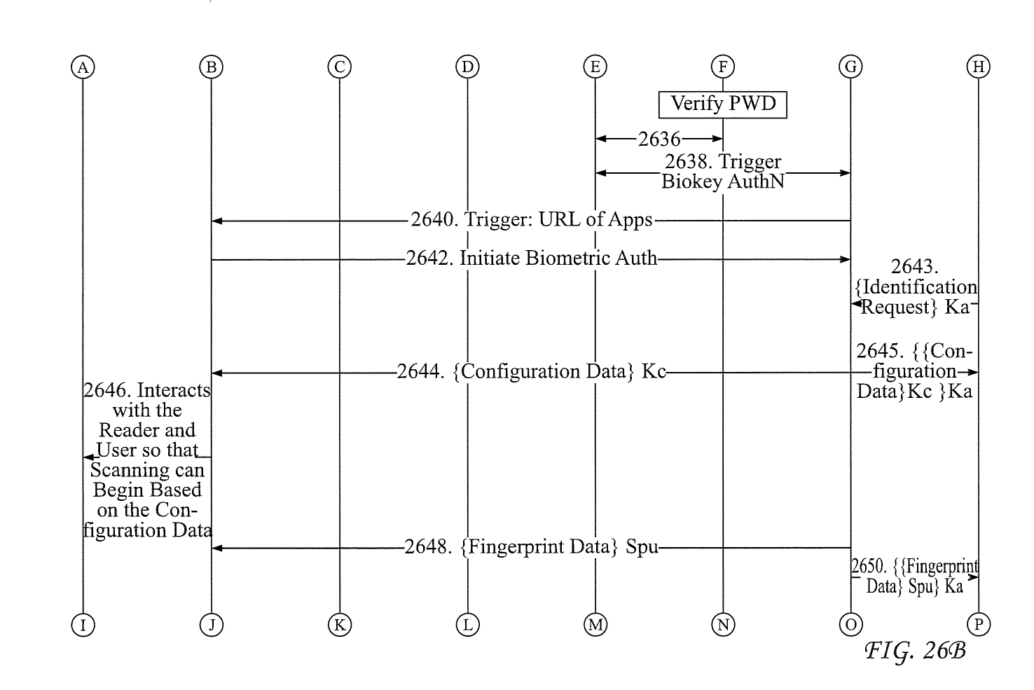

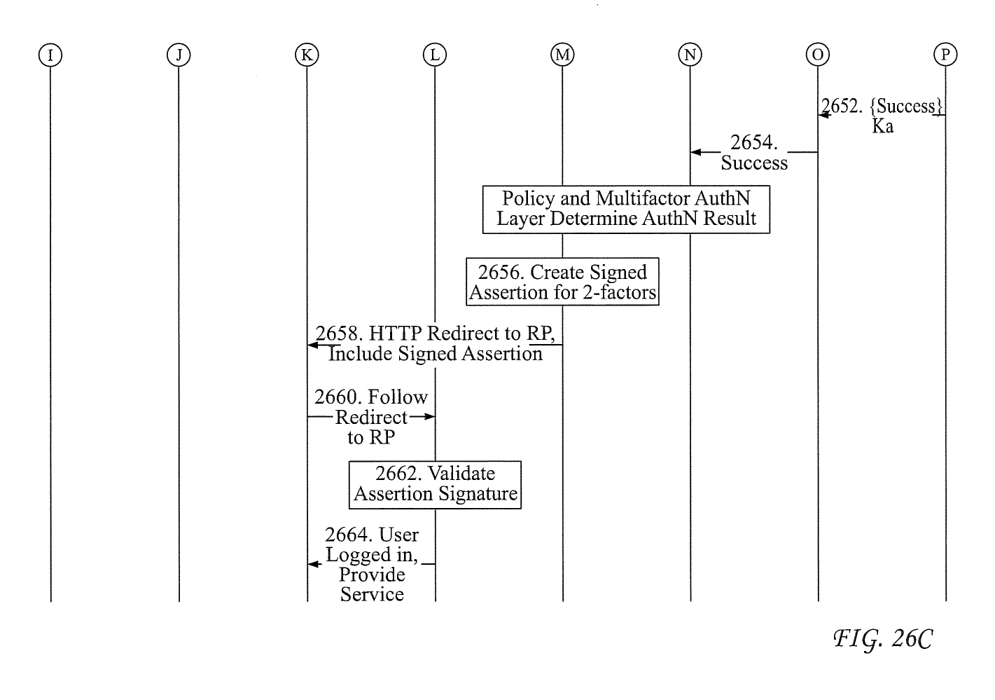

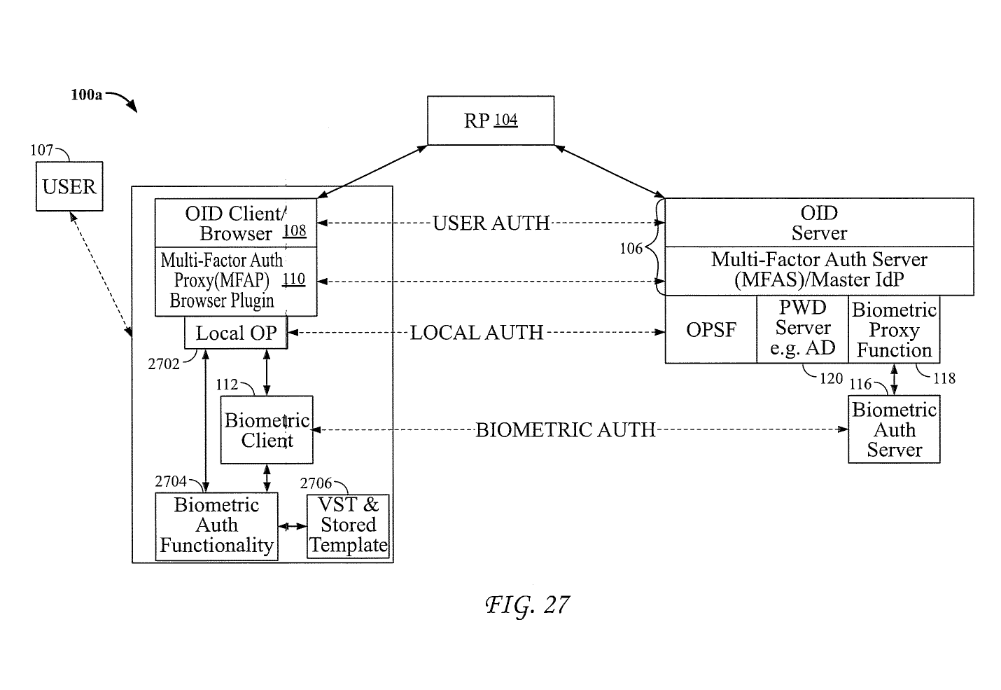

Referring now to FIGS. 26A-C, an example authentication system 2600 includes a user 2602, a webkey client 2604, a browser agent 2606, an RP 2610, an OP 2612, and password server (PWD) 2614, an application server 2616, and a webkey server 2618. The webkey client 2604 and the browser agent 2606 may be part of the user 2602. The user 2602, the RP 2610, the OP 2612, the PWD 2614, the App server 2616, and the webkey server 2618 may communicate with each other via a network.

Referring also generally to FIGS. 15 and 17, password based user authentication may be integrated with fingerprint based identification and authentication via the FNX 1508. For example, the a biometric NAE connector (e.g., webkey 2604) may be co-located with the FNX 1508. The FNX 1508 may have access to a database that stores authentication methods that a particular user supports. In some cases, a service provider (RP) can use the OpenID PAPE extension to communicate its desired/required authentication method to the FNX 1508.

In an example embodiment, the RP 2610 makes a decision regarding the required authentication policy because, for example, the RP 2610 may know best what strength of authentication should be required for the service it provides. The RP 2610 can communicate this required policy to the FNX 1508, for example, using a PAPE. The FNX 1508 may execute authentication based on that policy and based on capabilities of the user/UE 2602. By way of example, Table 5 shows an example mapping of capabilities and policies. Referring to Table 5, four different authentication screens render four different outcomes, though it will be understood that any number of outcomes can be rendered as desired. In accordance with the illustrated example, the FNX 1508 may determine, based on the policy and capabilities, that password authentication is needed, a biometric authentication is needed, both a password and a biometric authentication is needed, or that the user 102 cannot access the service. Thus, a screen on the UE 102 may be displayed that requests a password, that requests a fingerprint, that requests a password and a fingerprint, or informs the user that they cannot access the service (see Table 5).

TABLE 5

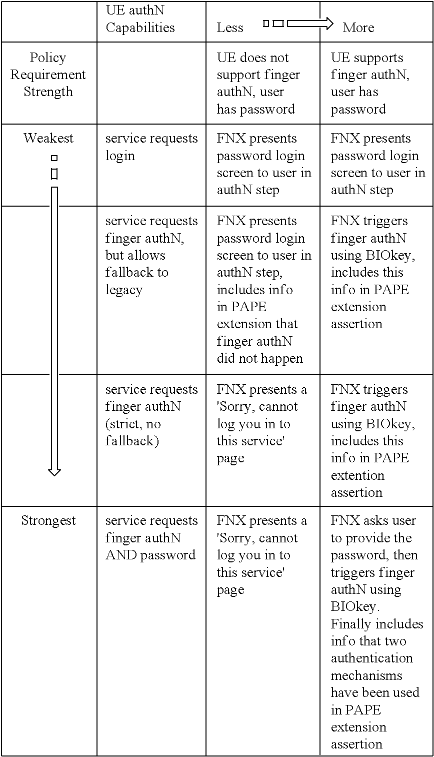

With particular reference to FIG. 26A, at 2620, in accordance with the illustrated embodiment, the user 2602 opens the browser 2608, visits the RP webpage 2610, and enters his OpenID identifier (URL) in the OpenID login field. At 2622, the RP 2610 checks with a local policy database and determines that biometric authentication is required for this specific user. At 2624, the RP 2610 runs the OpenID discovery and association steps and retrieves a shared key from the OP 2612 as a result of the association. In an example embodiment, the OP 2612 can advertise support for specific authentication policies in the discovery phase by adding supported authentication policies to the user's XRDS document for Yadis discovery. At 2626, the RP 2610 starts the OpenID authentication request by redirecting the UE 2602 to the OP 2612 (indirect request). The RP 2610 can include any necessary parameters describing its preferences for an authentication policy for the current assertion, for example, using the PAPE extension. For example, the RP 2610 may indicate that it requires a password and a biokey authentication. At 2628, the UE browser 2608 follows the redirect received from the RP 2610 and issues the request to the OP 2612. In an example embodiment, after step 2628 and before step 2630, the policy layer and the multi-factor authentication layer may determine any necessary authentication interfaces with which to trigger authentications, as described above. In this example, the policy layer determines that both BIOkey and password authentication should be carried out, and the policy layer then triggers the multifactor authentication layer to run both authentication methods. At 2630, the OP 2612 checks with the PWD 2614, which can also be referred to as a user database, to verify that the user exists in the DB. If the user exists in the database the OP 2612 may proceed. Otherwise the OP may present a registration/signup page for the user (OOS for implementation) to register with the PWD 2614. At 2632, the OP 2612, tasks the user for the password. At 2634, the user enters the password and the digest of the password gets sent back to the OP 2612. At 2636, the OP 2612 checks the received password digest with the password database 2614 to validate the received password. If the password is correct, the OP 2612 may proceed. The OP 2612 may keep track of the current session internally using a session identifier.

Referring in particular to FIG. 26B, in accordance with the illustrated embodiment, at 2638, the OP 2612 can, based on the username from the authentication request for example (see step 2626), retrieve the necessary key and identifiers to trigger a BIOkey biometric authentication subsystem, which is generally referred to as the App server 2616. The Biokey technology might internally use different identifiers so this step may also include the OP 2612 mapping the entered OpenID username to an BIOkey subsystem username. Roundtrip communications may occur at 2640 and 2642, for example, based on the BIOkey technology that is implemented. Thus, the BIOkey client on the UE 2602 may request authentication from the application server 2616 at the OP 2612. At 2643, the BIOkey application server, which may be a component of the OP 2612 as described above, issues a BIOkey authentication request to the BIOkey Webkey server 2618. Such a request may be encrypted using an application key (Ka). At 2635, the BIOkey webkey server may encrypt configuration data with a client specific key (Kc) and may encrypt the message using the application key Ka. In accordance with the illustrated embodiment, the encrypted message is returned to the application server 2616. At 2644, the application server 2616 triggers the BIOkey client on the user device 2602 and sends the configuration data encrypted using the client key Kc. At 2646, the webkey client 2604 on the UE 102 may interact with a fingerprint reader device to scan a fingerprint image. At 2648, the Webkey client 2604 sends the fingerprint data back to the application server 2618. At 2650, the application server 2616 forwards the received fingerprint data to the webkey server 2618.

Referring in particular to FIG. 26C, in accordance with the illustrated embodiment, at 2652, the webkey server 2618 checks the fingerprint and then responds to the application server 2616 with a success message when there is a successful match. At 2654, the application server 2616 forwards the success message to the OP 2612. In some cases, before creating an assertion, the above-described policy layer and multi-factor authentication layer may determine that the authentication was successful, and because the authentication results fulfill the required policy, the OP 2612 can proceed to create the signed assertion message. At 2656, the OP 2612 creates the signed assertion message. At 2658, the OP 2612 redirects the UE 2602 back to the RP 2610. The signed assertion that asserts that a two-factor authentication took place can be included in this redirect message. At 2660, the UE 2602 follows the redirect to the RP 2610. At 2662, the RP 2610 receives the assertion message and validates the assertion signature using the shared key established in step 2624. At 2664, if the assertion is valid, the user 2602 is authenticated at the RP 2610 and the RP service can be provided to the user 2602. In one embodiment, after step 2626, the OP 2616 checks if the user exists in the password database 2614. If so, the OP 2612 performs the password based authentication. The OP 2612 may communicate (interact) with the password database to verify the password digest, and if the password is correct, the OP 2612 may trigger the BIOkey web client at 2632.

Referring now to FIG. 27, the system 100a is similar to the system 100 depicted in FIG. 1, but the system 100a further depicts a biometric authentication module 2704 and a stored template 2706 that are part of the UE 102. The UE 102 in system 100a further includes local OP 2702, which is a module that is configured to locally perform OpenID based authentication on the UE 102.

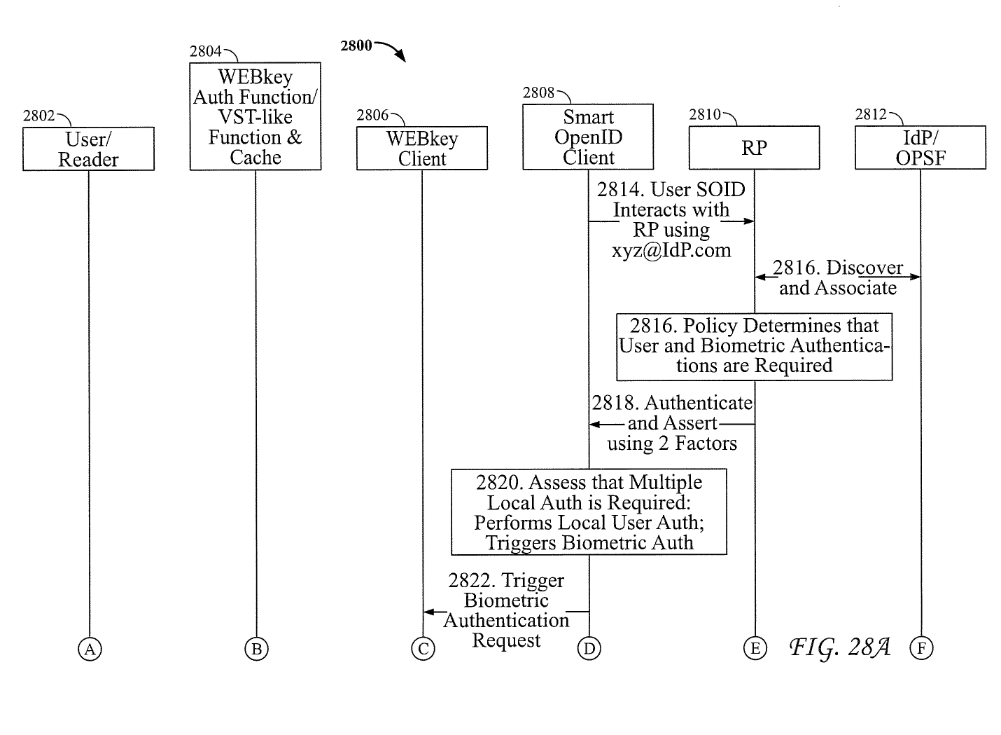

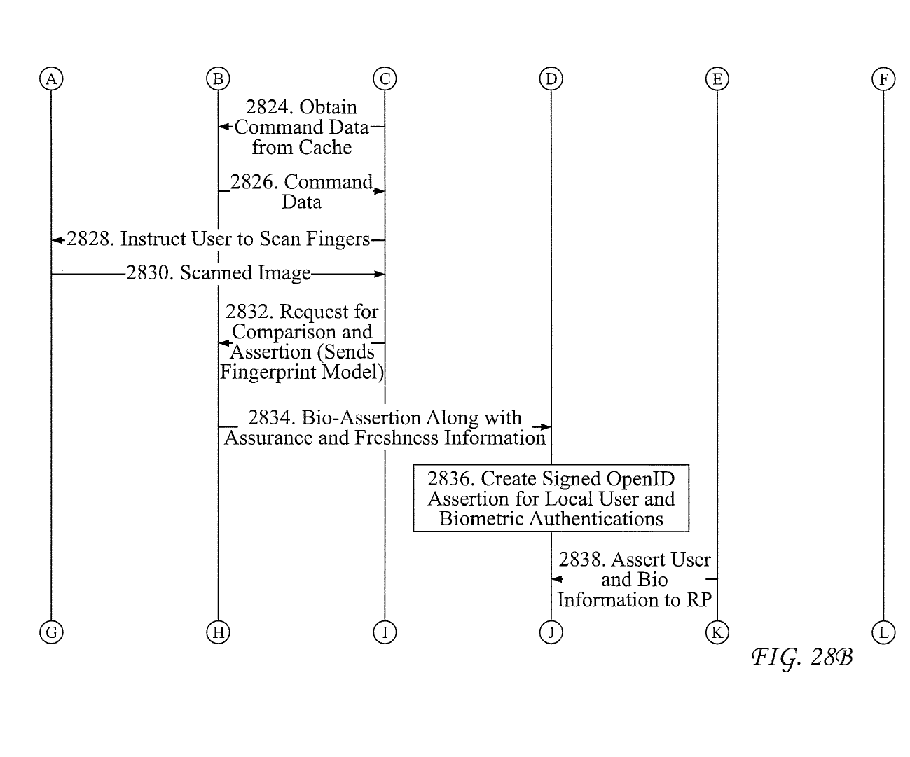

Referring to FIGS. 28A-B, an example authentication system 2800 includes a user 2802, a webkey authentication client 2804, which may be configured as a VST-like function and cache, a smart OpenID (SOID) client 2808, an RP 2810, and an IdP/OPSF 2812. In an example embodiment, the SOID client 2808 and the webkey client 2808, and the webkey authentication function reside on the UE 2808. Thus, the SOID client 2808 may be analogous to the local OP 2702 referenced in FIG. 27. At 2814, in accordance with the illustrated embodiment, the user 2802 requests service to the RP 2810, which may be referred to as an SP 2810, using the User's registered identity via the OpenID-aware client or browser. At 2816, the RP 2810 performs a discovery and association with the IdP 2812 that is associated with the user's identity in compliance with an OID/OIDC protocol. At 2818, in accordance with the illustrated embodiment, based on the user's identity and/or the type service requested by the user 102, the RP 2810 determines if a multi-factor authentication is required. The RP 2810 may further determine or select authentication factors that satisfy an authentication requirement. At 2818, based on policies at the RP 2810, the RP 2810 determines the type of factors that are required for authentication and communicates the required factors to the User/SOID client 2802. At 2820, if a User and Biometric authentications are required, the SOID 2808 initiates a local user authentication and then triggers a Biometric Authentication. At 2822, upon a successful Local User Authentication, the SOID 2808 initiates a Biometric Authentication Request using a trigger (e.g., API call) to the Web-key client 2806.

With particular reference to FIG. 28B, in accordance with the illustrated embodiment, at 2824, the Web-key client 2806 requests to obtain the command data from a locally stored cache that may be protected within a smart card. At 2826, the command data is sent from the cache to the Web-key client 2806. The data may be obtained using mechanisms such as OpenMobile API. At 2828, using the command data, the web-key client 2806 instructs the Reader/User 2802 to initiate the process to scan the user's fingerprints. Various example requirements include required quality and number fingers. Such requirements that are used for scanning may be part of the command data, or they may be tailored based on instructions from the RP 2810. At 2830, the scanned image is read from the reader, and thus the UE 2802, and is sent to the web-key client 2806. At 2832, the web-key client 2806 sends the fingerprint model to the Web-key Server 2804 and requests it to authenticate (verify) the user's fingerprints. At 2834, if the Local Biometric Authentication is successful, then the Web-key 2804 sends an assertion with associated assurance information (e.g., Quality of Image, number of fingers used, etc.) and associated freshness information to the Smart OID Client 2808. At 2836, the Smart OID client 2808 creates a single assertion using the information provided by the Web-key client 2806 and the local user authentication information that was carried out earlier. At 2838, the Smart OID client 2808 sends the combined assertion to the RP 2810 so that the user 2802 can obtain access to the service based on the results of the assertion.

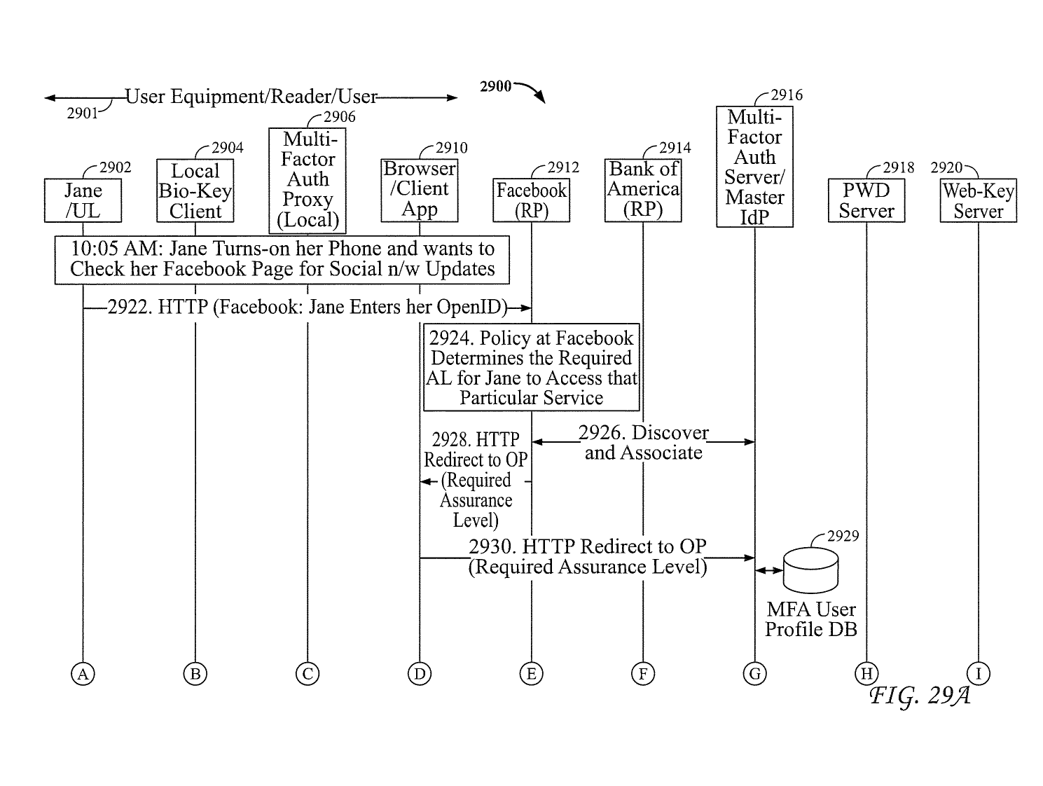

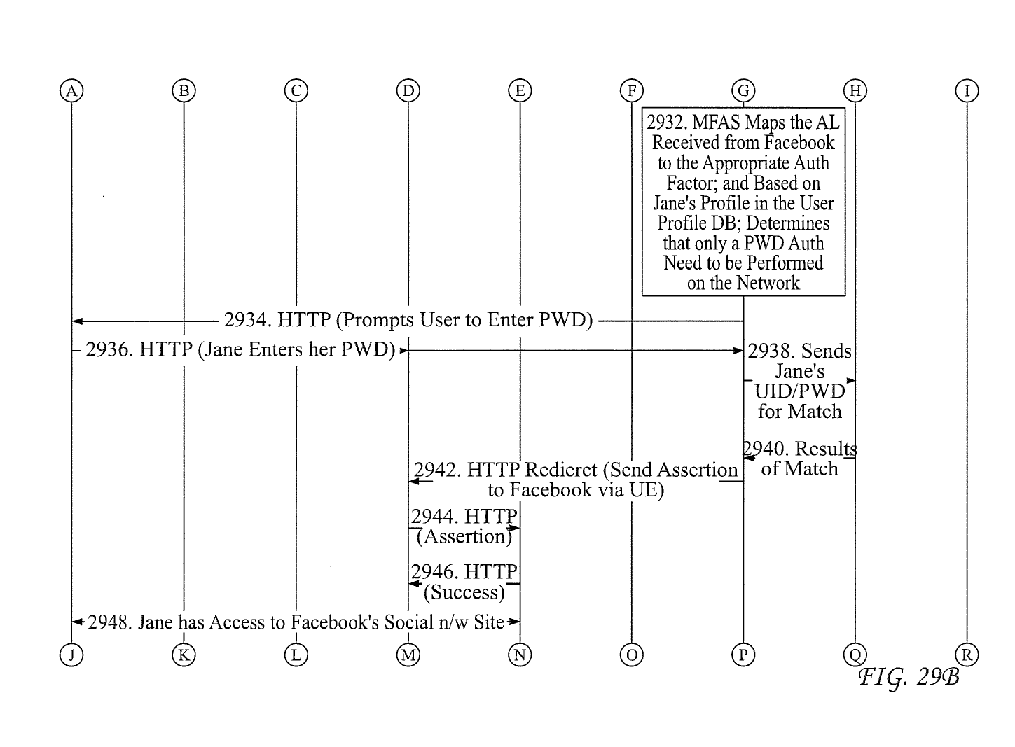

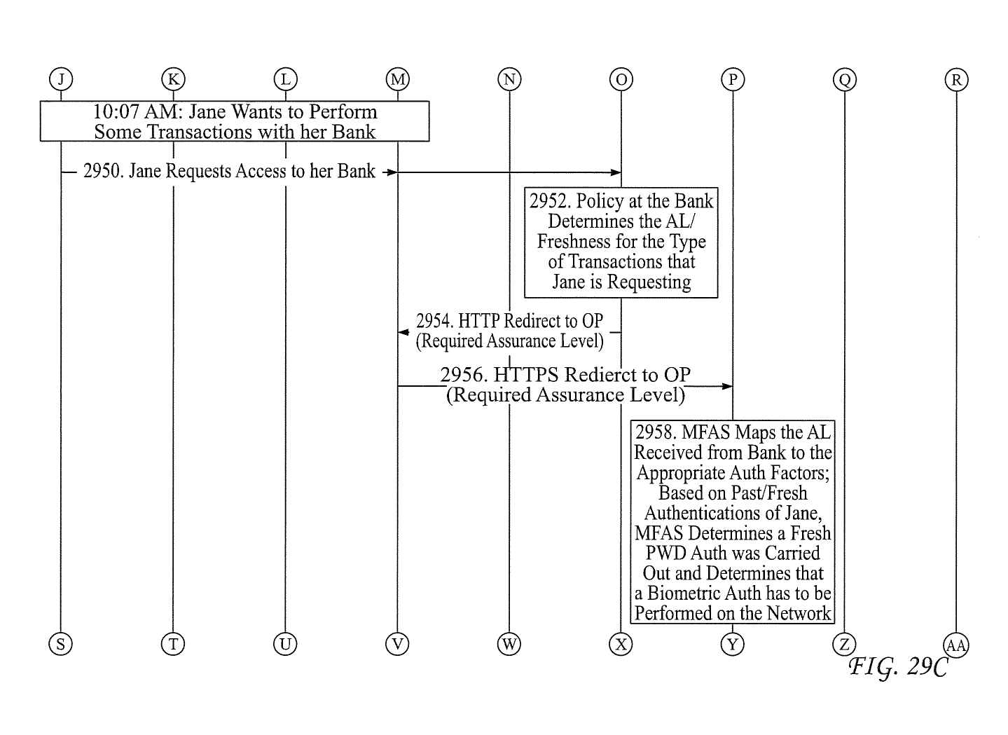

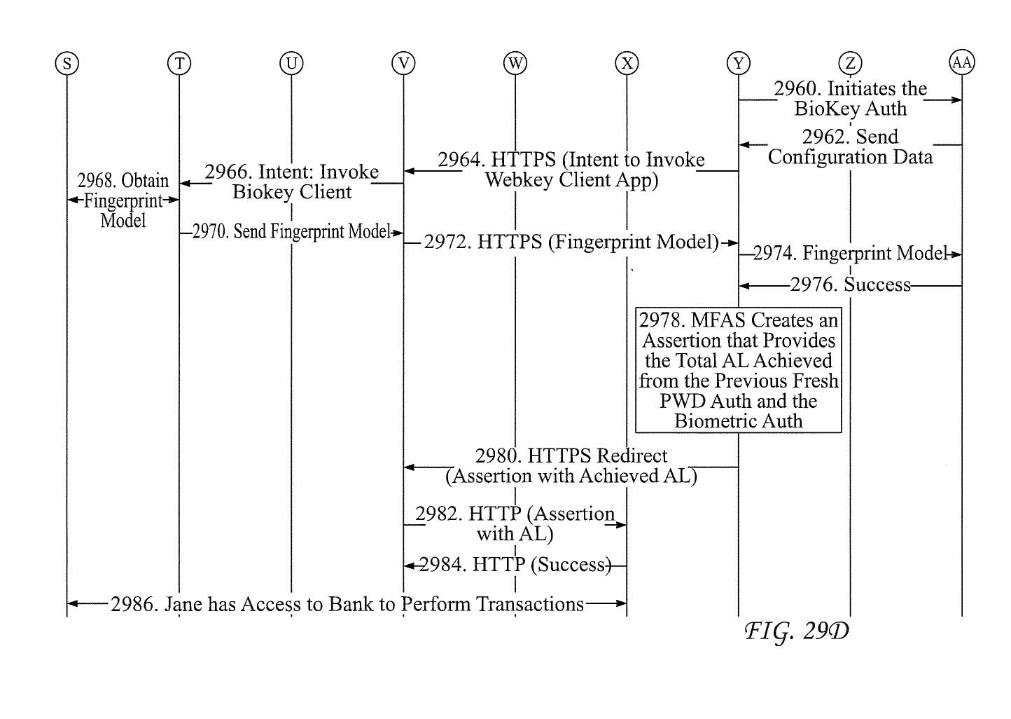

Referring now to FIGS. 29A-D, an example system 2900 includes user 2902 and UE 2901, a first RP 2912, a master IdP/MFAS 2916, and a second RP 1106 that communicate with each other via a network. The network may further include a PWD server 2918 and a web-key server 2920. The user 2902 is referred to as “Jane” in FIGS. 29A-D. The UE 2901 may include a local bio-key client 2905 and a browser 2910. It will be appreciated that the example system 2900 is simplified to facilitate description of the disclosed subject matter and is not intended to limit the scope of this disclosure. Other devices, systems, and configurations may be used to implement the embodiments disclosed herein in addition to, or instead of, a system such as the system 2900, and all such embodiments are contemplated as within the scope of the present disclosure. Further, while the first RP 2912 and the second RP 2914 are depicted as Facebook and Bank of America, respectively, it will be understood that this depiction is for purposes of example, and the first and second RPs may be any suitable service providers as desired.

In accordance with the illustrated embodiment, at 2922, the user 2902 enters a user identifier associated with the first RP 2912. At 2924, in accordance with the illustrated embodiment, the first RP 2912, for example based on a policy of the RP 2912, determines an assurance level (AL) that is required in order for the user/UE to access the requested service that is provided by the RP 2912. At 2929, the RP 2912 discovers the MFAS 2916 and associates with the MFAS 2916. At 2928, in accordance with the illustrated embodiment, the RP 2912 communicates its assurance level requirement to the browser 2910. At 2930, the browser 2910 invokes services of the MFAS 2916. The message at 2930 may include the required assurance level.

At 2932, based on the level of assurance that is required to access the service, for example, the MFAS 2916 determines the types and strengths of the authentication factors that can be performed to achieve the required assurance level. The MFAS may retrieve information (e.g., authentication capabilities) associated with the user 2902 and the UE 2901 from a user profile DB 2929. In accordance with the example, at 2932, the MFAS may determine that only a password authentication is required to access services from the RP 2012. At 2934, the MFAS 2916 may trigger the password authentication by sending an HTTP message to the user 2902 that prompts the user to enter a password. At 2936, the user enters the password. At 2938, the MFAS 2916 sends the password and UID to the PWD server 2918 for password authentication. The PWD server 2918 performs the password authentication by confirming the entered password for the user matches a stored password for the user. At 2940, the PWD server 2918 informs the MFAS 2916 that the passwords match. Such a message may be referred to as an authentication result.

Referring in particular to FIG. 29B, an assertion, such as a first assertion for example, may be generated by the MFAS 2916 and sent to the browser 2910. The browser 2910 may send the assertion to the RP 2912, and the RP 2912 may return a success message at 2946. Thus, at 2948, the user may have access to the service provided by the RP 2912.

Referring in particular to FIG. 29C, in accordance with the illustrated embodiment, at 2950, the user 2902 enters a user identifier associated with the second RP 2912 so that the user can access a service provided by the second RP 2912. At 2952, in accordance with the illustrated embodiment, the second RP 2914, for example based on a policy of the RP 2914, determines an assurance level (AL) is required in order for the user/UE to access the requested service that is provided by the RP 2914. At 2954, in accordance with the illustrated embodiment, the second RP 2914 communicates its assurance level requirement to the browser 2910. At 2956, the browser 2910 invokes services of the MFAS 2916. The message at 2956 may include the required assurance level. At 2958, based on the level of assurance that is required to access the service, for example, the MFAS 2916 determines the types and strengths of the authentication factors that can be performed to achieve the required assurance level. This determination may be based on the past password authentication describe above, which may be fresh in accordance with a policy of the second RP 2914. The MFAS 2916 may retrieve information (e.g., authentication capabilities) associated with the user 2902 and the UE 2901 from the user profile DB 2929. In accordance with the example, at 2932, the MFAS may determine that a biometric authentication is required to access services from the second RP 2014. At 2969, the MFAS 2916 may initiate the biometric authentication by sending a message to the web-key server 2920. In response, at 2962, the webkey server 2920 sends configuration data to the MFAS 2916. At 2964, the MFAS 2916 triggers the biometric authentication by sending an HTTPS message to the browser 2910. At 2966, the browser 2910 invokes the local bio-key client 2904 such that the client 2904 prompts the user 2902 to have her fingerprint scanned. Thus, a fingerprint model is obtained by the client 2904, at 2968. At 2970, the fingerprint mode is sent to the browser 2910. At 2972, the fingerprint model is sent to the MFAS 2916. At 2974, the MFAS 2916 sends the fingerprint model to the web-key server 2920 for biometric authentication. The server 2920 performs the biometric authentication by confirming that the received fingerprint model from the user matches a stored fingerprint of the user. At 2976, the server 2920 informs the MFAS 2916 that the fingerprints match. Such a message may be referred to as an authentication result. At 2978, the MFAS 2916 creates an assertion based on the authentication results from the password authentication and the biometric authentication. The assertion may have an associated assurance level that includes an assurance level of the previous (fresh) password authentication and the biometric authentication. At 2980, the assertion, which may include the associated assurance level, is sent to the browser 2910. At 2982 and 2984, the assertion is asserted to the second RP 2914, and a success message is sent from the second RP 2914 to the browser 2910. Thus, at 2986, the user/UE can access the requested service that is provided by the second RP 2914. Further, a fresh authentication factor is leveraged to access the service that is provided by the second RP, thereby facilitating an efficient authentication.

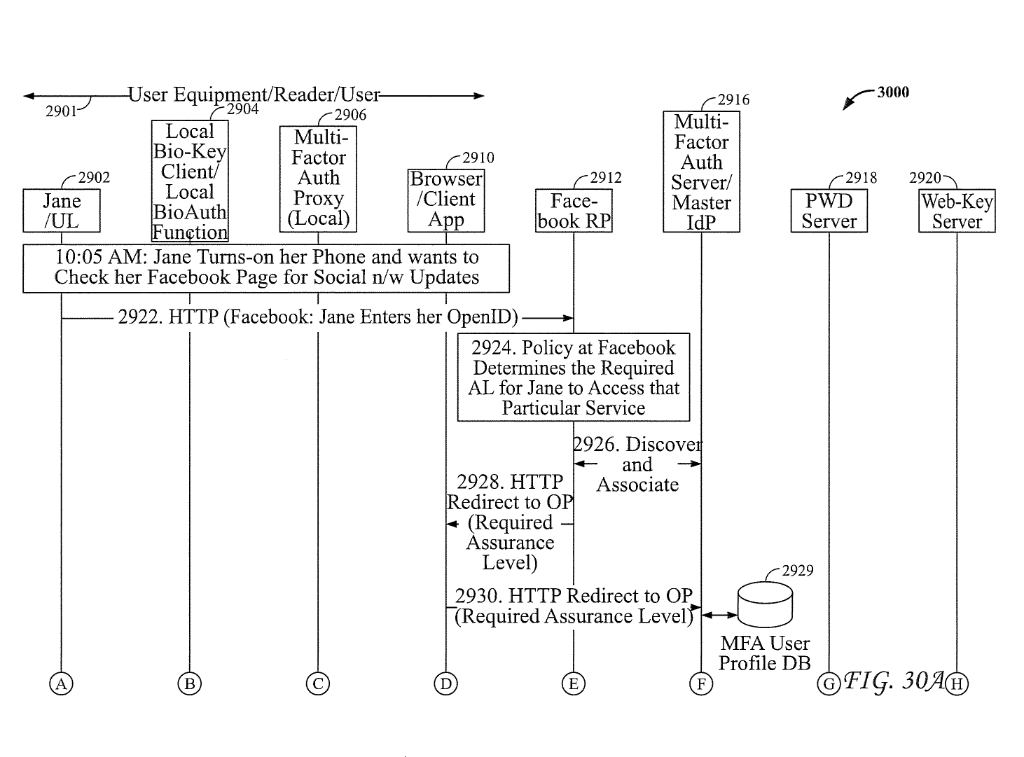

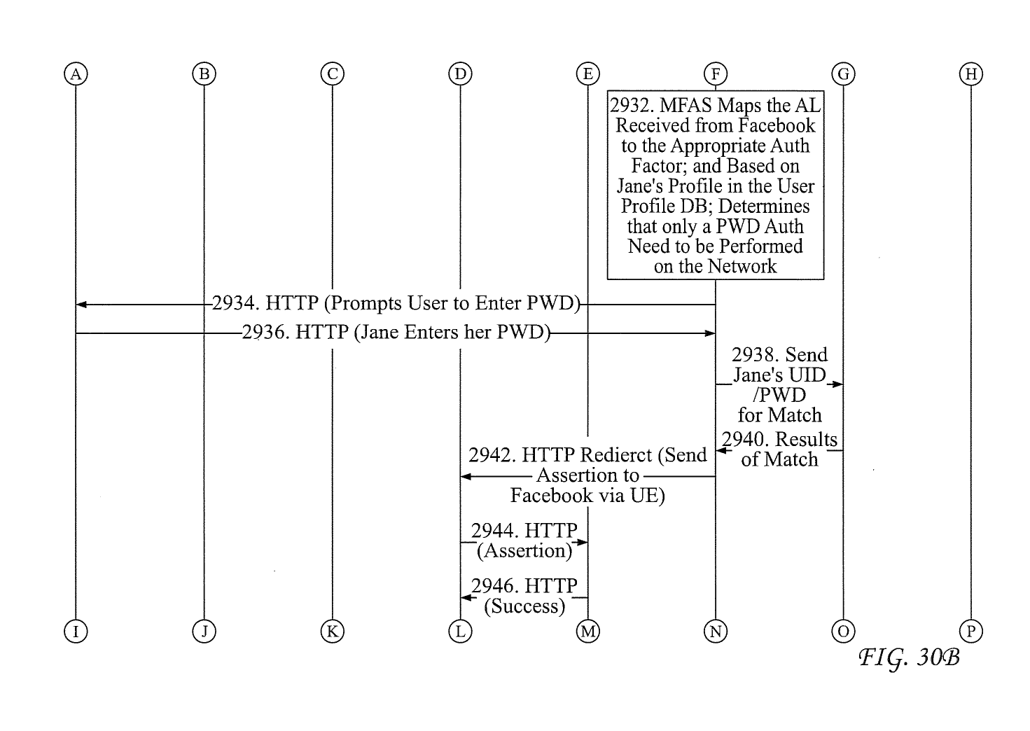

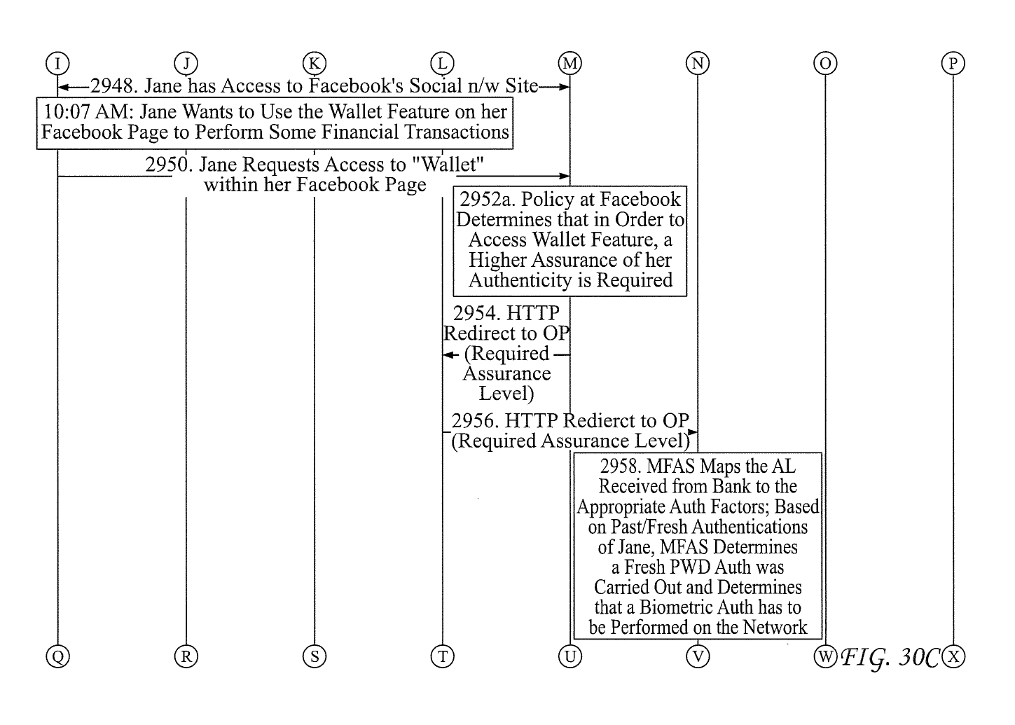

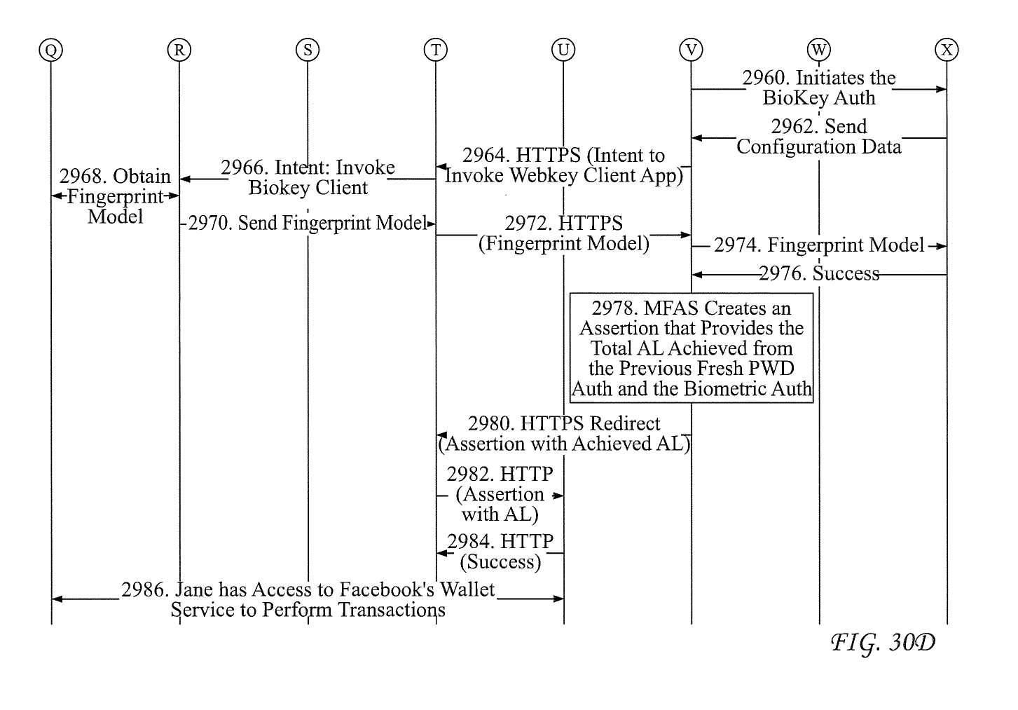

Referring now to FIGS. 30A-D, an example system 3000 performs a multi-factor authentication like the multi-factor authentication that is performed by the system 2900. FIGS. 30A-E show an embodiment in which the same RP offers different services, and thus a different assurance level may be required to assess the different services offered by the RP. For example, referring to FIG. 30C, at 2950, the user 2902 requests access to a second service provided by the RP 2912 after receiving access to a first service provided by the RP 2912 (see 2948). At 2952a, the RP 2912, based on a policy for example, determines that a higher level of assurance than previously obtained is required to access the second service. For example, the second service may include a money transaction, whereas the first service may only include access to a webpage. Because the second service may be more sensitive from a security perspective than the first service, a higher level of assurance may be required for the second service. Thus, referring to FIGS. 30C-E, the user 102 undergoes a biometric authentication to assess the second service of the RP 2912 even though the user already accessed the first service of the RP 2912. It will be understood that the example embodiment depicted in FIGS. 30A-D can be implemented using any number of relying parties as desired.

In an example embodiment, location information in the URL part of a URI is used to trigger a specific authentication factor. An example URL includes:

```
        soid.scheme:// simple.password/?salted-
digest=<SALTED_DIGEST_VALUE>,salt=<SALT_VALUE>
        soid.scheme://biometric.fingerprint-biokey/...
```

In the above example. a password based authentication is triggered followed by a biometric authentication.

An example of the OpenID AX query response for a two-factor (password and biometric) authentication with an authentication assertion containing a timestamp may include:

openid.ax.mode=fetch_response
openid.ax.type.mauthitem=http://multi-factor.org/schema/multi-auth-listing
openid.ax.type.mauth_signed=http://multi-factor.org/schema/generic-
signed
openid.ax.value.name=John Doe
openid.ax.type.auth_time=http://multi-factor.org/schema/timestamp
openid.ax.type.auth_time= 2013-04-31T15:07:38.6875000-05:00
openid.ax.count.mauth=2
openid.ax.value.mauth.1=password
openid.ax.value.mauth.2=biometric.BIO-Key
openid.ax.value.mauth_sig= iVBORw0KGgoAAAANSUhEUgAAAAUA
AAAFCAYAAACNbyblAAAAHElEQVQI12P4==

As shown above, the response to a fetch request may contain the list of the two authentications carried out. The full response, excluding the signature attribute line for example, may be signed by the OP. The signature may be bound to the original OpenID assertion by using the same signing key to sign it. This may also allow the RP to immediately verify the response.

In an example embodiment, authentication factors are looped in a sequential order, starting with the weakest authentication factor.

The MFAS, as described above, may allow for a seamless implementation of authentication policies for service providers that have multiple, different requirements for authentication assurance. For example, service providers have different authentication requirements based on different services that they provide. By way of example, e-commerce sites (e.g., Amazon) may have a first authentication requirement (username/password) for logging in to the website, and a second authentication requirement (biometric) for purchasing goods. Currently approaches to check out are crude. For example, often usernames and passwords are merely re-entered at checkout, which may cause security weaknesses for various reasons, such as credentials being stored in browsers. In accordance with an example embodiment of the above-described MFAS, a user may visit the shopping site, browse the catalogue, and add items to the shopping cart. When it comes to checkout, the shopping site page may trigger a login using the MFAS that uses a specific authentication policy for checkout.

This example scenario may also demonstrate the flexibility of the MFAS to manage payment information and authorize payments, while keeping the service provider integration loosely coupled. By presenting the same trusted/known interface to the user, he can be assured that his payments will be processed securely and is more likely to purchase goods from the store. The store can leverage the existing billing relationship between the mobile network operator (MNO), which may operate an MFAS, and the user in the payment process. The mobile network operator can provide a way for stores to access the subscriber base and offer a streamlined payment method and process to easily engage with users. The existing billing relationship of the MNO with its subscribers can be leveraged and can be extended to non MNO operated services like e-Commerce platforms. The following table shows some example advantages that may result from the above-described example scenario.

| | User | Service (e-commerce) | MNO |
|---|---|---|---|
| Advant | Higher privacy | Higher conversion | Monetization |
| ages | towards service | rate (site visitor | of existing data |
| | if MNO | to buyer) due | (verified |
| | handles | to simplified | payment and |
| | payment | signup and | contact/ |
| | Higher user | payment process | shipping |
| | satisfaction due | No need to | data) and |
| | to streamlined | implement | infrastructure, |
| | payment process | own payment | e.g. reuse of |
| | Higher trust in | infrastructure | existing |
| | security of | Higher security | billing |
| | service, phishing | and higher | infrastructure |
| | prevention | level of user | Higher visibility |
| | Easier and | authentication | towards services |
| | faster checkout | in payment | and users as |
| | with increased | process | ‘trust anchor’ |
| | security | Protection | and ‘payment |
| | Increased | from fraud | security |
| | customer | due to verified | provider’ |
| | loyalty | payment | Positive |
| | due to trusted | information | branding/ |
| | payment | from MNO | marketing |
| | processing | Opportunity to | effects, |
| | Ease of Use, | access consumer | opportunity for |
| | can use similar | preference | co-branding |
| | mode of payment | data in | Increased |
| | every time | partnership | revenue |
| | (does not worry | with MNO | by charging |
| | about having | | users or web |
| | paypal | | services for |
| | accounts and | | MNO checkout/ |
| | visa cards for | | authentication |
| | specific | | service usage |
| | services) | | Could serve as |
| | | | central payment |
| | | | processing |
| | | | entity for |
| | | | services and |
| | | | Opportunity for |
| | | | partnership |
| | | | relationship to |
| | | | services |

By way of another example, a user may browses to a first site, such as a social networking site for example, where he logs in with his usual credential, such as his password for example, using the MFAS login provided by his MNO. After some activity on that site, the user decides to move on to do some shopping with an e-Commerce site, such as Amazon for example. There, he is presented with the option (as on the social networking site previously visited) to login using the MFAS services provided by his MNO. The authentication policy agreed upon between the e-commerce site and the MFAS may allow for using the previous authentication with the social networking site as a credential, provided it is fresh enough. Thus, after the user enters his/her ID that is associated with the e-commerce site (a step which is often automated by browser functions or plugins), the MFAS system of the MNO may look up the corresponding policy, check the freshness of the previous authentication factor with the social network site, and in the case of success, assert a successful authentication to the e-Commerce site. The user is then seamlessly taken to his personal login page showing some shopping recommendations for him.

Continuing with the example, the user may fill his shopping basket and at a certain point he decides to purchase the goods in it. He presses the ‘proceed to checkout’ button. The policy of the e-commerce site for checkout may require a separate authentication using a stronger factor than the one used for logging in to the e-commerce site. For instance, checkout may require an operator-based authentication using the phone SIM card plus a biometric authentication by the user, as a true two-factor authentication. It could also require that at least the biometric authentication shall be fresh (i.e. previous user authentication using the biometric factor are not considered valid). While the first factor authentication using the SIM card proceeds in the background between user device and operator MFAS system, the biometric factor requires explicit user interaction, e.g., the user has to swipe his finger on the phone's fingerprint sensor.

After the operator MFAS has asserted successful combined authentication according to the e-commerce site's policy for checkout, the user is taken to the usual checkout page where he may confirm/select/edit his shipping and/or payment details. Using the MFAS embodiments described above, such user details may be transferred ad hoc to the shopping site from the MFAS or the client device.

The discrimination of authentication policies between the e-commerce login site and the e-commerce checkout site can be effected by using subdomain names or site URLs, such as amazon.com/login or checkout.amazon.com, respectively. For each of these URLs, a single user is very likely to own and use multiple devices to access the same or different services. Not all devices may exhibit the same authentication capabilities. However, the same user and same user identifier may be authenticated by the FNX on behalf of the service. Therefore, the FNX supports the above-described mechanisms to enroll and map multiple devices to a single user, and the FNX can support authentication to be combined from different devices. In an example scenario presented for purposes of illustration, a user may browses his eBanking website on his laptop. In order to login to the website, the website requests a biometric authentication from the FNX. The FNX then triggers the biometric authentication with the user's laptop. After the user has scanned his fingerprint, the FNX creates the necessary assertion towards the banking website, and access is granted. When the user next wants to make a transaction, the banking website may request a biometric plus an SMS authentication from the FNX. The FNX may evaluate the request and detects that the SMS is possible from the user's registered smartphone. The FNX may trigger the necessary NAE connectors to send an SMS to the user's phone. The user sends back that SMS to the FNX to complete SMS authentication. According to policies, since the last biometric authentication just happened when the user logged in, the FNX may not need to re-authenticate the biometric factor. For example, the FNX may instead add a freshness statement to the combined assertion for the two authentications. The banking transaction may be carried out subsequently. In the above example scenario, it is through the knowledge of both authentication factors by the FNX that the service can run the authentication in a seamless and integrated way without implementing its own biometric and SMS authentication infrastructure.

In order to enable the above example scenario, the FNX may have an additional device connector, which may be used to configure each device that a user possesses during device enrollment. As part of an enrollment protocol, in accordance with one embodiment, the user registers this device with the FNX, and adds the device specific capabilities to the FNX mapping. In the case of a local FNX, the local FNX might only know about the device capabilities of the local device. However, the network FNX may distribute the device information to all local FNX instances of a user, so that, for example, the mobile phone local FNX knows that it can trigger biometric authentication on the user's laptop. For example, policy that includes device capabilities may be stored in the corresponding user profile at the MFAS.

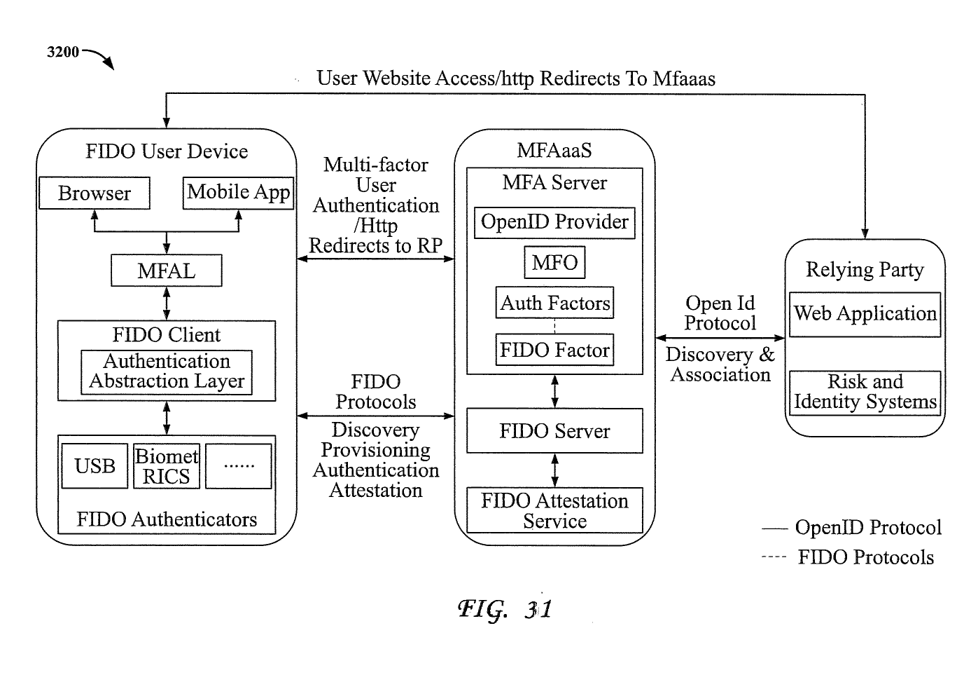

Referring now to FIG. 31, the example architecture 3200 shows an example of how architectures showcasing FIDO and the above-described MFAS functionalities may work with one another.

A FIDO user device shown in FIG. 31 refers to a FIDO-enabled user device, which refers to devices which have the necessary components to do FIDO authentication. In an example embodiment, the FIDO-enabled user device also has an additional Multi-factor Authentication Layer to enable usage of the FIDO authenticator as one of the authentication factors in the multi-factor authentication. As part of the FIDO architecture, an example FIDO user device consists of a FIDO Client, an authentication abstraction layer, and the FIDO authenticators.

A FIDO client implements the client side of the FIDO protocols and interfaces with the FIDO Authenticator abstraction layer via the FIDO Authenticator API. The FIDO authenticator abstraction layer provides a uniform API to upper layers enabling the utilization of authenticator-based cryptographic services. It provides a uniform lower-layer “authenticator plugin” API facilitating the employment of multi-vendor authenticators and their requisite drivers.

A FIDO authenticator may be a secure entity that is attached to or housed within FIDO user devices. It may be able to be remotely provisioned with key material by relying parties, and it is then capable of participating in cryptographic strong authentication protocols. For example, the FIDO authenticator may be capable of providing a cryptographic challenge response based on the key material thus authenticating itself.

On the device side, for example, the FIDO user device may house the above-described MFAP, which interacts with the above described MFAS, and thus enables the use of FIDO as one of the authentication factors in a multi-factor authentication. The MFAP may facilitate binding (cryptographic or other means) of the two step local authentication(s), which are typically carried out by the FIDO authenticator(s), with the authentication protocol of the network. The MFAP may take into consideration the fullness of the MFAaaS service, including the freshness aspects of the authentication factors and the policies that drive the overall multi-factor authentication and variable grade authentication assurance.

In an example embodiment, the MFAaaS service may have control of the MFAS and also may have the FIDO server and the FIDO Attestation service, or an external connection to these FIDO components may be provisioned. The FIDO server may have various functionalities. For example, the FIDO server may implement the server portion of the FIDO protocols, communicating with the FIDO Attestation Service to validate FIDO Authenticator attestations, and communicate with the FIDO Attestation Service to update FIDO Authenticator data. The FIDO Attestation service may be used to close the loop between the FIDO authenticators and the FIDO server. Responsibilities of the FIDO Attestation service may include, for example, endorsing FIDO authenticators, validating FIDO authenticator attestations, and providing revocation data of FIDO authenticators to FIDO server.

In accordance with an example embodiment, at the MFAS that is described above, an authentication module for the FIDO factor is added. When this module is invoked, it may direct the MFAP to do the local authentication based on the FIDO authenticator. This authentication can be validated by the FIDO server using the attestation service. Thus, the FIDO authentication architecture may be modified, in accordance with an example embodiment, to work in conjunction with the MFAaaS, wherein different types of network and local authentication vectors may be combined in different desired ways for authenticating to various relying parties.

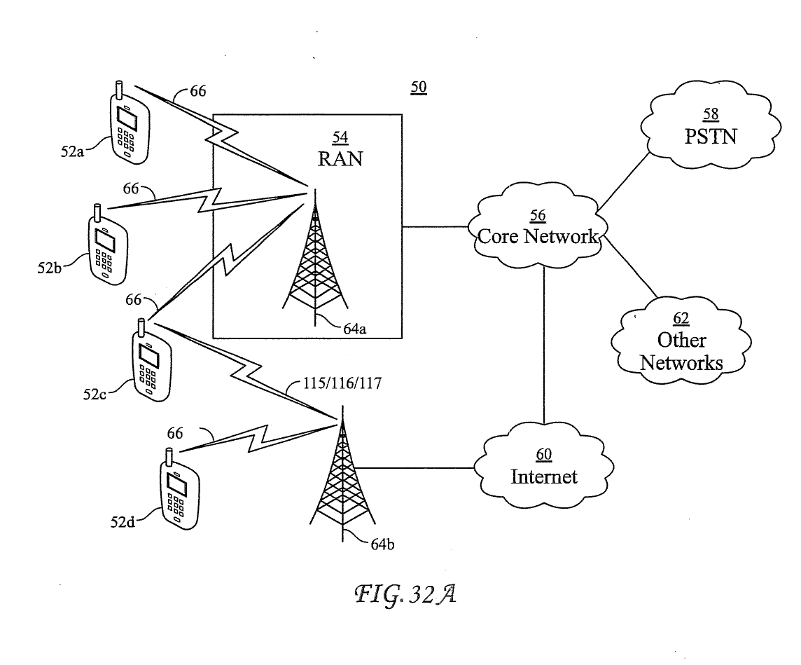

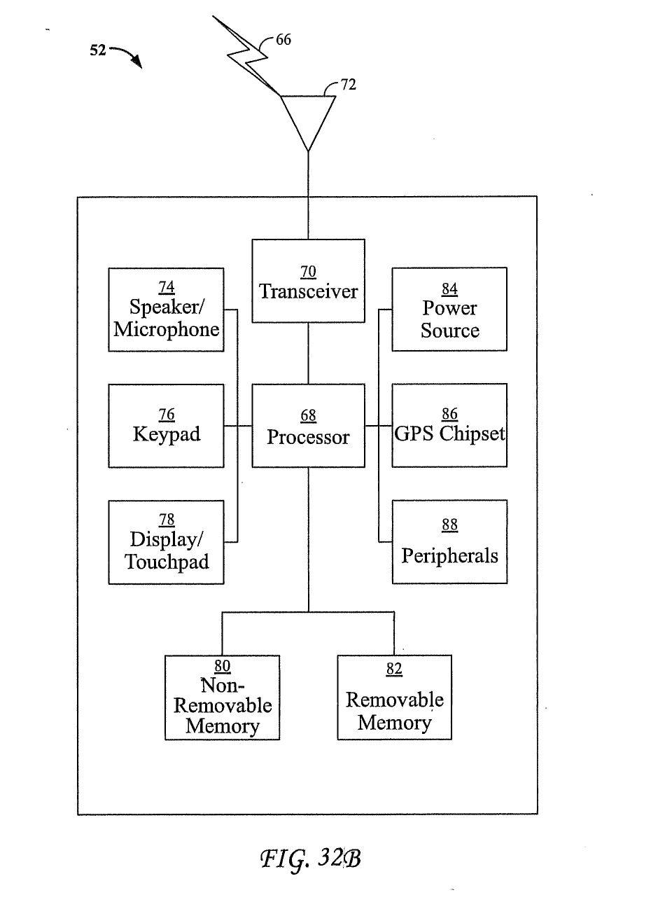

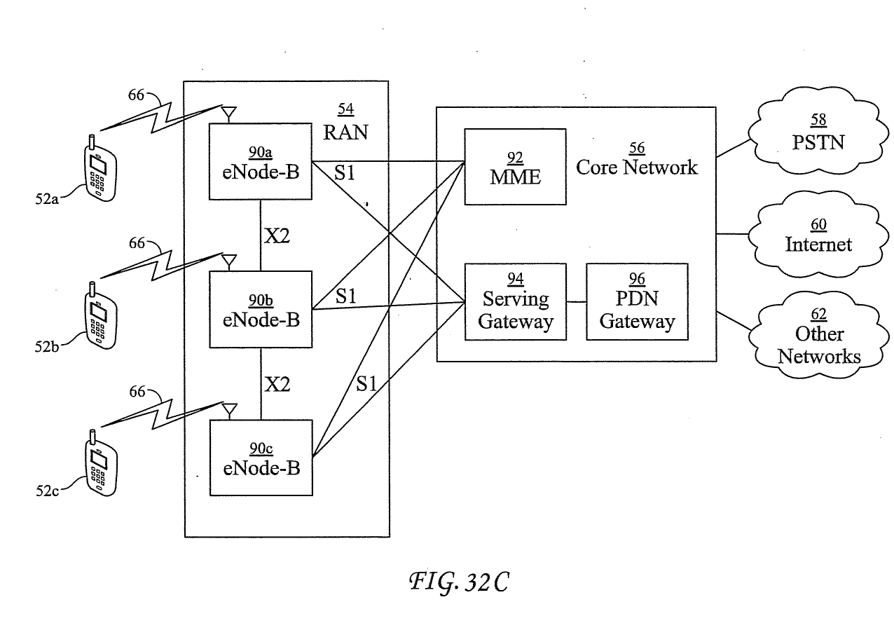

FIG. 32A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 32A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64b may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64b may be a base transceiver station (BTS), a Node-B, an eNode B, a Home Node B, a Home eNode B, a site controller, an access point (AP), a wireless router, and the like. While the base stations 64a, 64b are each depicted as a single element, it will be appreciated that the base stations 64a, 64b may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64b may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64b may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 66 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64b in FIG. 32A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64b and the WTRUs 52c, 52d may implement a radio technology such as IEEE 802.11 to establish a wireless local area network (WLAN). In an embodiment, the base station 64b and the WTRUs 52c, 52d may implement a radio technology such as IEEE 802.15 to establish a wireless personal area network (WPAN). In yet another embodiment, the base station 64b and the WTRUs 52c, 52d may utilize a cellular-based RAT (e.g., WCDMA, CDMA2000, GSM, LTE, LTE-A, etc.) to establish a picocell or femtocell. As shown in FIG. 32A, the base station 64b may have a direct connection to the Internet 60. Thus, the base station 64b may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 32A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 32A may be configured to communicate with the base station 64a, which may employ a cellular-based radio technology, and with the base station 64b, which may employ an IEEE 802 radio technology.

FIG. 32B is a system diagram of an example WTRU 52. As shown in FIG. 32B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 32B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet another embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 32B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 818 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 818 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 32C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 32C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 32C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 56 shown in FIG. 32C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method that facilitates an authentication of at least one of a wireless transmit/receive unit (WTRU) or a user that operates the WTRU, wherein the WTRU is in a communications network that farther includes a service provider (SP), the method comprising:
determining a first authentication assurance level required by the SP to access a first service that is provided by the SP;
discovering one or more authentication capabilities of the WTRU;
determining whether the discovered one or more authentication capabilities can meet the first authentication assurance level required by the SP; and
if the discovered one or more capabilities can meet the first authentication assurance level required by the SP, triggering a performance using at least one of one or more authentication factors associated with the discovered one or more authentication capabilities.

2. The method as recited in claim 1, the method further comprising:
based on one or more authentication results associated with the performances of each of the one or more authentication factors, creating a consolidated result that achieves the first authentication assurance level required by the SP; and
sending the consolidated result to the SP, thereby enabling the WTRU to access the first service.

3. The method as recited in claim 2, wherein the consolidated result comprises the one more authentication results bound together in a cryptographic manner, the consolidated result identifying the one or more authentication results that are bound together.

4. The method as recited in claim 3, wherein the consolidated result further comprises an aggregate authentication assurance level and an aggregate authentication freshness level, the aggregate authentication assurance level and the aggregate authentication freshness level associated with the one or more authentication results.

5. The method as recited in claim 2, wherein the consolidated result comprises the one or more authentication results bound by a nonce that is shared during the performance of each of the one or more authentication factors.

6. The method as recited in claim 1, the method further comprising:
determining a freshness level associated with a select one of the one or more authentication factors;
based on a policy of the SP, determining whether the freshness level associated with the select one authentication factor satisfies a threshold level; and
if the freshness level satisfies the threshold level, asserting a previous authentication result of the one authentication factor, thereby refraining from performing a new authentication using the one authentication factor.

7. The method as recited in claim 1, wherein triggering the performance of at least one of the selected one or more authentication factors comprises:
sending a challenge to a network authentication entity; and
in response to the challenge, receiving a response from the network authentication entity.

8. The method as recited in claim 1, wherein the method is performed by a logical entity operating on the WTRU.

9. The method as recited in claim 1, where the method is performed by a logical entity operating in the network that is in communication with the WTRU and the SP.

10. The method as recited in claim 1, the method farther comprising:
if the one or more discovered authentication capabilities cannot meet the first authentication assurance level, selecting one or more authentication factors that can achieve a second assurance level; and
triggering a performance of the one or more authentication factors that can achieve the second assurance level.

11. The method as recited in claim 10, based on one or More authentication results associated with the performance of the one or more authentication factors that can achieve the second authentication assurance level, the method further comprising:
creating a second consolidated result that achieves the second authentication assurance level; and
sending the second consolidated result to the SP, thereby enabling the WTRU to access a second service provided by the SP, wherein access to the second service requires a lower assurance level than the first authentication assurance level required to access the first service.

12. The method as recited in claim 1, the method further comprising:
if none of the discovered authentication capabilities can meet the first authentication assurance level or if the performance using the one or more authentication factors fails, sending notice to the SP such that at least the WTRU or user receives no access to services provided by the SP.

13. The method as recited in claim 1, wherein the one or more discovered authentication capabilities comprises a biometric capability, the method further comprising:
determining that an authentication using the biometric capability can meet the first authentication assurance level.

14. The method as recited in claim 13, wherein one of the one or more authentication factors is a biometric factor, the biometric factor being the only authentication factor.

15. The method as recited in claim 1, wherein a first authentication factor of the one or more authentication factors is a biometric factor, and a second authentication factor of the one or more authentication factors is a password factor.

16. The method as recited in claim 1, wherein discovering the one or more authentication capabilities comprises:
receiving at least one capability of the WTRU during a registration of the WTRU;
storing the at least one capability of the WTRU with an identifier of the WTRU; and
based on the identifier, retrieving the at least one capability when the WTRU attempts to access the first service.

17. The method as recited in claim 1, wherein the performance that is triggered using at least one of the one or more authentication factors occurs at the SP or an identity provider (IdP).

18. A network server in a communication network that further includes a wireless transmit/receive unit (WTRU) and a service provider (SP), the network server comprising:
a memory comprising executable instructions; and
a processor that, when executing the executable instructions, effectuates operations comprising:
determining an authentication requirement to access a first service that is provided by the SP;
discovering one or more authentication capabilities of the WTRU;
determining whether at least one of the discovered one or more authentication capabilities can achieve the authentication requirement; and
if the discovered authentication can achieve the authentication requirement, triggering a performance using at least one of one or more authentication factors associated with the authentication capabilities.

19. The network service as recited in claim 18, wherein the performance using at least one of the one or more authentication factors occurs at the SP.

20. The network server as recited in claim 18, wherein the network server is an identity provider (IdP), and wherein the performance using at least one of the one or more authentication factors occurs at the IdP.

21. The network server as recited in claim 18, wherein determining an authentication requirement to access a first service that is provided by the SP comprises:
receiving the authentication requirement from the SP, wherein the authentication requirement indicates an authentication assurance level.
